(19) United States
(12) Patent Application Publication
(10) Pub. No.: US 2016/0165472 A1
(43) Pub. Date: Jun. 9, 2016

(54) Analytics assisted self-organizing-network (SON) for coverage capacity optimization (CCO)

(71) Applicant: Futurewei Technologies, Inc., Plano, TX (US)

(72) Inventors: Nandu Gopalakrishnan, Chatham, NJ (US); Yan Xin, Princeton, NJ (US); James Mathew, Bellemead, NJ (US)

(21) Appl. No.: 14/757,764

(22) Filed: Dec. 23, 2015

Related U.S. Application Data
(63) Continuation-in-part of application No. 14/971,870, filed on Dec. 16, 2015.
Application No. 14/971,870 is a continuation-in-part of application No. 14/963,062, filed on Dec. 8, 2015.
(60) Provisional application No. 62/089,654, filed on Dec. 9, 2014.
(60) Provisional application No. 62/096,439, filed on Dec. 23, 2014.
(60) Provisional application No. 62/093,283, filed on Dec. 17, 2014.
(60) Provisional application No. 62/099,854, filed on Jan. 5, 2015.
(60) Provisional application No. 62/100,003, filed on Jan. 5, 2015.

(51) Int. Cl. H04W 24/10; H04W 16/28; H04W 52/04; H04W 24/02

(52) U.S. Cl. CPC H04W 24/10; H04W 24/02; H04W 16/28; H04W 52/04; H04W 84/18

(57) ABSTRACT

Methods and apparatus are provided for adjusting configuration parameters, such as antenna tilt or transmit power, of a plurality of cells in a wireless network based on measurement reports received during a data collection period of the wireless network, so that coverage and capacity of the wireless network may be improved. Cell status labels or blames are assigned to each of the cells based on the measurement reports, and configuration parameters of the cells are adjusted based on the assigned cell status labels or blames.

The present application is a continuation-in-part of and claims priority to U.S. non-provisional patent application Ser. No. 14/971,870 filed on Dec. 16, 2015, which is a continuation-in-part of and claims priority to U.S. non-provisional patent application Ser. No. 14/963,062 filed on Dec. 8, 2015, which claims priority to the following U.S. provisional applications:

U.S. Provisional Application No. 62/089,654 filed Dec. 9, 2014;

U.S. Provisional Application No. 62/096,439 filed Dec. 23, 2014;

U.S. Provisional Application No. 62/093,283 filed Dec. 17, 2014;

U.S. Provisional Application No. 62/099,854 filed Jan. 5, 2015; and

U.S. Provisional Application No. 62/100,003 filed Jan. 5, 2015.

All of these are hereby incorporated herein by reference.

### TECHNICAL FIELD

The present invention relates to telecommunications, and, in particular embodiments, to techniques for an analytics assisted self-organizing-network (SON) for coverage capacity optimization (CCO).

### BACKGROUND

A self-organizing network (SON) is an automation technology designed to make the planning, configuration, management, optimization, and healing of mobile radio access networks simpler and faster. SON functionality and behavior has been defined and specified in generally accepted mobile industry recommendations produced by organizations such as 3rd Generation Partnership Project (3GPP) and Next Generation Mobile Networks (NGMN). SON is considered critical to operators' strategy for meeting the exploding demand for data in the coming decade—the era of the Internet of Things. SON is considered necessary to automate operations and optimize performance in a scalable manner for small cell driven heterogeneous networks (HetNets). As SON evolves it will be run on Big Data platforms in the cloud powered by “intelligent” predictive analytics algorithms.

Coverage Capacity Optimization (CCO) is a SON use case that initially configures and adjusts key RF parameters (antenna tilt and azimuth configuration and power) post-deployment to maximize some measure of user quality of experience (QoE) (in particular, coverage, quality and capacity) and adapt to changing traffic patterns and changes in environment. CCO is expected to work on a long time-scale in the order of hours/days to capture and react to long term or seasonal changes in traffic and environment and also allow for sufficient data collection for accurate observation and estimation of CCO performance.

### SUMMARY OF THE INVENTION

Technical advantages are generally achieved, by embodiments of this disclosure which describe an analytics assisted self-organizing-network (SON) for coverage capacity optimization (CCO).

In accordance with an embodiment, a method for improving coverage and capacity of a wireless network having multiple cells is provided. The method includes receiving one or more measurement reports associated with communications in the wireless network during a first period, and assigning two or more status labels to a cell in the wireless network based on the one or more measurement reports. The two or more status labels are associated with different cell status categories. The method further includes instructing the cell to adjust an antenna tilt, a transmit power level, or both based on information including a combination of the two or more status labels. The antenna tilt or transmit power level is used to communicate wireless signals in the cell during a second period. An apparatus for performing this method is also provided.

In accordance with another embodiment, a method is provided, which includes identifying measurement reports, each of which fails to satisfy a performance criteria for a wireless network. The measurement reports are generated in the wireless network during a first period, and each of the measurement reports is associated with a unit of blame. The method further includes assigning, for each of the measurement reports, fractional units of blame to cells in the wireless network, and instructing at least one of the cells to adjust at least one parameter based on the fractional units of blame assigned to the at least one of the cells. The at least one parameter is used to communicate wireless signals in the at least one of the cells. An apparatus for performing this method is also provided.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates an example of a Long Term Evolution (LTE) network;

FIG. 2 illustrates an example process for optimizing cell specific antenna configuration parameters;

FIGS. 3A-3E illustrate example graphs of global historical data categorizing interfering cells for a plurality of LTE networks;

FIGS. 4A-4E illustrate example graphs categorizing cells as overshooter cells;

FIG. 5 illustrates a graph depicting an example simulated annealing process performed by the optimization process;

FIG. 6 illustrates a graph depicting network performance as a function of power and downtilt parameters;

FIGS. 7A-7E illustrate changes in coverage and quality parameters in the LTE network through various iterations in a base incremental adjustment phase of the optimization process;

FIG. 8 illustrates a graph of an objective function through various iterations of the base incremental adjustment phase of the optimization process;

FIG. 9 illustrates a graph of the objective function through various iterations of a biased random adjustment phase of the optimization process;

FIG. 10 illustrates an example process for determining cell states to adjust antenna configuration parameters;

FIG. 11 illustrates the coverage states that can be assigned to a cell;

FIG. 12 illustrates additional coverage states of a weak edge state and a weak interior/insufficient state that can be assigned to a cell;

FIGS. 13A-13B illustrate a process for determining the coverage state for a cell;

FIG. 14 illustrates the overshooting states that can be assigned to a cell;

FIG. 15 illustrates an example of a cell in an overshooter state;

FIG. 16 illustrates a graph depicting a relationship between overlapped UE devices and overshooting identification;

FIG. 17 shows a process for determining an overshooter state of a cell;

FIG. 18 shows the interference states that can be assigned to a cell;

FIG. 19 shows a process for determining an interferer state of a cell;

FIG. 20 shows the quality states that can be assigned to a cell;

FIG. 21 shows a process for determining a quality state of a cell;

FIG. 22 illustrates a block diagram of an example processing system which may be implemented in the LTE network;

FIG. 23 illustrates a simplified example of a general-purpose computing component suitable for implementing one or more embodiments disclosed herein;

FIG. 24 illustrates a flowchart of an embodiment method for adjusting communication parameters for a cluster of cells using an autonomous adaptive simulated annealing algorithm;

FIG. 25 illustrates a flowchart of an embodiment method for adjusting communication parameters for a subset of cells;

FIG. 26 illustrates a graph depicting simulation results obtained by performing the method described in FIG. 25;

FIG. 27 illustrates another graph depicting additional simulation results obtained by performing the method described in FIG. 25;

FIG. 28 illustrates an embodiment flowchart for adjusting communication parameters for a cluster of cells using an autonomous adaptive simulated annealing algorithm;

FIG. 29 illustrates a diagram of an embodiment wireless network;

FIG. 30 illustrates a flowchart of an embodiment method for adjusting cell configurations in a wireless network;

FIGS. 31A-31C illustrates an embodiment table for mapping status labels to actions;

FIGS. 32A-32C illustrates another embodiment table for mapping status labels to actions;

FIG. 33 illustrates a diagram of another embodiment wireless network;

FIG. 34 illustrates a flowchart of an embodiment method for adjusting cell configurations in a wireless network;

FIG. 35 illustrates a flowchart of another embodiment method for adjusting cell configurations in a wireless network;

FIG. 36 illustrates a graph of an embodiment up-blame and down-blame space;

FIG. 37 illustrates a flowchart of another embodiment method for adjusting cell configurations in a wireless network;

FIG. 38 illustrates a diagram of an embodiment antenna radiation coverage zone;

FIG. 39 illustrates a table of an embodiment blame counter matrix;

FIG. 40 illustrates a diagram of a graph problem & solution visualization;

FIG. 41 illustrates a flowchart of an embodiment method for operating a CCO interface; and

FIG. 42 illustrates a diagram of an embodiment processing system.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Aspects of the present disclosure provide methods and apparatus for adjusting configuration parameters of a plurality of cells in a wireless network based on measurement reports (MRs) received during a data collection period of the wireless network, so that coverage and capacity of the wireless network may be improved. A configuration parameter of a cell may be an antenna tilt or a transmit power.

In some embodiments, labels are assigned to the plurality of cells based on the MRs and configuration parameters of the plurality of cells are adjusted according to the labels. In one embodiment, each of the plurality of cells are assigned two or more status labels based on one or more MRs collected in the wireless network. The two or more status labels are associated with different cell status categories. In one embodiment, a cell status may be categorized as a coverage status, a quality status, an overshooter status, or an interference status. Each of the cell status categories may be further classified into different cell status types. For example, a quality status is classified into types of {good, bad}, or an interference status is classified into types of {strong, medium, weak}. A cell may be mapped to one of the cell status types corresponding to a cell status category based on MRs and is labeled by that type and category. A combination of the labels assigned to each of the cells in the wireless network reflects the current status of each corresponding cell with respect to different cell status categories, and is used to determine adjustment of one or more configuration parameters of each corresponding cell, for improving cell performance. In one embodiment, domain expertise, knowledge and experience are used to determine what actions to take to adjust the cells' configuration parameters based on the combinations of labels.

In some embodiments, blames are assigned to the plurality of cells based on the MRs, and the configuration parameters of the plurality of cells are adjusted according to the blames. Blames are associated with MRs that do not satisfy a pre-defined set of performance criteria, which are referred to as bad or unsatisfactory MRs, and indicate responsibilities that one or more cells should take for the bad MRs. In one embodiment, bad MRs are identified from the collected MRs, and each bad MR is associated with one unit of blame. For each bad MR identified in the wireless network, fractional units of blame are assigned to responsible cells. If one cell is fully responsible for a bad MR, the cell is assigned a unit of blame. Thus the joint impacts of cell performance issues, such as problems related to coverage, quality or interference, resulted from cell's configuration is captured into the blames assigned to the cell corresponding to bad MRs in the wireless network. Blames assigned to each of the plurality of cells are used to determine adjustment of one or more configuration parameters of each corresponding cell, in order to improve status of each corresponding cell. In one embodiment, domain expertise, knowledge and experience are used to determine what actions to take to adjust the cells' configuration parameters based on the blames assigned to the cells.

In some embodiments, blames are classified into different blame categories for determining configuration parameter adjustment of the cells. The different blame categories indicate different manners to adjust one or more configuration parameters of the cells in order to reduce the values of blames. In one embodiment, a blame is classified into an up-blame or a down-blame, indicating an increase or a decrease of a configuration parameter is needed in order to reduce the blame value. In one embodiment, blames assigned to each of the cells are classified into an up-blame or a down-blame, and a sub-total up-blame value and a sub-total down-blame value are calculated by summing all up-blames and all down-blames, respectively, assigned to each corresponding cell. In one embodiment, the sub-total up-blame value and the sub-total down-blame value of a cell are used to calculate an up-action probability and a down-action probability of the cell. A configuration parameter of the cell may be increased when the up-action probability is greater than a first threshold, and may be decreased when the down-action probability is greater than a second threshold.

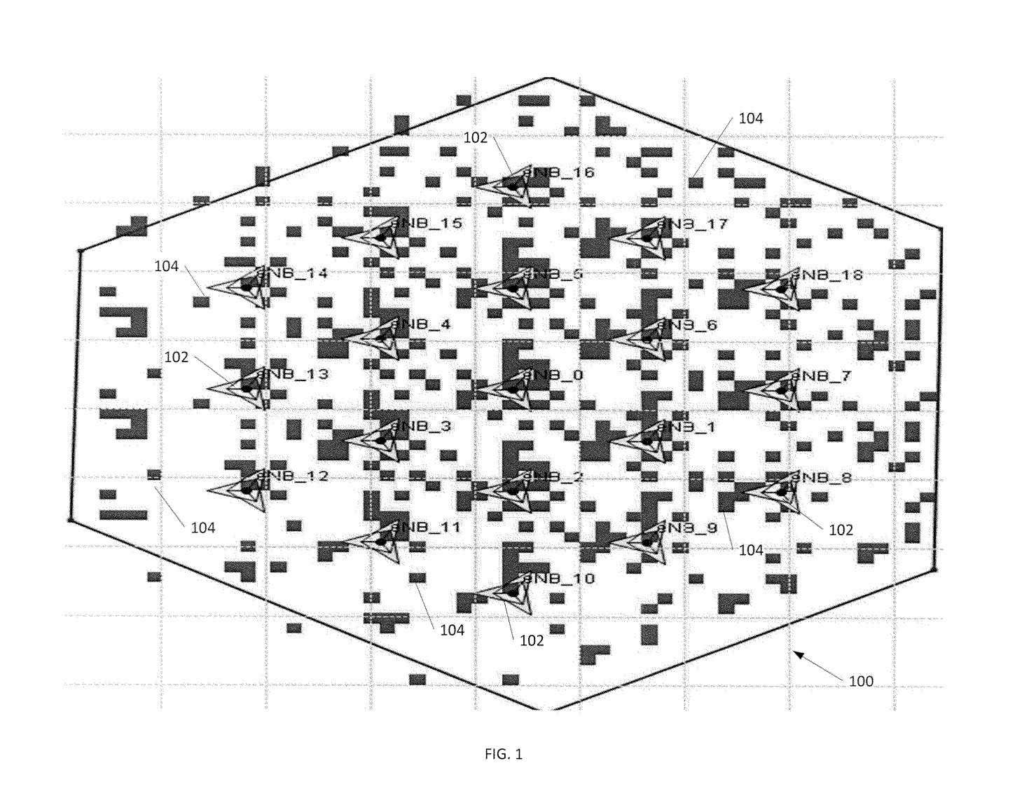

FIGS. 1 through 42, discussed below, and the various embodiments used to describe the principles of the present disclosure in this patent document are by way of illustration only and should not be construed in any way to limit the scope of the disclosure. Those skilled in the art will understand that the principles of the disclosure may be implemented in any type of suitably arranged device or system. Features shown and discussed in one figure may be implemented as appropriate in one or more other figures.

FIG. 1 shows an example of a Long Term Evolution (LTE) network 100. LTE network 100 is a type of wireless communications network designed to provide broadband Internet and phone service to user equipment (UE) such as mobile phones and other types of devices. Voice calls on an LTE network are converted into small chunks of data, which eliminates the need for separate voice circuits. These types of networks are often marketed as “4G” and are capable of offering speeds that rival wired broadband services. They also offer increased capacity, which may help wireless carriers deal with the increasing amounts of data used by smart phones and other devices. Though discussed in terms of LTE network 100, the present disclosure may also be applicable to other known or future wireless communications networks.

In the example of FIG. 1, LTE network 100 is partitioned into multiple cells provided by 19 Evolved Node B (eNB) radio access nodes 102. The eNB radio access nodes 102 provide service for multiple UE devices 104. The number of eNB radio access nodes 102 and UE devices 104 operating within LTE network 100 may be greater or fewer than what is depicted in FIG. 1. Each eNB radio access node 102 is responsible for radio transmission and reception with UE devices 104 in one or more cells. Each eNB radio access node 102 controls the radio resources of its own cells and provides functions for configuring and making measurements on the radio environment.

Optimizing Cell Specific Antenna Configuration Parameters

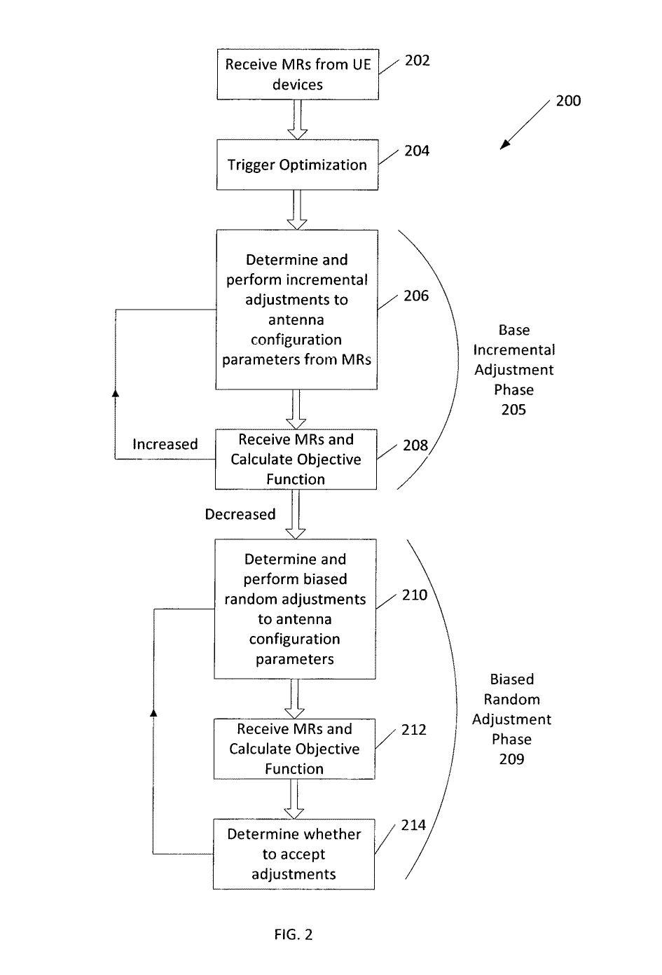

FIG. 2 shows a process 200 for optimizing performance in LTE network 100. In general, process 200 adjusts antenna configuration parameters incrementally online, jointly, and per cluster. Process 200 observes the resultant feedback from measurement reports (MRs) transmitted by UE devices 104 and continues in a closed loop to optimize over the long run. Antenna configuration parameters include electronic tilt, azimuth, and reference symbol power. Feedback from actual UE devices 104 is used in the form of MRs, as opposed to propagation model estimates. As known in the art, the MRs can include multiple UE-related and cell-related parameters, such as cell ID, reference signal received power (RSRP), reference signal received quality (RSRQ), serving cell ID, and timing advance parameters. The information in the MRs is used to update an objective function representing network performance, identify cell state indicator metrics/labels, and make step-wise antenna configuration parameter adjustments for performance progress. As known in the art, an objective function can be used for optimization of a measurable quantity, parameter, or feature, such as network performance. As used herein, the disclosed objective function can be used for optimization of network performance.

Process 200 does not need to know where UE devices 104 are located within LTE network 100 nor the exact antenna configuration parameter values in order to optimize performance. This contrasts with propagation model aided solutions (such as ACP) that require accurate user location and correct antenna configuration parameter values for each cell. Because correct configuration parameter values are not known, even if initial configuration parameters are erroneous, the antenna configuration parameter values can still be adjusted in a meaningful direction due to the fact that parameter changes lead to measurable change in cell/system metrics. As long as MRs (including RSRP, RS-SINR RSRQ, or the like) from representative UE devices 104 (e.g., UE devices 104 selected by unbiased random sampling) are available for a given antenna configuration parameter change, the objective function can be evaluated accurately.

In the disclosed embodiments, every MR that is adjudged to have “failed” a coverage criterion (e.g., by virtue of a reported reference channel signal strength not meeting a pre-defined threshold) or a quality criterion (e.g., by virtue of a reported reference channel quality, i.e., signal to interference plus noise, not meeting another pre-defined threshold) assigns a notional unit of “blame” for such failure to a “responsible” cell or cells. If multiple cells are held responsible, fractional units of “blame” (or “shares of blame”) are assigned to each responsible cell. When aggregated over all “failed” MRs, blame metrics can be calculated for each cell, and a base incremental action (e.g., antenna tilt or transmit power adjustment) can be taken by the cell in accordance with such blame metrics in order to reduce the rate of occurrence of MR failures.

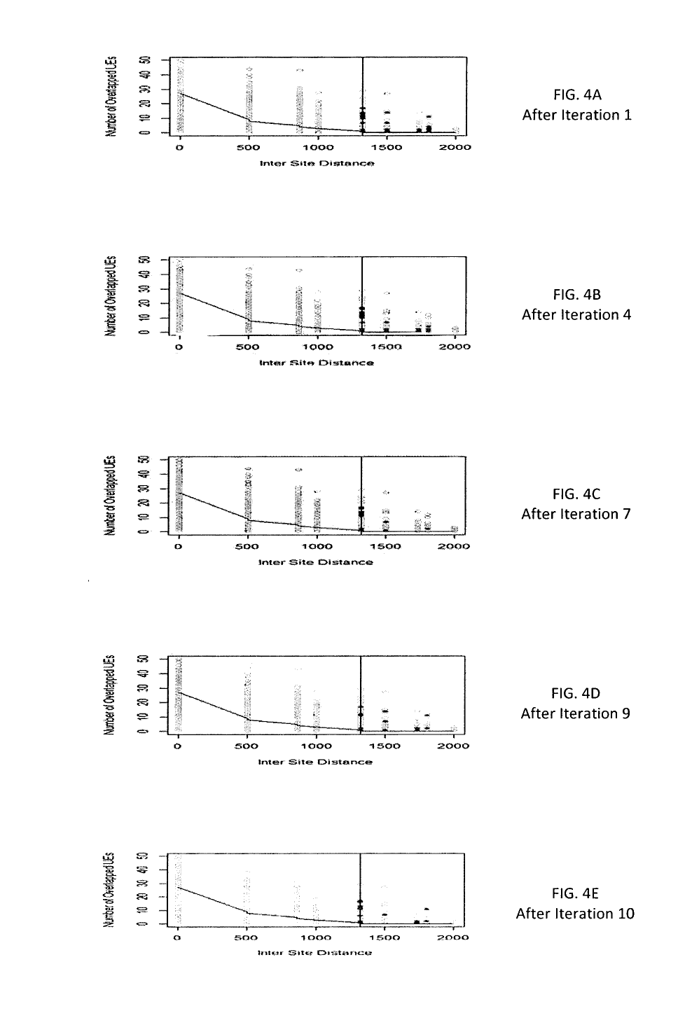

Process 200 employs two closed loop phases—a base incremental adjustment phase 205 and a biased random adjustment phase 209. In the base incremental adjustment phase 205, cell level features or blame metrics are calculated from the MRs and, alternatively or in addition, cells are labeled according to a coverage, quality, interference, or overshooter state (described in greater detail below with respect to FIGS. 4A-4E) that map to “intuitively correct” adjustment directions for the antenna configuration parameters based on domain knowledge applied simultaneously on multiple cells in order to quickly grab big initial gains. Embodiments for determining cell states are described in greater detail later in this disclosure. MRs are processed to derive cell level metrics accounting for every cell's share of blame for measurement reports indicating inadequate coverage or quality. The cell level metrics determine what base incremental adjustments are made to that cell's antenna configuration parameters. Alternatively or in addition, MRs are processed to derive intuitive cell labels or combinations of cell labels indicating any of coverage, quality, interference, and overshooter state of each cell. The one or more labels attached to a cell determine the base incremental adjustments made to that cell's antenna configuration parameters.

The biased random adjustment phase 209 represents a mathematical search procedure that performs explorative techniques and chooses oppositional or random initial directions. Adjustments are accepted when the objective function is improved and accepted with decreasing probability as the objective function worsens and with passage of time (cooling) to steadily improve the solution. Over time, exploration direction can be conditioned to learn from mistakes and, in a later explorative pass, the action learned to be best (in the sense of maximizing instantaneous or cumulative rewards) for a given cell state is chosen. The key facts being exploited are that the system objective function and cell level metrics are aggregations of UE state information (MR) that don't require individual UE locations for evaluation, and that parameter changes matter but not the absolute value.

Process 200 begins at block 202 with the receipt of MRs from UE devices 104. Initiation of the optimization process is triggered at block 204. Optimization may be triggered manually, by network conditions, or automatically based on key performance indicators (KPIs) within LTE network 100. Examples of KPIs include call drop rate and call block rate. Other KPIs are known to those of skill in the art. If analysis of KPIs identify a degradation in network performance, then optimization is triggered. Upon triggering of optimization, process 200 proceeds to the base incremental adjustment phase 205, which includes blocks 206 and 208.

In the base incremental adjustment phase 205, MRs are used in block 206 to determine a direction of adjustment to the antenna configuration parameters (i.e., whether to adjust an antenna configuration parameter up or down). Only the direction of change is determined and not the specific current or starting values of the antenna configuration parameters. The direction of adjustment may be determined in several ways. In one example, the direction of change for each antenna configuration parameter is determined by a blame action metric where a majority rule of UE devices 104 provide MRs indicating a certain change in a direction (up or down) for a respective parameter. In another example, each cell is labeled with a cell state based on the MRs received from UE devices 104. A cell may be given one or more labels identifying a state of the cell, such as an interferer, non-interferer, good/weak coverage, good/weak quality, overshooter, and non-overshooter. Here, interference refers to downlink interference in the cell. These labels are typically determined based on a comparison with one or more thresholds. The exact determination of these thresholds is beyond the scope of this disclosure. The labels given to a particular cell determine the change in direction for the antenna configuration parameters associated with that particular cell.

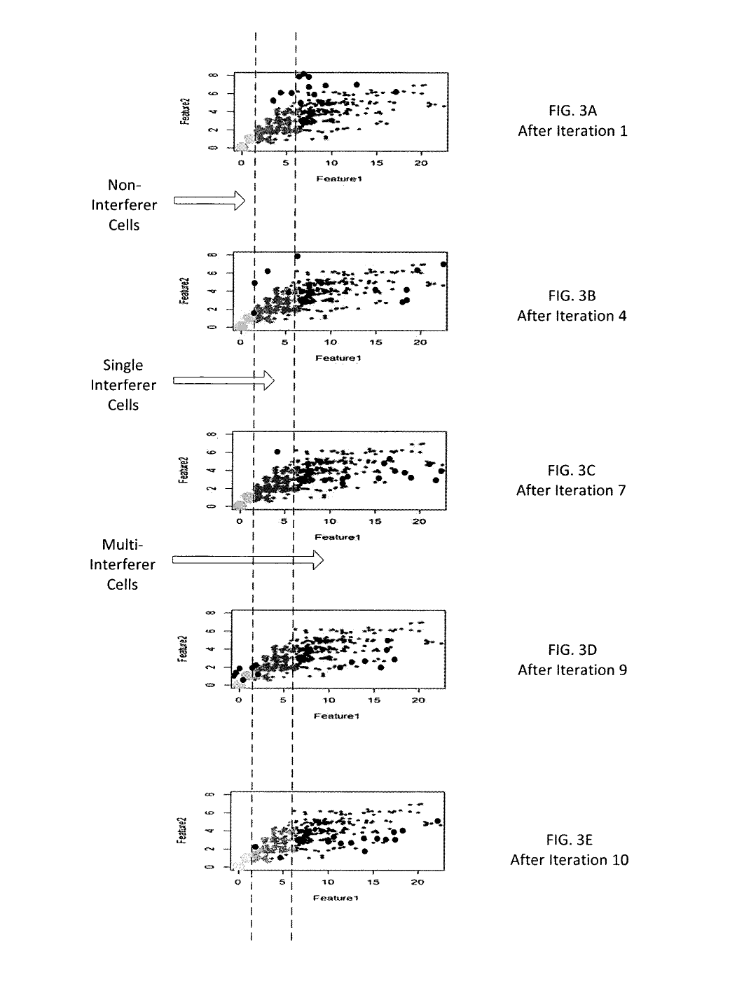

FIGS. 3A-3E show example graphs of global historical data categorizing interfering cells for a plurality of LTE networks. A cell is given an interferer label based on membership in a group cluster. The global historical data categorizes cells as non-interferer, single interferer, or multi-interferer, based on how many nearby cells experience interference from the given cell. The category a cell falls into determines its interferer label. The type of interferer label given to a particular cell determines the direction of adjustments made to the cell's antenna configuration parameters. After an adjustment is made to the antenna configuration parameters, a cell may fall into a different interferer category based on returned MRs from UE devices 104. FIGS. 3A-3E show how cells may move across interferer categories during various iterations of the base incremental adjustment phase 205. For example, looking at the larger circular dots in FIGS. 3A-3E, it can be seen that many of the larger dots improve toward a non-interferer state through iteration 9 (FIG. 3D), but then cause greater interference and move to a multi-interferer state in iteration 10 (FIG. 3E).

FIGS. 4A-4E show example graphs categorizing cells as overshooter cells. An example of an overshooter cell is a cell that provides a high reference signal received power (RSRP) to a UE device 104 but is located some distance from the UE device 104. That is, an overshooter cell causes significant interference from a comparatively far distance (e.g., further than an adjacent cell). A cell labeled as an overshooter may have a particular direction of adjustments made to its antenna configuration parameters (e.g., a down power or down tilt). After an adjustment is made to the antenna configuration parameters, a cell may fall out of or into an overshooter state based on new MRs from UE devices 104, where the new MRs are determined after the adjustment to the antenna configuration parameters. FIGS. 4A-4E show how cells may move into and out of overshooter state during various iterations of the base incremental adjustment phase 205.

After each change in the antenna configuration parameters of the cells, the objective function for network optimization is calculated upon receiving new MRs in block 208 to determine if network performance improves. The objective function is based on a coverage parameter such as RSRP and a quality parameter such as signal to interference and noise ratio of the reference signal (RS-SINR). The objective function is determined by identifying those MRs having their RSRP parameter greater than a first threshold value and identifying those MRs having their RS-SINR parameter greater than a second threshold value. In some embodiments, the objective function is calculated according to the equation:

k1*number of (RSRP>threshold1)+k2*number of (RS-SINR>threshold2),

where k1 and k2 are non-negative numbers that sum to 1.0 and are determined in advance, e.g., by a system user (such as a network engineer) or automatically in a configuration routine. As long as network performance improves as indicated by an increase in the objective function, process 200 will loop through the base incremental adjustment phase 205 in blocks 206 and 208.

Upon identifying a decrease in the objective function in block 208, the base incremental adjustment phase 205 ends and the biased random adjustment phase 209 including blocks 210, 212, and 214 begins. In the biased random adjustment phase 209, simulated annealing is performed where random direction changes are made to the antenna configuration parameters and chaotic jumps are made to escape local minima positions in order to steadily improve the objective function toward a global optimum level. The biased random direction changes are accepted upon obtaining an improvement in the objective function. If the objective function decreases, a probability factor is used in determining whether to accept the random direction changes. Table I shows an example of a simulated annealing algorithm.

TABLE I

| | |
|---|---|
| 1. | Obtain initial solution S and position T |
| 2. | Determine C as the cost of S |
| 3. | Generate new solution S′ |
| 4. | Determine C′ as the cost of S′ |
| 5. | Accept S′ as the current solution S with probability p: |
| | p = exp[(C − C′)/T] if C′ ≧ C; p = 1 if C′ < C |
| 6. | If equilibrium level has not been reached, go to 3. |
| 7. | Update position T |
| 8. | If termination criterion has not been reached, go to 3. |

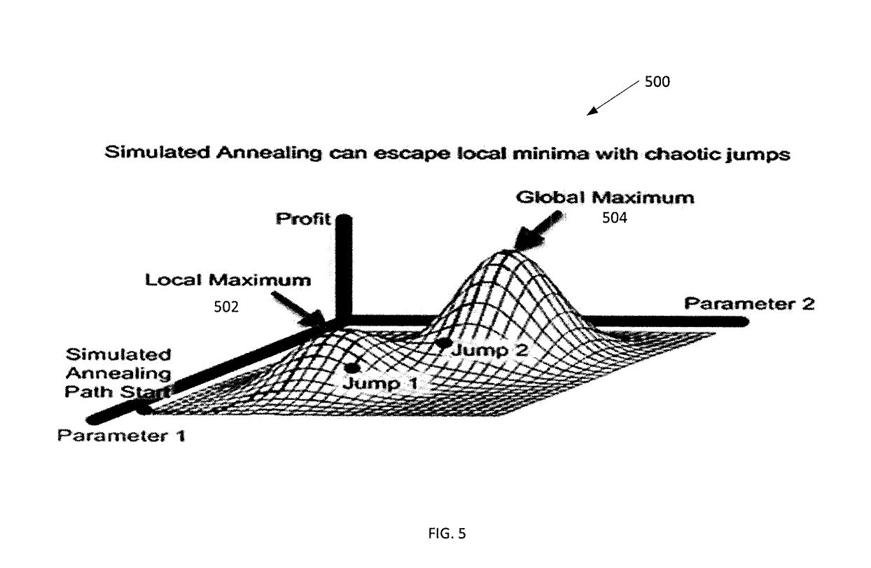

An example of the simulated annealing process that can be performed in the biased adjustment phase 209 is represented by the graph 500 in FIG. 5. The simulated annealing process may identify a local maximum 502 but may perform a chaotic jump (from Jump 1 to Jump 2) in order to locate a global maximum 504. Here, the maximums 502, 504 are determined maximums of the objective function described above. In terms of the present disclosure, biased random adjustments are determined and performed in block 210. After the biased random adjustments have been made, new MRs are received and used to calculate the objective function in block 212. A determination is made as to whether to accept or discard the adjustments based at least on the recalculated objective function in block 214. If the biased random adjustments are discarded, alternative biased random adjustments may be determined when the process 200 returns to block 210. The biased random adjustment phase 209 continues to loop through blocks 210, 212, and 214 and fine tune the parameters until a convergence to a global maximum is reached.

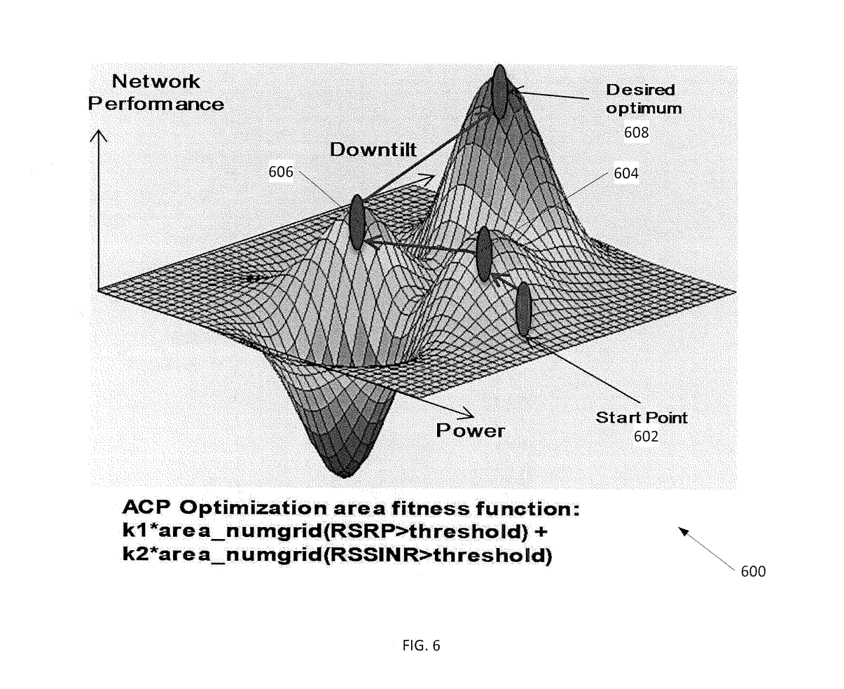

FIG. 6 shows a graph 600 of how the antenna configuration parameters of power and downtilt affect network performance (as measured by the objective function). The goal of process 200 is to identify a desired optimum network performance level 608 from a starting point 602. Process 200 is not aware of the particular starting point 602. Iterating through the base incremental adjustment phase 205 will attain a first intermediate network performance level 604. The biased random adjustment phase 209 will then kick in to perform chaotic jumps to identify the desired optimum network performance level 608, possibly through one or more second intermediate network performance levels 606.

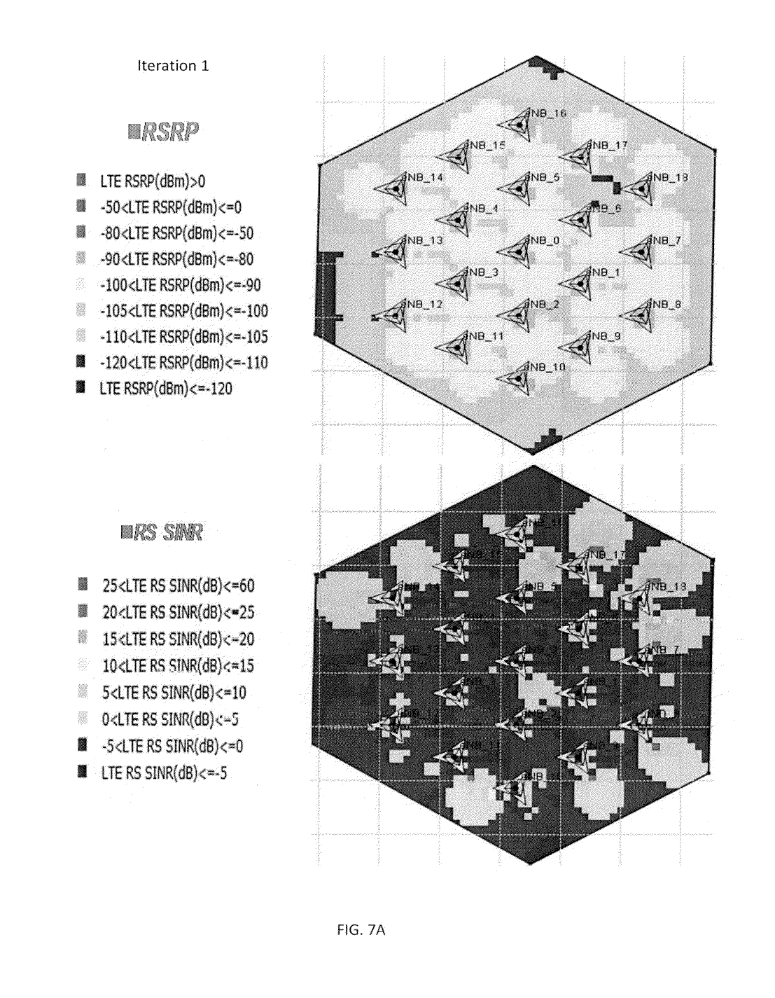

FIGS. 7A-7E show the changes to the two parameters provided in the measurement reports through several iterations of the base incremental adjustment phase 205. The first measured parameter is RSRP. RSRP is a measure of signal strength and identifies the signal level of the Reference Signal transmitted by an eNB radio access node 102 and received by a UE device 104. RSRP is used by UE devices 104 for cell selection and reselection process and is reported to the network to aid in a handover procedure. RSRP is defined as the linear average over the power contributions of the resource elements that carry cell-specific reference signals within the considered measurement frequency bandwidth. The second measured parameter is RS-SINR. RS-SINR is a measure of signal quality and quantifies the relationship between RF conditions and throughput. UE devices 104 typically use RS-SINR to calculate a Channel Quality Indicator (CQI) reported to the network. RS-SINR indicates the power of measured usable signals, the power of measured signals or channel interference signals from other cells in the current system, and background noise related to measurement bandwidths and receiver noise coefficients. Though the present disclosure focuses on RSRP and RS-SINR, there are other parameters provided in the measurement reports that are used in operation of LTE network 100.

As shown in FIGS. 7A-7E, as the eNB radio access nodes 102 iterate through the process and perform base incremental adjustments to the antenna configuration parameters, the measured parameters RSRP and RS-SINR improve through each successive iteration. At some point in the base incremental adjustment phase 205, a lack of growth in the objective function occurs and a degradation can start to occur in the performance characteristics. This lack of growth (and possible degradation) is referred to as an improvement limit. For example, between iteration 9 of FIG. 7D and iteration 10 of FIG. 7E, the RSRP and RS-SINR values begin to decrease in certain areas of LTE network 100.

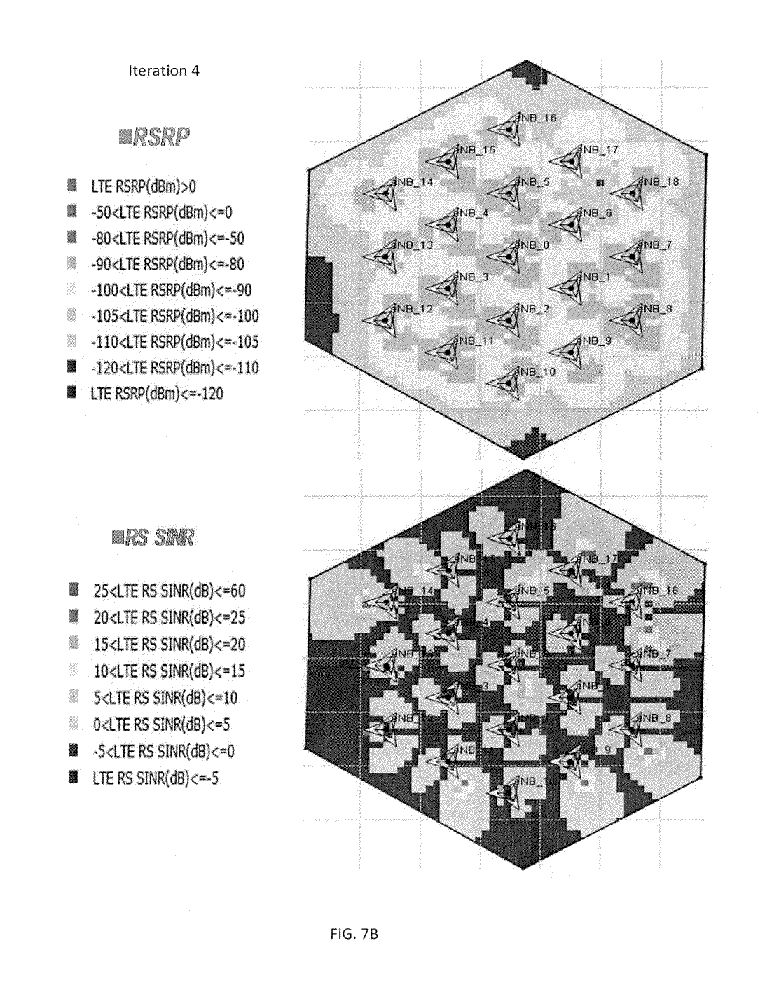

FIG. 8 shows a graph 800 depicting a change in the objective function through the iterations of the base incremental adjustment phase 205. Iteration numbers 1, 4, 7, 9, and 10 correspond to the results of the parameter adjustments shown in FIGS. 7A-7E. The base incremental adjustments rapidly improve performance within LTE network 100, as indicated by the rapid increase in objective function value. The trend in continued performance improvement continues up until a certain point. In complex, non-linear, and noise infused data environments such as provided by LTE network 100, base incremental adjustments to the antenna configuration parameters will reach an improvement limit where the objective function value does not increase (or increases only slightly) and may also provide improvement regression (e.g., a decrease in objective function value). Upon identifying a decrease in performance exceeding a desired threshold level, the base incremental adjustment phase 205 ends and the biased random adjustment phase 209 begins. In the example of FIG. 8, a decrease in performance represented by the objective function occurs between iteration 9 and iteration 10. Approximately at iteration 9 is where the improvement limit occurs.

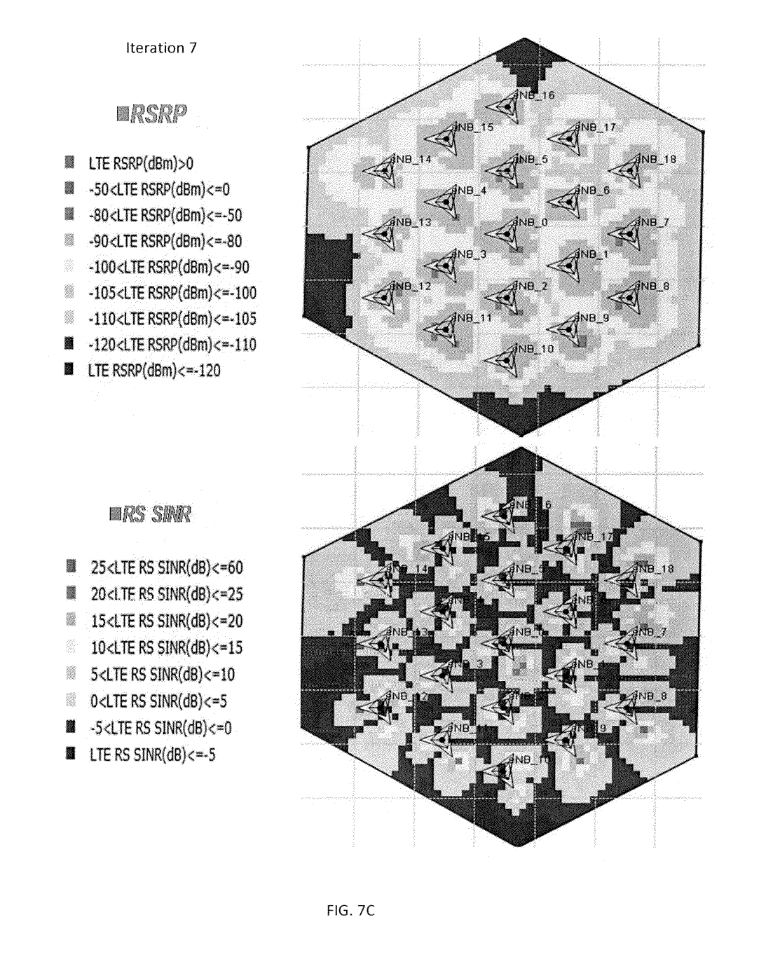

FIG. 9 shows a graph 900 depicting a change in the objective function through the iterations of the biased random adjustment phase 209. As adjustments are accepted and discarded during the biased random adjustment phase 209, an upward drift in improvement in the objective function occurs subject to small oscillations along the way. The biased random adjustment phase 209 continues until an optimum point 902 is reached representing a global maximum, such as global maximum 504 of FIG. 5 or the desired optimum network performance level 608 of FIG. 6.

As described above, an analytics assisted fully automatic closed loop self-organizing network provides a general framework for solving large scale near real time network optimization problems (SON use cases) The optimization process disclosed herein learns online the environment via real-time feedback of UE MRs and cell KPIs using machine learning analytics to assign actionable metrics/labels to cells. The optimizing process self-adapts internal algorithm parameters (like metric thresholds) to changing circumstances (data) and learns the correct action rule for a given cell in a given state. Domain expertise and sophisticated processes (explorative and learning based optimization) are combined in phases for deciding joint corrective actions. This approach contrasts to other approaches that use ad hoc engineering knowledge based rules and unreliable models. The optimization process is robust to engineering parameter database errors and lack of knowledge of UE locations and has minimal modeling assumptions in contrast to expensive and unreliable UE location based optimization techniques.

The optimization process is self-driving in that it uses machine learned cell labels or blame metrics with engineering knowledge guided small step actions to extract quick initial gains in network performance. For further optimization, action is taken in a biased random manner that balances reward with exploration risk. The optimization process learns from mistakes or wrong decisions with time to eventually pick a best action for a given cell state. As a result, the overall process is fast and outperforms engineers fazed by multi-cellular complex interactions. The optimization process provides a cost effective solution by reducing the need for an army of optimization engineers and expensive drive testing and model calibration. The optimization process may be readily extended to optimize additional CCO parameters like channel power offsets and CCO & Load Balancing (CCO+LB) scenarios. The optimization process works for diverse scenarios, including adapting to changes in the cellular network and traffic, and is readily transferable and scalable to other communication domains and deployments.

Determining Cell States to Adjust Antenna Configuration Parameters

The process for optimizing cell specific antenna configuration parameters described above can use various cell states to perform base incremental adjustments. Discussed below are embodiments for determining such cell states according to this disclosure.

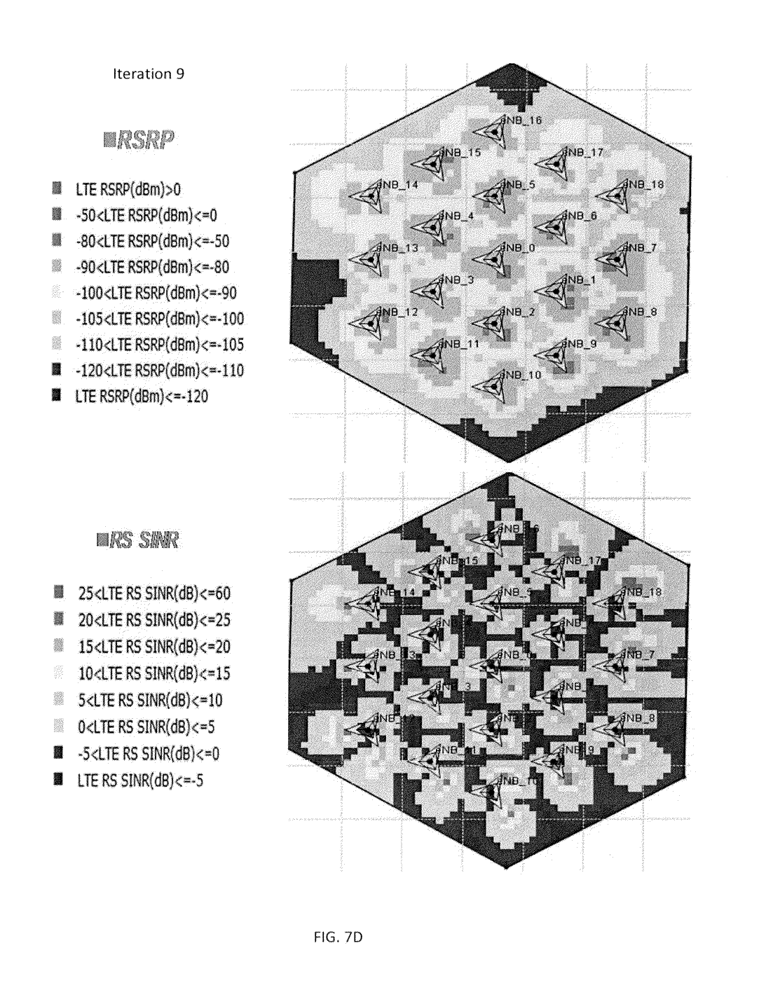

FIG. 10 shows a process 1000 for determining cell states to adjust antenna configuration parameters. Process 1000 begins at block 1002 where MRs are received over the network from UE devices 104. As described above, the MRs can include multiple UE-related and cell-related parameters, such as cell ID, reference signal received power (RSRP), reference signal received quality (RSRQ), serving cell ID, and timing advance parameters. Data extraction, filtering aggregation, and processing are performed on the MRs at block 1004 to obtain values associated with network performance. Values analyzed for network performance include reference signal strength values such as RSRP used in LTE network 100, reference signal quality values, such as Reference Signal Signal-To-Interference-Noise Ratio (RS-SINR) or RSRQ for LTE network 100 may also be included in the analysis effort.

Though discussed in terms of a LTE network 100, process 1000 may be implemented in other network types including a Universal Mobile Telecommunications System (UMTS) network. The reference signal strength values in a UMTS network can include a Received Signal Code Power (RSCP) or Energy per Chip and Interference Level (Ec/Io). Other values derived from the MRs may also be used in the cell state determinations. Though MR information and especially periodic MR information offer the best sampling of the network, other sources of network data may be used including, but not limited to, channel quality indicator (CQI), key performance indicators (KPI), Performance Monitoring (PM) counters, and key quality indicator (KQI) metrics.

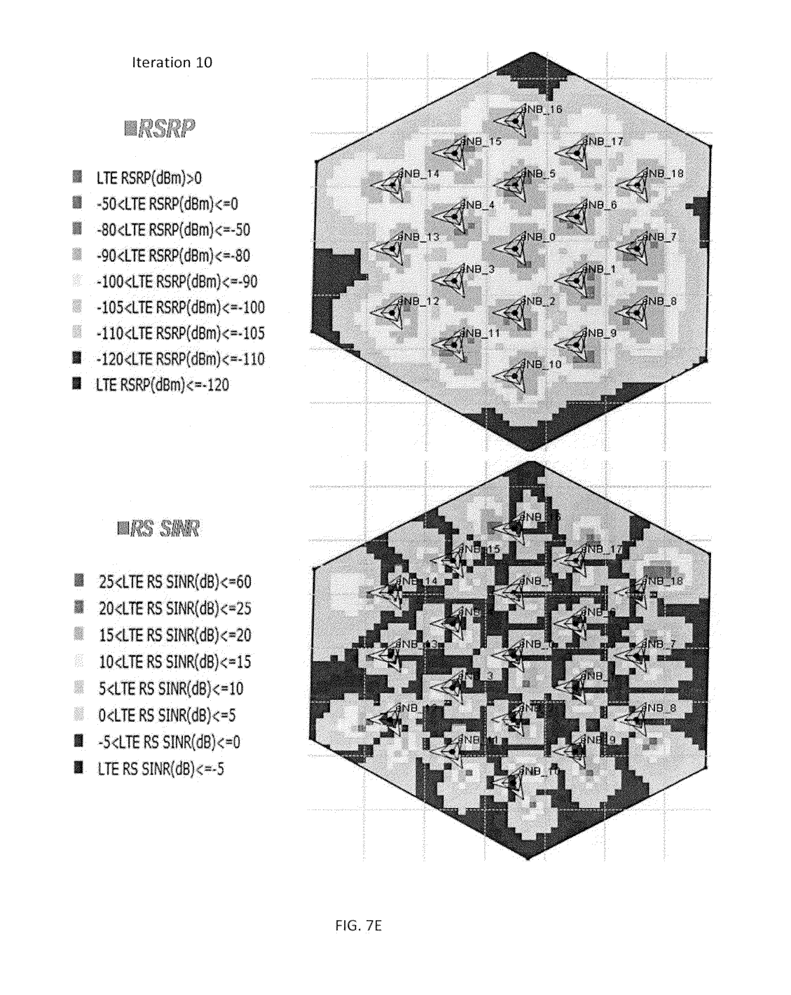

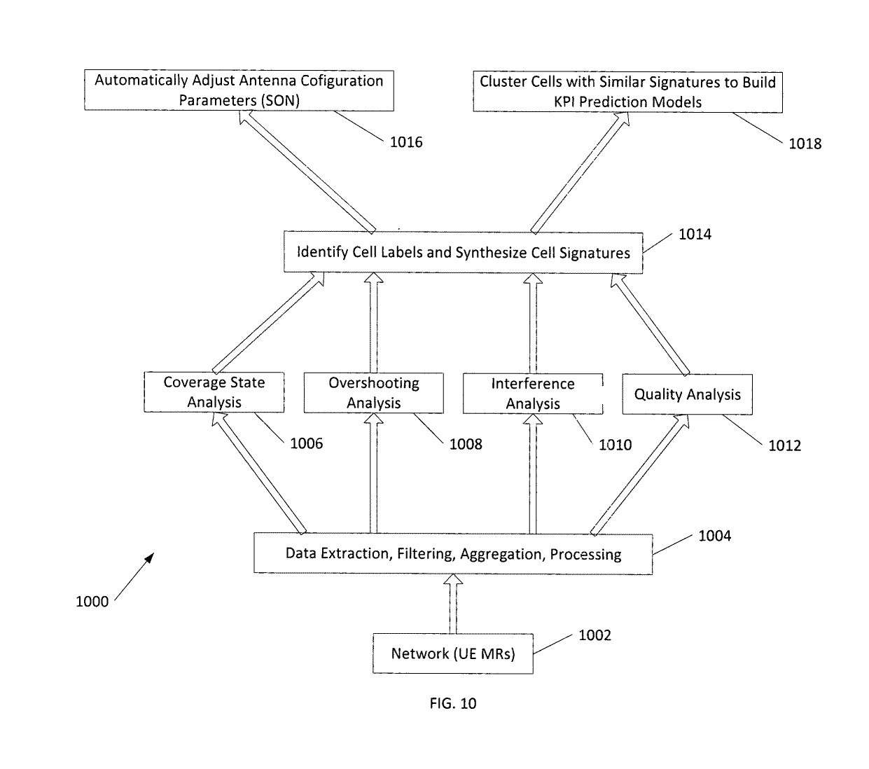

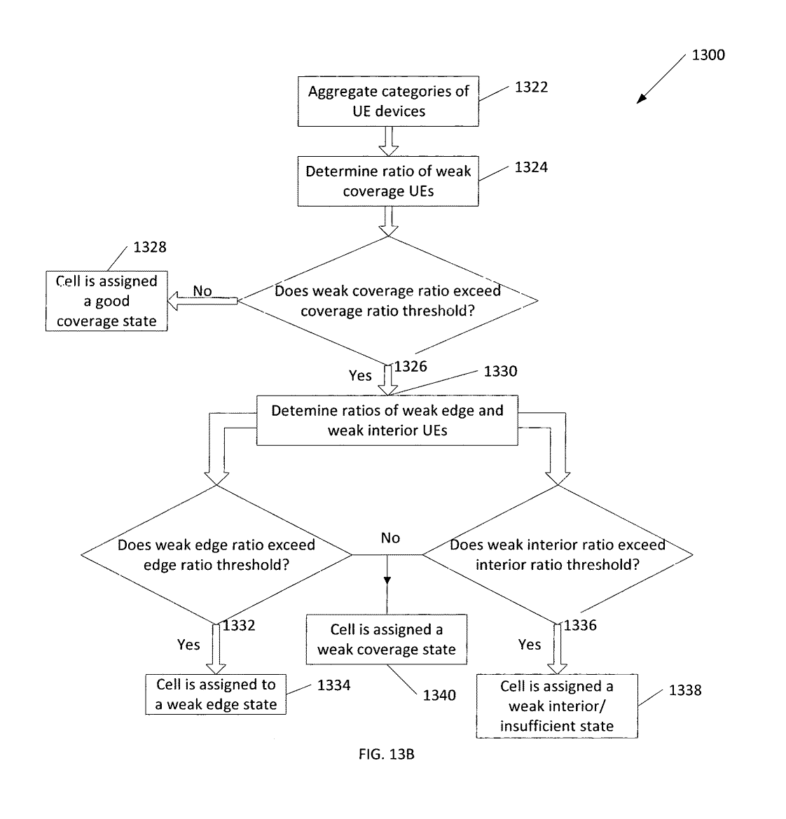

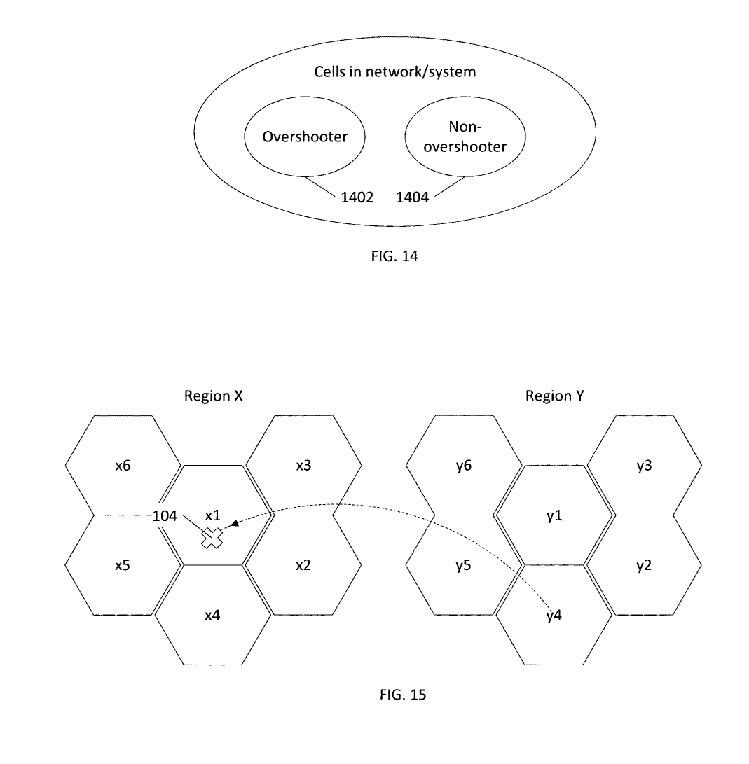

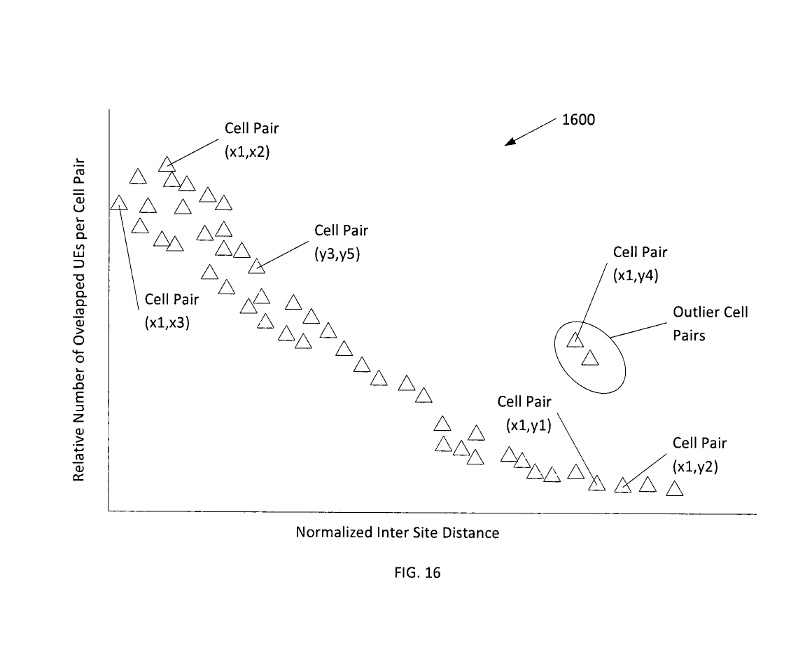

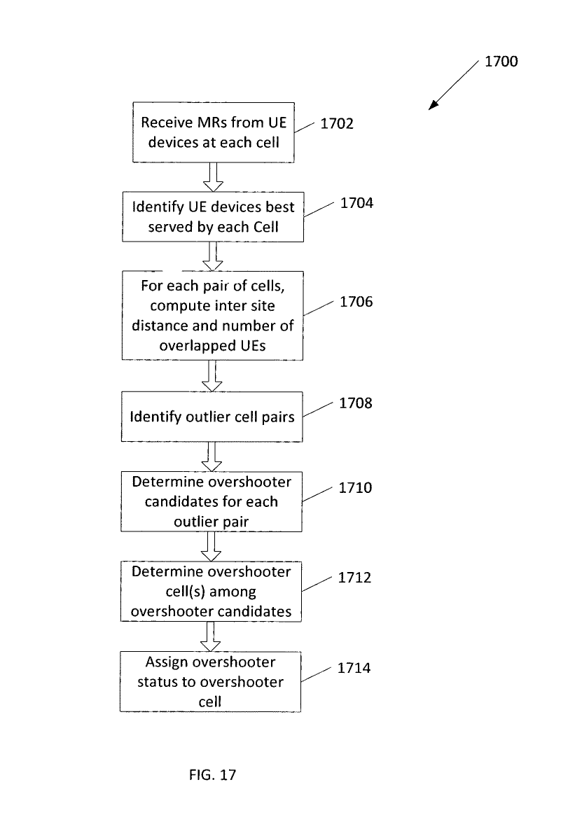

The values derived from MRs transmitted by UE devices 104 are used to perform several cell state determinations for each cell in the network. A coverage state analysis is performed at block 1006 to determine whether the cell provides good or weak coverage. An example of such a coverage state analysis is described in detail below with respect to FIGS. 11-13B. An overshooting analysis is performed at block 1008 to determine whether the cell is an overshooter or a non-overshooter. An example of such an overshooting analysis is described in detail below with respect to FIGS. 14-17. An interference analysis is performed at block 1010 to determine whether the cell is an interferer or non-interferer. An example of such an interference analysis is described in detail below with respect to FIGS. 18 and 19. A quality analysis is performed at block 1012 to determine whether the cell is of good or bad quality. An example of such a quality analysis is described in detail below with respect to FIGS. 20 and 21. At block 1014, cell labels are identified from the cell state determinations and each cell synthesized by combining the set of cell state labels assigned to the cell to create a cell signature.

The cell signature (i.e., the combination of cell labels) for each cell may be used in block 1016 to automatically perform adjustments to the antenna configuration parameters in order to optimize for coverage, quality, and capacity, making use of domain knowledge for actions. For example, a network component may instruct a cluster of cells to adjust their cell configuration parameters (e.g., their antenna tilts, transmit power, or both) based on the cell signature assigned to each cell. As a particular example, if a cell is labeled as “good” coverage and “bad” quality, the transmit power of the cell may be increased. In another example, if a cell is labeled as “good” coverage and “strong” interference, the antenna tilt and/or transmit power of the cell may be decreased. In some embodiments, a combination of labels assigned to each cell and the current antenna tilt and/or RS power level of each corresponding cell are used to determine cell configuration adjustment. In the example where the cell is labeled as “good” coverage and “strong” interference, if the current antenna tilt level of the cell is “small”, then the antennal tilt of the cell may be decreased by a small amount, which is a pre-defined level of antenna tilt amount. In some embodiments, the network component may map a combination of the status labels assigned to a cell and the current antenna tilt and/or RS power levels of the cell to an action and assign the action to the cell. An action represents a change of one or more of a cell's configuration parameters, such as increase or decrease of the antenna tilt and/or RS power of the cell. An action may be assigned based on domain knowledge, experience or expertise in consideration of status labels assigned to a cell, current configuration of the cell, and other factors that may affect its cell status.

In some embodiments, instead of a network component controlling automatic adjustments, the adjustments may be performed semi-automatically by providing the cell signatures to field optimization engineers to guide them in making adjustments to the antenna configuration parameters in the correct direction.

In addition, cells with similar signatures may be clustered in block 1018 to build KPI models for predictive analysis. In general, KPI predictive models are algorithms that identify which KPIs are likely to be a root cause of a poor key quality indicator (KQI), such as packet loss rate. For example, in the context of Coverage Capacity Optimization (CCO), antenna uptilt may be increased when a poor KQI is associated with an RSRP level, as that would indicate the root cause is poor coverage, while antenna downtilt may be increased when a poor KQI is associated with interference, as that would indicate the root cause is poor coverage. KPI predictive models for groups of similar cells can predict network performance given predictors such as traffic and resource consumption variables. KPI predictive models may also predict gains/losses due to the application of a new feature on a given type or group of cells. KPI predictive models are built based on actual historic/field trial data and have demonstrated value for use in feature recommendations, analysis, and improvement. Additional information regarding KPI predictive models can be found in commonly-owned U.S. patent application Ser. No. 14/810,699 filed Jul. 28, 2015, the contents of which are incorporated herein by reference. Cell labels and signatures generated from MRs transmitted by UE devices 104 offer a way of grouping like cells to pool data together in building more powerful predictive analytics models.

FIG. 11 shows the coverage states that can be assigned to a cell as determined in block 1006 of FIG. 10. A cell may have a state of good coverage 1102 or weak coverage 1104. If a cell is considered in a weak coverage state 1104, the cell may be further assigned a weak edge state 1106 or a weak interior/insufficient state 1108. A cell assigned a weak coverage state 1104 may also be assigned both a weak edge state 1106 and a weak interior/insufficient state 1108. In addition, it is possible that a cell assigned a weak coverage state 1104 may not be considered either in a weak edge state 1106 or a weak interior/insufficient state 1108. The assignment of a cell to a weak coverage state 1104, a weak edge state 1106, and/or a weak interior/insufficient state 1108 is based on RSRP values in MRs transmitted by UE devices 104. Of course, the coverage states 1102-1108 shown in FIG. 11 are merely one example. In other embodiments, there may be additional, intermediate coverage states. For example, there may be one or more additional weak coverage states based on ranges of RSRP values.

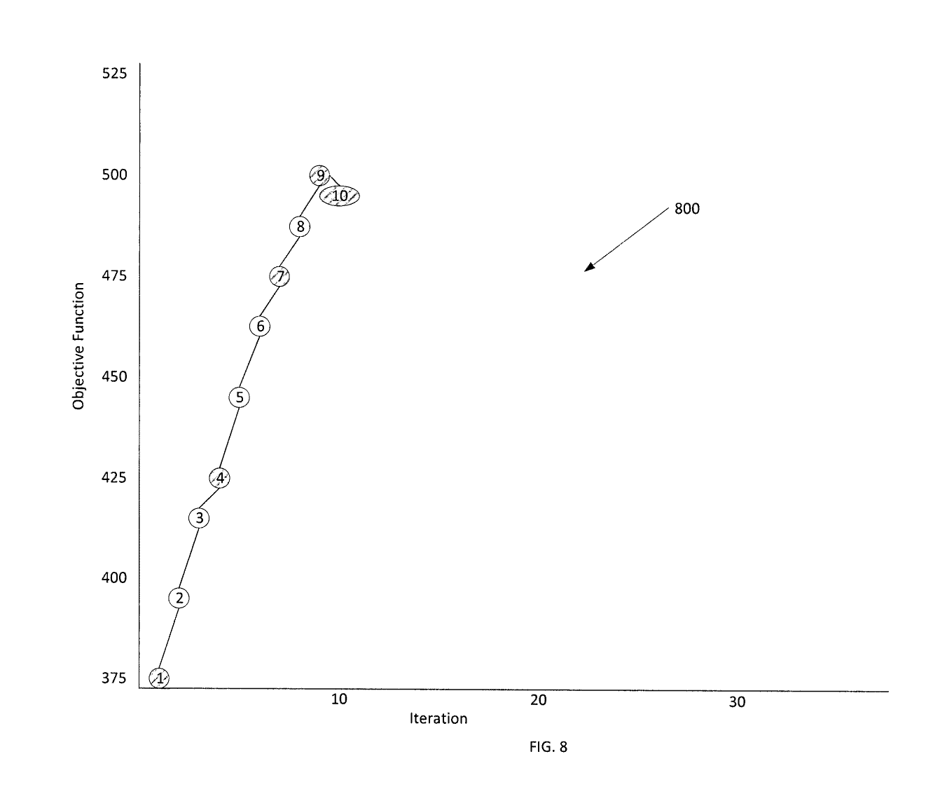

FIG. 12 shows an example of how a cell may be considered in a weak edge state 1106 and/or a weak interior/insufficient state 1108. A cell in a weak edge state 1106 has a certain number/percentage of UE devices 104 that it serves with corresponding RSRP values below a coverage threshold. In addition, a cell in weak edge state 1106 has a certain number/percentage of UE devices 104 that it serves with RSRP values associated with one or more neighboring cells within a coverage reference range of an average RSRP value for the cell. In this scenario, a UE device 104 with a low RSRP value corresponding to the best serving cell coupled with a high enough RSRP value associated with a neighboring cell is most likely located near the edge of coverage provided by the best serving cell.

To be considered in a weak interior/insufficient state 1108, the cell has a certain number/percentage of UE devices 104 that are served by the cell RSRP values below a coverage threshold. In addition, these UE devices 104 do not report a RSRP value associated with a neighboring cell that is within the coverage reference range. A UE device 104 with a low RSRP value for the best serving cell coupled with no significant RSRP value for a neighboring cell is most likely located near the interior of the cell.

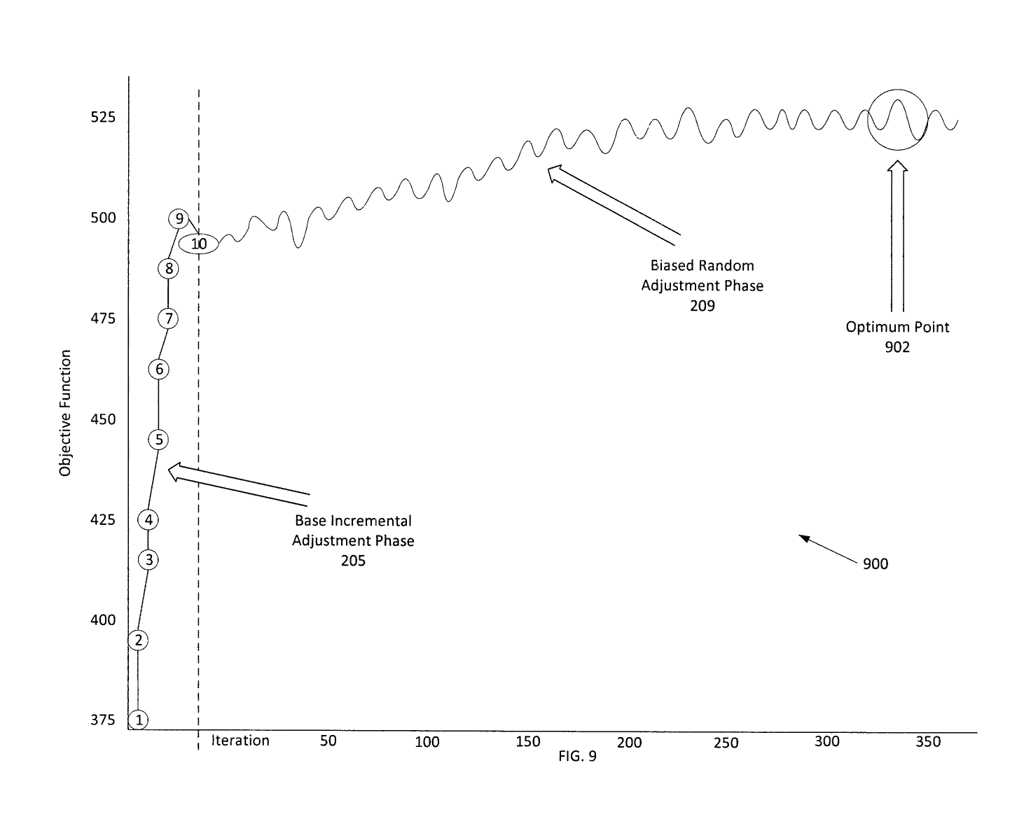

FIGS. 13A-13B show a process 1300 for determining a coverage state for a cell. In FIG. 13A, process 1300 first performs individual analysis of each UE device 104 best served by the cell and categorizes each UE device 104 as one of good coverage or weak coverage. Those UE devices 104 of weak coverage are further categorized as being of weak edge coverage or weak interior/insufficient coverage. In FIG. 13B, process 1300 then aggregates the categories of the UE devices 104, determines ratios of UE devices belonging to the cell with weak coverage, and compares the ratio to thresholds in order to assign a coverage state to the cell.

In FIG. 13A, process 1300 begins at block 1302 with the receipt of MRs from UE devices 104. From the MRs, those UE devices 104 best served by the cell are identified in block 1304. For each UE device 104, the RSRP value from the MR corresponding to the cell is compared to a coverage threshold value in block 1306. If this RSRP value exceeds the coverage threshold, the UE device 104 is assigned to a good coverage category at block 1308. If this RSRP value does not exceed the coverage threshold value, the UE device 104 is initially assigned to a weak coverage category at block 1310. At block 1312, the RSRP values associated with neighbor cells in the MR of the UE device are compared to a coverage offset threshold range. If at least one RSRP value associated with a neighbor cell is within the coverage offset threshold range, the UE device 104 is assigned to a weak edge category at block 1314. If there are no RSRP values associated with neighbor cells within the coverage offset threshold range, the UE device 104 is assigned to a weak interior/insufficient category at block 1316. Unlike a cell that can be assigned to either, both, or neither of a weak edge state and a weak interior/insufficient state, a UE device 104 of weak coverage is categorized as only one of weak edge or weak interior.

In FIG. 13B, process 1300 continues at block 1322 with the aggregation of the categories for the UE devices 104 determined in FIG. 13A. At block 1324, a ratio of weak coverage UEs is determined from the aggregation. The ratio of weak coverage UEs is compared to a coverage ratio threshold at block 1326. If the ratio of weak coverage UEs does not exceed a coverage ratio threshold, then the cell is assigned a good coverage state at block 1328. If the ratio of weak coverage UEs does exceed the coverage ratio threshold at block 1326, the ratios for weak edge UEs and weak interior/insufficient UEs are determined at block 1330. At block 1332, the ratio of weak edge UEs is compared to an edge ratio threshold. If the ratio of weak edge UEs exceeds the edge ratio threshold, then the cell is assigned to a weak edge state at block 1334. In addition, the ratio of weak interior/insufficient UEs is compared to an interior ratio threshold at block 1336. If the ratio of weak interior/insufficient UEs exceeds the interior ratio threshold, then the cell is assigned to a weak interior/insufficient state at block 1338. If neither the ratios of weak edge UEs nor weak interior/insufficient UEs exceed their respective ratio thresholds, the cell is assigned a weak coverage state in block 1340.

FIG. 14 shows the overshooting states that can be assigned to a cell as determined in block 1008 of FIG. 10. A cell may be assigned an overshooter state 1402 or a non-overshooter state 1404. A cell may be considered to be in an overshooter state 1402 if its associated RSRP value in a MR of a UE device 104 served by a distant cell in another region ranks within a certain number of top RSRP values for the distant cell.

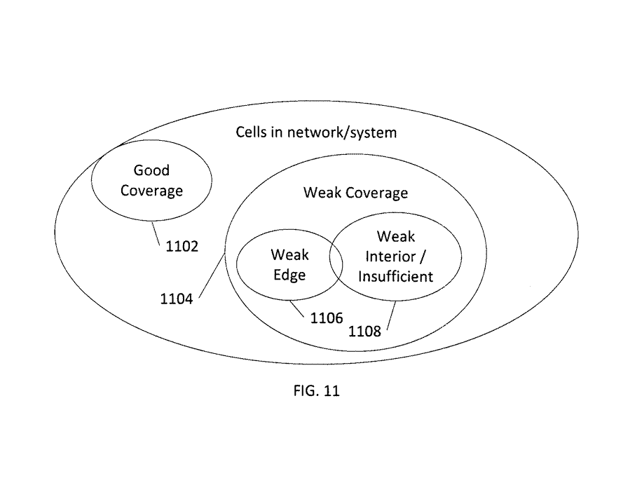

FIG. 15 shows an example of a cell in an overshooter state. UE device 104 located in and best served by cell x1 of Region X transmits a MR to eNB radio access node 102 providing coverage for cell x1. Note that the exact location of UE device 104 is unknown and does not need to be known. The parameter values in the MR transmitted by UE device 104 provide an indication that UE device 104 is served by cell x1 which is all that is needed for analysis purposes. The parameter values in the MR transmitted by UE device 104 may indicate a potential overshooter cell. In this example, cell y4 of Region Y may potentially be in an overshooter state. Cell y4 may be in an overshooter state if a RSRP value associated therewith is in a certain top number of reported RSRP values and/or within a certain threshold of the RSRP value corresponding to cell x1. For example, a MR report transmitted by UE device 104 in cell x1 includes multiple RSRP values associated with different cells. Table II shows a ranked list of the top six RSRP values reported by UE device 104 in its MR.

TABLE II

| RSRP Value Rank | Cell |
|---|---|
| 1 | x1 (overshootee) |
| 2 | x2 |
| 3 | x3 |
| 4 | y4 (overshooter) |
| 5 | x4 |
| 6 | x5 |

Cell y4, being in Region Y, is relatively far away from cell x1 as compared to the other cells in Region X. Typically, a cell that is relatively far away would not tend to be ranked near the top of the RSRP value list. Thus, it would be typical for cell y4 to be ranked much lower in Table H (e.g., at least below cells x4 and x5, which are much nearer to cell x1). By being in the top six of RSRP values for UE device 104, cell y4 is a potential overshooter. In addition, a UE device 104 is considered in an overlapped state if a pair of cells appears in the top k values of the RSRP value list determined from the transmitted MR and/or the difference between RSRP values is less than a certain threshold. An example threshold value is 3 dB, though any threshold value may be used as desired. Consideration of multiple overlapped UE devices 104 in an area or network is given to identify potential overshooters as overshooters or not overshooters, which will now be described.

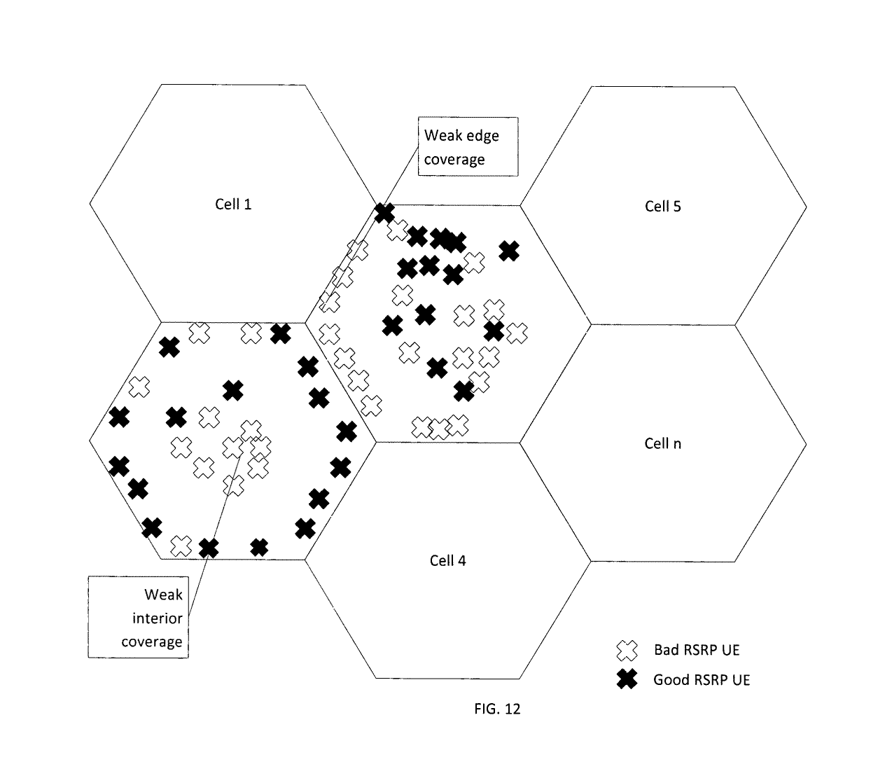

FIG. 16 shows a graph 1600 depicting a relationship between overlapped UE devices 104 and overshooting identification. Each point in graph 1600 is a cell pair where the distance between cells in a cell pair increases along the y-axis. Ideally, a larger inter site distance between cells in a cell pair should lead to less overlapped UE devices 104 for the cell pair. Using the cell identifiers of FIG. 15, a relatively high number of overlapped UE devices 104 exist for cell pair x1,x2; cell pair x1,x3; and cell pair y3,y5, which is expected since there is a relatively short distance between the respective cells of each cell pair. A relatively low number of overlapped UE devices 104 exist for cell pair x1,y1 and cell pair x1,y2 as there is a relatively large distance between the cells of each cell pair.

Outlier cell pairs from the norm indicate an overshooter potential. The outlier cell pairs, such as cell pair x1,y4, have an abnormally high number of overlapped UE devices 104 as compared to cell pairs of a similar inter site distance. Identification of an outlier cell pair indicates that at least one cell in the cell pair may be in an overshooter state. Thus, cells x1 and y4 are both overshooter candidates; however, it is not clear just from looking at FIG. 16 if cell x1 is the overshooter and cell y4 is the overshootee, or if cell y4 is the overshooter and cell x1 is the overshootee. To determine the overshooter among the overshooter candidates, the ranked RSRP value lists such as shown in Table II are also considered. From Table II, it can be seen that cell y4 is a candidate for an overshooter state as its associated RSRP value is in an unexpected position in the RSRP value list of a UE device 104 being served by cell x1 in a different region than cell y4. However, an examination of a similar RSRP value list of a UE device 104 being served by cell y4 may reveal that cell x1 is not in an unexpected position in the RSRP value list. For example, cell x1 may rank below all of the cells y1-y6 and rank among the cells x1-x6, as would be expected if cell x1 is not an overshooter. Thus, by examining RSRP values lists for UE devices 104 served by cell x1 and UE devices 104 served by cell y4, it can be determined that cell y4 is an overshooter and cell x1 is not an overshooter.

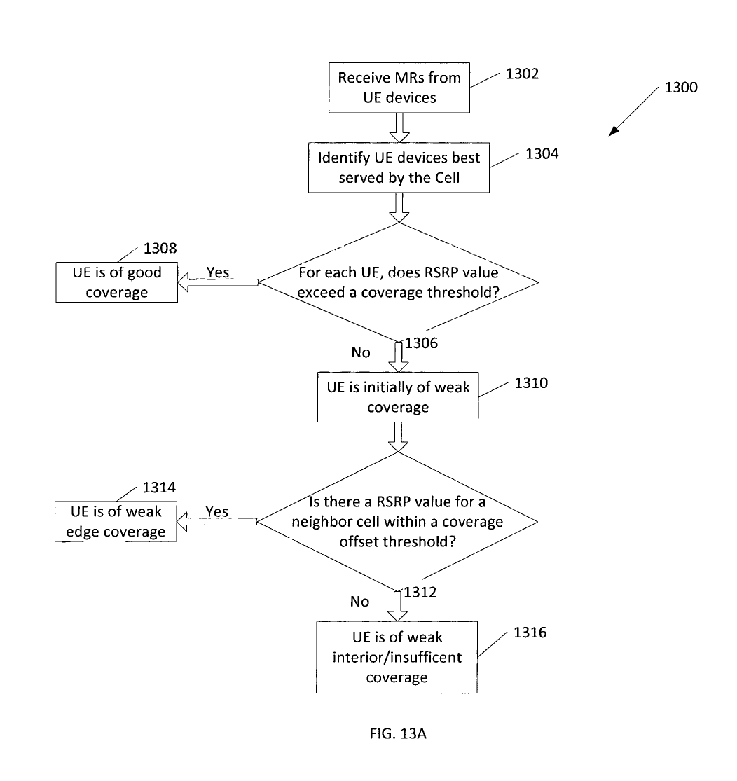

FIG. 17 shows a process for determining an overshooter state of a cell. Process 1700 begins at block 1702 with the receipt of MRs from UE devices 104 for each cell. From the MRs, those UE devices 104 best served by each cell are identified in block 1704. Cells are then paired up with every other cell at block 1706 and an inter site distance and number of overlapping UE devices are computed for each cell pair. Inter site distance may be normalized by the median inter site distance of a cell with its top neighbors. Normalization may be performed by dividing the inter site distance of a reference cell (such as x1) in the pair to its top n closest tier neighbor cells. Normalization is performed to standardize a picture across cells and create a global database of real world or well simulated examples. Outlier cell pairs are then identified in block 1708. An outlier cell pair may have an abnormal number of overlapping UE devices 104 in relation to the inter site distance between the cells in the cell pair. For each outlier pair, the overshooter candidate cells are determined at block 1710. Then, in block 1712, the overshooter(s) among the overshooter candidates are determined by examining ranked lists of RSRP values. For example, as described above, the overshooter cell will have its associated RSRP value near the top of the RSRP values of the other cell in the outlier cell pair. The overshooter state is assigned to the overshooter cell in block 1714.

In accordance with another embodiment, an algorithm for determining an overshooter state will now be described. The algorithm uses quantities termed N( ), Serving_Radius( ) and Planned_Radius( ) which are defined as follows.

N(s) is the set of all neighbor cells in an “estimated” neighbor list of a given serving cell s. The set N(s) can be inferred or estimated (either making use of cell azimuth information or without it) based on information extracted from one or more MRs. At a later point in the algorithm, N(s) can also be used to calculate a feature normalization factor, which is the sum of all MRs served by cell s and its neighbors.

Serving_Radius(s,o) maps one or more topology parameters involving a pair of cells (serving cell s and neighbor cell o) to a radius of serving cell s in the direction of cell o.

Planned_Radius(s) of a cell s is the average or median of Serving_Radius(s,o) over a predetermined most-related subset of cells o in the neighbor list of s, i.e., all o in N(s).

The algorithm performs overshooter detection as follows. In one or more cell-level variables for cell c, a counter for the algorithm counts the following values:

(1) The number of MRs served by a cell c with bad serving cell RSRQ (e.g., worse than T3 dB) and with no other significant overlapping cells (i.e., RSRPs in the MR list that are within T2 dB of the serving cell) that are “far away,” as determined by the TA distance from c. Here, T3 is a predetermined RSRQ threshold separating good RSRQ of an MR (for the serving cell) from bad RSRQ and may be in a range of, e.g., [−20,0]. T2 is a predetermined RSRP offset to determine whether a pair of cells have significant overlap in an MR and may be in a range of, e.g., [9, 20]. TA distance is a parameter that is found in the MR and represents an estimated distance of a UE device that submits the MR from its serving cell.

(2) The number of MRs served by cell c with bad serving cell RSRQ (e.g., worse than T3 dB) and other significant overlapping cells present that are “far away” in terms of TA distance from c and such that the number of significant “far away” non-neighbor overlapping cells form a significant fraction (e.g., larger than Tn threshold) of the total number of overlapping cells. Here, Tn represents a threshold of a proportion of neighbors to the total number of cells seen in an MR for overshooter detection. As this is a ratio of small integers, only certain quantized values (e.g., between 0 and 1) make sense as threshold choices.

(3) The number of MRs not served by cell c with bad serving cell RSRQ (e.g., worse than T3 dB) and in which cell c is a significant overlapper and also a “far away” non-neighbor of the serving cell (that itself has been judged to be “not far away” from the MR).

This counter is then normalized with a blame normalization factor of c (i.e., the number of MRs served by c and all of its neighbors) and compared with a threshold Tos. Here, Tos is a predetermined threshold and may be between 0 and 1.

The cell c is declared an overshooter if the normalized overshoot counter of cell c exceeds Tos AND the fraction of MRs served by cell c with respect to an analysis cluster average per cell exceeds Tosormintraf. Here, Tosormintraf is a predetermined threshold that represents a minimum fraction of traffic (i.e., served MRs of a cell/analysis cluster average of MRs per cell) that a cell must carry before it is eligible to be declared as an overshooter. This latter condition on cell c's traffic is for stable statistical inference purpose. It is noted that the “far away” judgment above for an MR is based on its TA distance ratio (with respect to the serving cell's planned radius) exceeding Factor1Upper. Here, Factor1Upper represents a predetermined threshold to compare the ratio of the TA based distance of MR to a planned radius of the serving cell and decide whether MR is far away.

Normalization of the counters using the total traffic (served MRs) of the serving cell s and its estimated neighbors N(s) is important to ensure the setting of standard thresholds invariant to traffic or the specific set of cells being analyzed.

Thresholds used for overshooting, such as Tos, can be learned by offline analysis of real field trial or market data. If labeled examples (by domain expert engineers) of overshooters are used to guide threshold setting, it is called supervised learning; otherwise it is called unsupervised learning (that looks at the groupings of the metrics and outliers to determine thresholds). Similarly, if automatic algorithms learn the thresholds, it is called machine learning.

FIG. 18 shows the interference states that can be assigned to a cell as determined in block 1010 of FIG. 10. As shown in FIG. 18, a cell may be considered as being a strong/multi-interferer 1802, a medium/single-interferer 1804, or a weak/non-interferer 1806. Of course, this is merely one example. In other embodiments, there may be additional, intermediate interferer states between strong/multi-interferer 1802 and weak/non-interferer 1806 that represent differing levels of interference. A first cell may be an interfering cell to a second cell if a RSRP associated with the first cell in a MR of a UE device 104 best served by the second cell is within a threshold range of an average RSRP reported by UE devices 104 best served by the second cell.

FIG. 19 shows a process for determining an interferer state of a cell. Process 1900 begins at block 1902 with the receipt of MRs from UE devices 104 for each cell. From the MRs, those UE devices 104 best served by each cell are identified in block 1904. At block 1906, a determination is made in each cell if a RSRP associated with another cell is within a top k of RSRPs for the cell and/or within a reference range of an average RSRP in each cell. A cell having a RSRP within a top k of RSRPs for another cell may be an interferer to that cell. In block 1908, UE devices 104 best served by each cell as having a RS-SINR below a quality threshold due to a RSRP of another cell being within a threshold range of top RSRP values for the cell are identified. An interference blame counter is maintained in block 1910 for each cell as a cell pair with the other cells to record how many UE devices 104 are affected by a non-serving cell. A total blame counter for a cell is determined in block 1912 by summing interference blame counters over all affected cells. A check is made in block 1914 as to whether the total blame counter is greater than a first or second interference threshold. If the total blame counter is not greater than the first or second interference threshold, the cell is assigned a weak/non-interfering state at block 1916. If the total blame counter is greater than the first interference threshold but less than the second interference threshold, the cell is assigned a medium/single-interfering state at block 1918. If the total blame counter is greater than the second interference threshold, the cell is assigned a strong/multi-interferer state. The total blame counter may be normalized by the total number of UE devices 104 served by all cells in the neighborhood of the cell being assigned an interferer state.

The embodiment of FIG. 19 described above is based on consideration of one interference feature or metric, namely the number of UE devices having an RS-SINR below a quality threshold. This is merely one example. In other embodiments, other or additional interference features may be used in the analysis, including a number of cells a particular cell affects significantly in terms of a number or percentage of affected UE devices 104, or an average or median RSRP of a potential interferer cell MRs of UE devise 104 served by neighbor cells. In some embodiments, multiple interference features may be considered against multiple corresponding thresholds. If multiple interference features are considered (each with a corresponding threshold), a clustering algorithm such as shown in FIGS. 3A-3E may be used to analyze the multiple interference features concurrently.

FIG. 20 shows the quality states that can be assigned to a cell as determined in block 1012 of FIG. 10. A cell may be considered as being of good quality 2002 or bad quality 2004. A particular cell with a certain percentage of good quality UE devices 104 where the particular cell is the best server for the UE devices 104 is assigned a good quality state. A particular cell with less than a certain percentage of good quality UE devices 104 where the particular cell is the best server for the UE devices 104 is assigned a bad quality state. A good quality UE device 104 is one where the RS-SINR or RSRQ value is greater than a quality threshold value. The quality threshold may be fixed, dynamically adjusted, or learned in a supervised, semi-supervised, or unsupervised manner by correlating UE device 104 RS-SINR or RSRQ against relevant key performance indicators (KPI) and key quality indicators (KQI) describing a UE device 104 quality of experience (QoE). Of course, the quality states 2002-2004 shown in FIG. 20 are merely one example. In other embodiments, there may be one or more additional, intermediate quality states between good quality 2002 and bad quality 2004 based on intermediate thresholds of good quality UE devices 104.

FIG. 21 shows a process 2100 for determining a quality state of a cell. Process 2100 begins at block 2102 with the receipt of MRs from UE devices 104. From the MRs, those UE devices 104 best served by the cell are identified in block 2104. For the UE devices 104 best served by the cell, the RS-SINR/RSRQ value from the MRs are compared to a quality threshold value at block 2106. A percentage of UE devices 104 best served by the cell that exceed the quality threshold value is determined at block 2108. At block 2110, the percentage of UE devices 104 exceeding the quality threshold value is compared to a quality reference percentage. If the percentage of UE devices 104 exceeding the quality threshold value is greater than the quality reference percentage, the cell is assigned a good quality state at block 2112. If the percentage of UE devices 104 exceeding the quality threshold value is not greater than the quality reference percentage, the cell is assigned a bad quality state at block 2114. The assignment of a good or bad quality state to the cell affects the adjustments to the antenna configuration parameters for the cell. The cell may be assigned a good or bad quality state in varying degrees based on how much the percentage is greater than or not greater than the quality reference percentage. Differing degrees of good and bad quality state may provide different adjustments to the antenna configuration parameters of the cell.

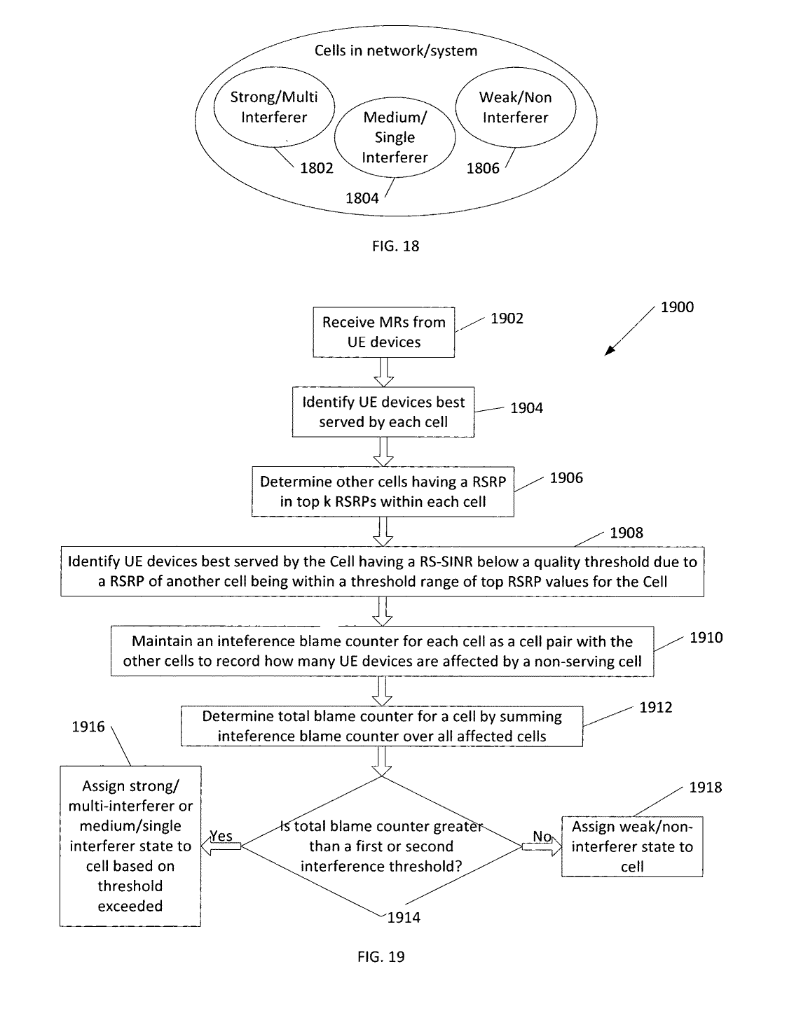

FIG. 22 shows a block diagram of a transceiver 2200 adapted to transmit and receive signaling over LTE network 100. One or more transceivers 2200 may be implemented in eNB radio access nodes 102 configured for adjusting cell specific configuration parameters, such as antenna configuration parameters, and/or determining cell states, as described in the embodiments herein. As shown, the transceiver 2200 comprises a network-side interface 2202, a coupler 2204, a transmitter 2206, a receiver 2208, a signal processor 2210, and device-side interface(s) 2212. The network-side interface 2202 may include any component or collection of components including antennas adapted to transmit or receive signaling over LTE network 100. The coupler 2204 may include any component or collection of components adapted to facilitate bi-directional communication over the network-side interface 2202. The transmitter 2206 may include any component or collection of components (e.g., up-converter, power amplifier, etc.) adapted to convert a baseband signal into a modulated carrier signal suitable for transmission over the network-side interface 2202. The receiver 2208 may include any component or collection of components (e.g., down-converter, low noise amplifier, etc.) adapted to convert a carrier signal received over the network-side interface 2202 into a baseband signal. The signal processor 2210 may include any component or collection of components adapted to convert a baseband signal into a data signal suitable for communication over the device-side interface(s) 2212, or vice-versa. The device-side interface(s) 2212 may include any component or collection of components adapted to communicate data-signals between the signal processor 2210 and components within the host device (e.g., UE devices 104, local area network (LAN) ports, etc.).

The transceiver 2200 may transmit and receive signaling over any type of communications medium. In some embodiments, the transceiver 2200 transmits and receives signaling over a wireless medium. For example, the transceiver 2200 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 2202 comprises one or more antenna/radiating elements. For example, the network-side interface 2202 may include a single antenna, multiple separate antennas, or a multi-antenna array configured for multi-layer communication, e.g., single input multiple output (SIMO), multiple input single output (MISO), multiple input multiple output (MIMO), etc. The configuration parameters of these antennas are adjusted based on the one or more states of the cell as determined above. In other embodiments, the transceiver 2200 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

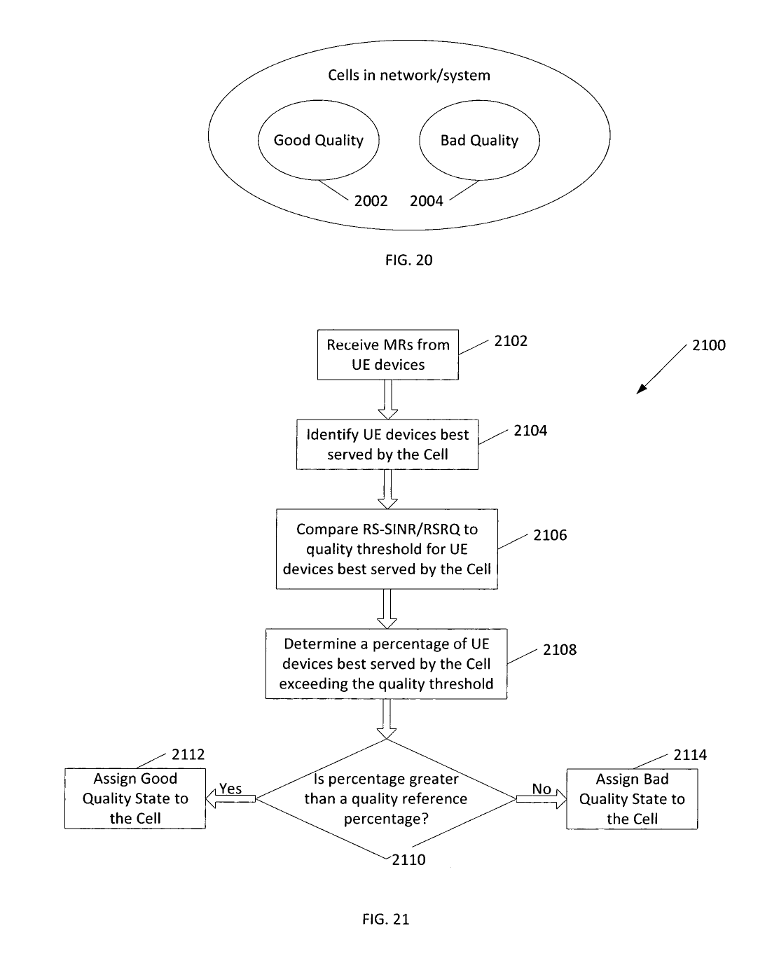

FIG. 23 illustrates a simplified example of a general-purpose computing component 2300 suitable for implementing one or more embodiments disclosed herein. Computing component 2300 may be incorporated at each cell to determine the one or more states of the cell as discussed above. The features described above for adjusting cell specific antenna configuration parameters and/or determining cell states may be implemented on any general-purpose computing component, such as a computer or network component with sufficient processing power, memory resources, and network throughput capability to handle the necessary workload placed upon it. For example, computing component 2300 may be implemented in each eNB radio access node 102 or in a centralized server at the network level to perform the features described herein. The computing component 2300 includes a processor 2302 (which may be referred to as a central processor unit or CPU) that is in communication with memory devices including secondary storage 2304, read only memory (ROM) 2306, random access memory (RAM) 2308, input/output (I/O) devices 2310, and network/component connectivity devices 2312. The processor 2302 may be implemented as one or more CPU chips, or may be part of one or more application specific integrated circuits (ASICs).

The secondary storage 2304 is typically comprised of one or more disk drives or tape drives and is used for non-volatile storage of data and as an over-flow data storage device if RAM 2308 is not large enough to hold all working data. Secondary storage 2304 may be used to store programs that are loaded into RAM 2308 when such programs are selected for execution. The ROM 2306 is used to store instructions and perhaps data that are read during program execution. ROM 2306 is a non-volatile memory device that typically has a small memory capacity relative to the larger memory capacity of secondary storage 2304. The RAM 2308 is used to store volatile data and perhaps to store instructions. Access to both ROM 2306 and RAM 2308 is typically faster than to secondary storage 2304.

Solutions for Large Scale Near Real Time Network Optimization Problems

Embodiments of this disclosure provide a general approach for solving large scale near real time network optimization problems (e.g., SON use cases). Embodiments of this disclosure may divide large networks into subgroups of smaller networks, and then optimize control decisions for the subgroups using a simulated annealing technique. Simulated annealing (SA) is a generic probabilistic meta-heuristic approach for solving global optimization problems that locate a good approximation to the global optimum of a given function in a large search space. In an embodiment, a method may dynamically identify and/or sort problematic cells at the global or sub-group level, and optimize cells based on priority such that the more problematic cells are optimized first. In some embodiments, self learning solutions are executed online based real-time feedback (e.g., UE MRs, KPIs, mistakes, rewards). Self learning solutions may also be executed offline based on a simulation.

Embodiments of this disclosure may provide techniques for avoiding local optimization to obtain globally optimal, or near globally optimal, solutions. This can be achieved through simulated annealing (SA) based guided random search via online learning from experience with the system and proactive offline optimization via simulators, accepting worse solution according to some criterions (e.g., Metropolis), etc.

Embodiments of this disclosure provide autonomous, closed-loop, adaptive, self-learning techniques that are robust across different network implementations. Embodiment approaches may utilize minimal modeling assumptions, and may be insensitive to lack of UE location information and/or inaccurate engineering parameters.

Control parameters for the cluster of cells may be adapted using an embodiment autonomous adaptive simulated annealing algorithm. Aspects of this disclosure provide autonomous adaptive simulated annealing algorithms. An embodiment algorithm is described by the following ten steps.

The first step comprises obtaining an initial solution (S) and an initial temperature (T0). In one embodiment, the starting temperature (T0) is selected based on an objective or cost function during an offline simulation. In another embodiment, the starting temperature (T0) is selected by increasing the starting temperature (T0) until an acceptance ratio exceeds a threshold, e.g., ninety percent, etc.

The second step comprises evaluating the cost of the initial solution using constraints (e.g., thresholds and weights for parameters (e.g., RSRP, SINR) used in objective function). This may include a normalization process that considers the cost per cell, the ratio of total cost to the total number of UEs, and the ratio of cost to number of UEs per cell. The second step may also consider the cost per cell or per area (e.g., all cells or partial group of cells such as neighbors), cost percentage (e.g., ratio of cost per cell to UE number per cell), and distribution (e.g., weighted by cell).

The third step comprises generating a new solution (Snew). The new solution may be generated using various adaptive (e.g., on-line) algorithm algorithms, including a uniform algorithm, a guided random search (e.g., Gaussian, Cauchy). The new solution may also be generated via an offline simulation combined with reinforcement learning. Generating the new solution may include selecting which cell(s) are to be adjusted. The cells may be chosen randomly, using a heuristic approach, e.g., sorted by cost to UE no per cell, first m, exponential probability), or a using a hybrid approach (e.g., part random and part heuristic). The number of cells that are optimized may fixed (e.g., X number of cells), or adaptive (e.g., based on the priority or severity of problematic cells). One or more parameters may be adjusted per iteration. Various change/action/perturbation mechanisms may be applied to adjust the parameters to be adjusted. For example, parameters may be adjusted in the positive or negative direction. The adjustments can use different step size adjustment parameters, e.g., small step, large step, absolute step size, relative step size, fixed step-size/range, adaptive step-size/range depending on the temperature at system/cell level or offline simulation, etc.

The fourth step includes evaluating the cost of the new solution. The fifth step includes determining whether to select the new solution as the current solution. This decision may consider various criteria, and may be probability-based and/or threshold based. For example, the decision may consider criteria related to the cost of the new solution, e.g., difference between the cost of new solution and optimal cost, cost per UE or per cell, etc.

The sixth step determines whether an equilibrium condition (# of iterations carried out before update T) has not been reached. If not, then the technique reverts back to step three. The seventh step comprises learning from experience gained during the first six steps, e.g., feedback from the system, mistake, reward, etc. This step may update models and/or parameters, such as control parameters (e.g., system/cell level temperate Tn), propagation models used by simulators, engineering parameters, parameters/models for identifying problematic cells, generating new solution and accepting new solution, etc.

The eighth step determines whether a backward/safeguard condition has been met. If so, the technique back-steps to a previous solution according to some criteria. This step may be helpful in avoiding locally optimal solutions. The ninth step determines whether a termination criterion has been reached according to some criteria. If not, then the technique reverts back to step three. The tenth step returns all solutions and relevant parameters, e.g., Sbest, Cbest, S, C, Sall and Call.

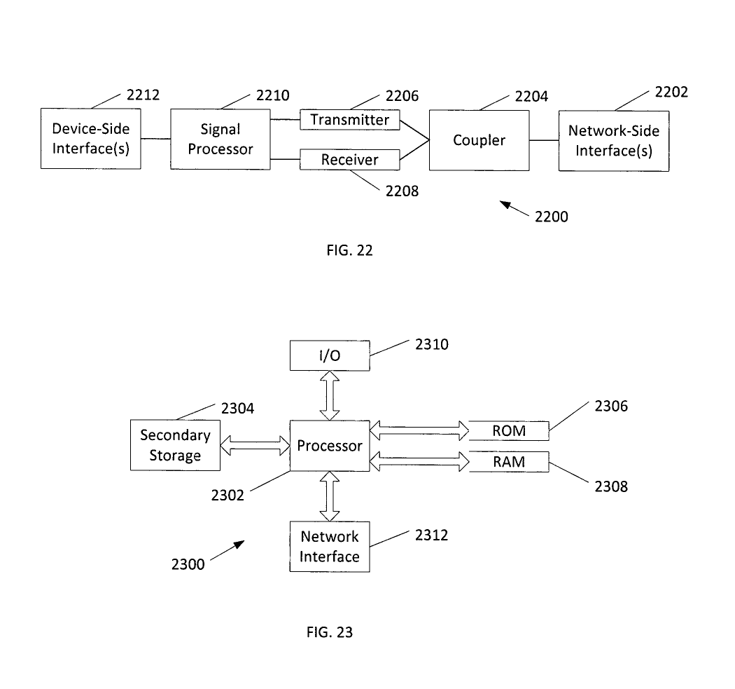

FIG. 24 illustrates an embodiment flowchart for adjusting communication parameters for a cluster of cells using an autonomous adaptive simulated annealing algorithm. As shown, the method 2400 begins by identifying all problematic cells. Next, the method 2400 generates subgroups of cells to be optimized. Thereafter, the method 2400 selects subgroups of cells to be optimized in parallel and/or subgroups of cells to be optimized sequentially. Subsequently, the method 2400 selects cells to be optimized in each subgroup. Next, the method 2400 generates a new solution. Thereafter, the method 2400 determines whether or not to select the new solution at the system level.

If the new solution is selected at the system level, then the method 2400 determines whether or not to select the new solution at the cell level. If the new solution is selected at the system level, then the method 2400 proceeds to learn from its experience. When learning from the solution, the method 2400 may record the solution, and update the models/parameters. After learning from the experience, the method 2400 determines whether to terminate the subgroup. If the subgroup is terminated, then the method 2400 re-selects cells to be optimized in the subgroup. If the subgroup is not terminated, then the method 2400 outputs the best solution, and then determines whether to terminate the SON session. If the new system is rejected at the system level or at the cell level, then the method 2400 reverts back.

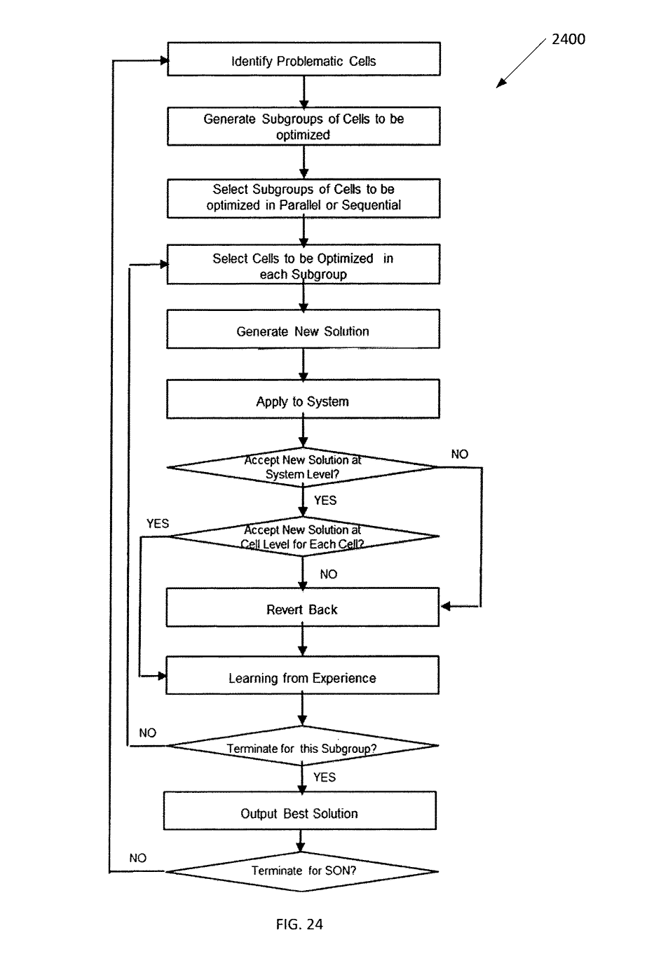

Aspects of this disclosure provide techniques for generating new solutions for selected cells during SA-based self learning. FIG. 25 illustrates an embodiment flowchart for generating new solutions for selected cells during SA-based self learning. As shown, the method 2500 begins by starting a new round of optimization for a selected cell. Various criteria may be used to determine when to start a new round of optimization. In some embodiments, groups of two or more cells may be optimized in parallel. In an embodiment, a new round of optimization may be started only after a certain number of cells in the group have finished the previous round of optimization. During the new round of optimization, a direction is selected for the cell. The possible directions may include randomly generated and/or predefined directions for RF parameters, e.g., electronic antenna tilt, power (up/0, down/0, 0/up, 0/down, 0/0), etc. The directions may be determined using adaptive online techniques, or via offline simulation. Various methods may be used to determine the direction, e.g., guided random, learning from experience (e.g., direction with maximum probability of positive gain), heuristic (e.g., expert system, whitebox), offline simulation (e.g., Netlab), predefined order of directions, adaptive (e.g., up-tilt if current eTilt<(max−min)/2), reinforcement learning, etc.

Thereafter, parameter(s) are adjusted based on a step size in the selected direction, after which a solution is generated. Next, the method 2500 determines whether to continue stepping in the current direction. If so, the parameters are adjusted once more in the selected direction, and a solution is generated. At some point, a determination is made to change the direction for the current cell, at which point parameters are adjusted in a different direction. Outputs are generated iteratively until a termination condition is reached, e.g., all directions have been considered, a threshold number of directions have been considered, etc. Thereafter, a new cell is selected, and directions for the new cell are evaluated to generate corresponding solutions. Cells in the selected subset are evaluated iteratively until another termination condition is reached, at which point a new solution is output. Termination conditions may occur after performance of a threshold number of iterations or rounds. Termination conditions may also include results-based criteria, e.g., negative gain, number of negative gains, number of rejections, etc.

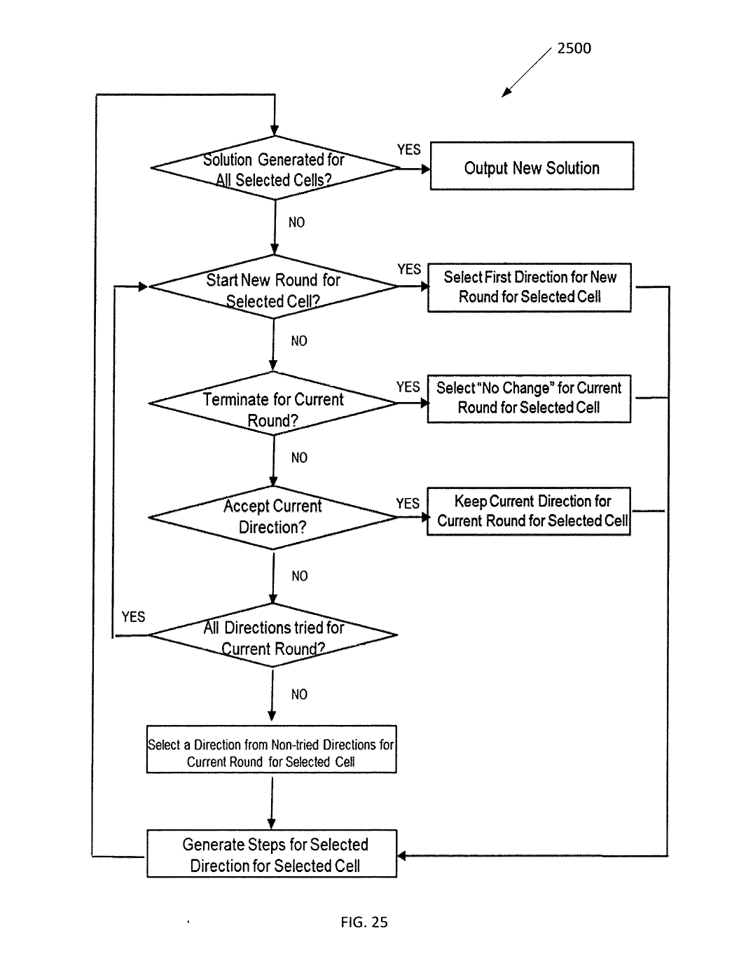

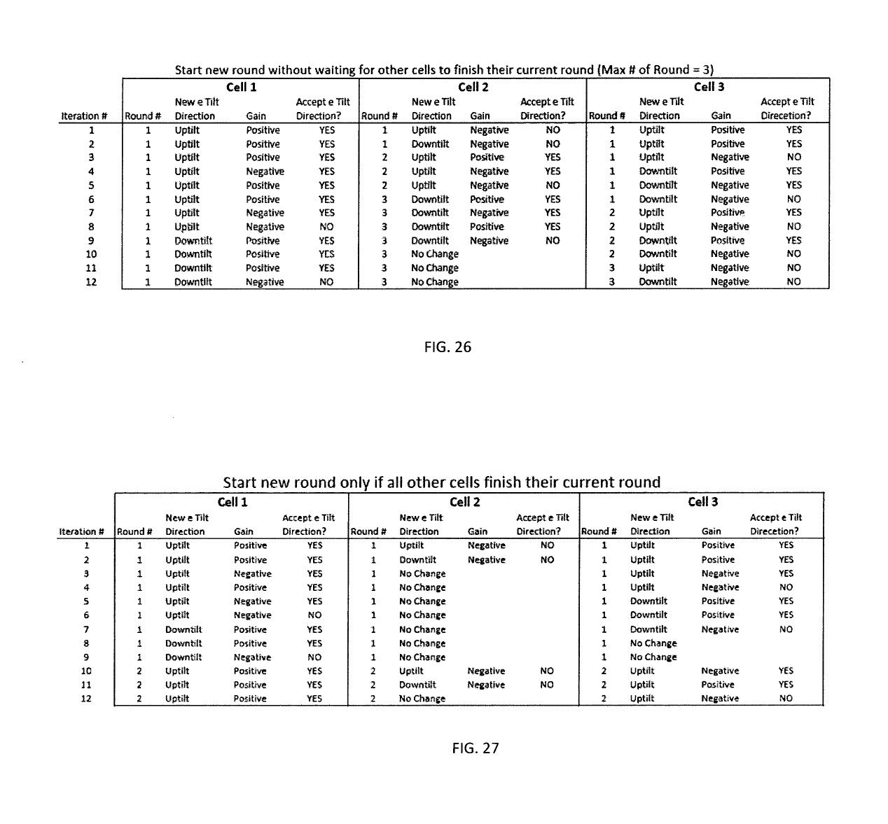

FIG. 26 illustrates a graph of the results of simulations of the method 2500 described in FIG. 25. These results were obtained by starting a new round of adjustment without waiting for all cells to be adjusted in the previous round. Three rounds of adjustment were performed. FIG. 27 illustrates a graph of the results of simulations of the method 2500 described in FIG. 25. These results were obtained by starting a new round of adjustment only after all cells had been adjusted in the previous round.

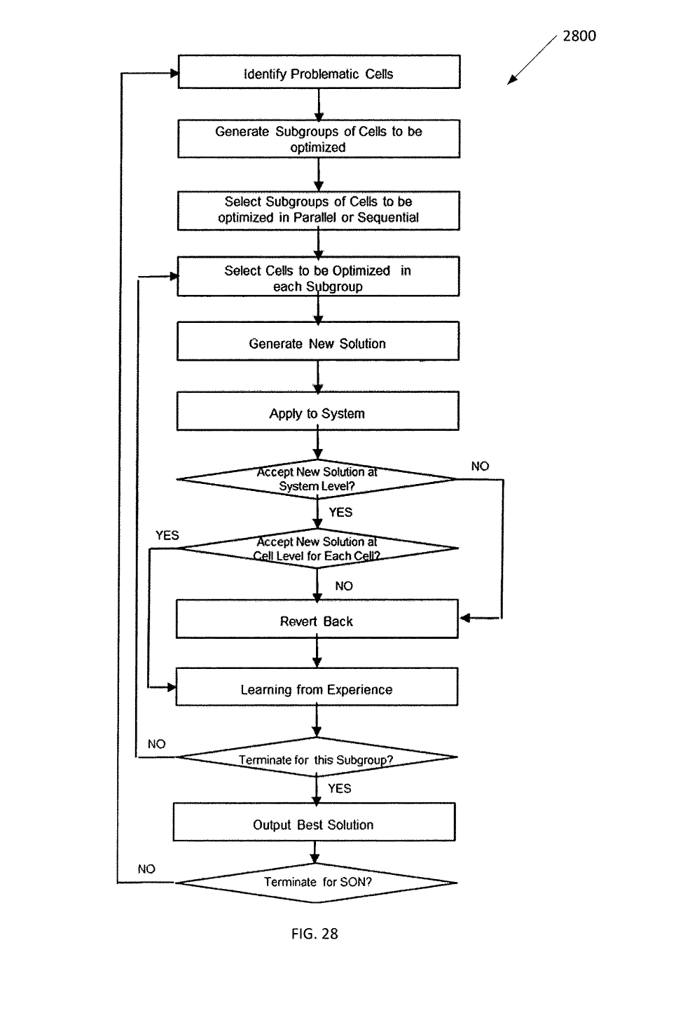

FIG. 28 illustrates an embodiment flowchart for adjusting communication parameters for a cluster of cells using an autonomous adaptive simulated annealing algorithm. As shown, the method 2800 begins by identifying all problematic cells. Next, the method 2800 generates subgroups of cells to be optimized. Thereafter, the method 2800 selects subgroups of cells to be optimized in parallel and/or subgroups of cells to be optimized sequentially. Subsequently, the method 2800 selects cells to be optimized in each subgroup. Next, the method 2800 generates a new solution. Thereafter, the method 2800 determines whether or not to select the new solution at the system level.

If the new solution is selected at the system level, then the method 2800 determines whether or not to select the new solution at the cell level. If the new solution is selected at the system level, then the method 2800 proceeds to learn from its experience. When learning from the solution, the method 2800 may record the solution, and update the models/parameters. After learning from the experience, the method 2800 determines whether to terminate the subgroup. If the subgroup is terminated, then the method 2800 re-selects cells to be optimized in the subgroup. If the subgroup is not terminated, then the method 2800 outputs the best solution, and then determines whether to terminate the SON session. If the new system is rejected at the system level or at the cell level, then the method 2800 reverts back.

Aspects of this disclosure provide techniques for dynamically adjusting cell-specific radio frequency (RF) configuration parameters (e.g., electrical antenna tilt, reference symbol (RS) pilot power, etc.) to optimize an objective function. In one embodiment, RF parameters of a single cell are adjusted to maximize a per-cell performance metric. In another embodiment, RF parameters for two or more cells are jointly adjusted to maximize a network performance metric, e.g., QoE in terms of coverage, capacity, etc.

In some embodiments, parameters are adjusted incrementally online. Parameters may be adjusted jointly for the different cells in a cluster, and the resultant feedback from UE measurement reports (MRs) may be observed continually in a closed loop for long term optimization. Real UE feedback (e.g., no propagation model estimate) in MRs to update the objective function, to identify cell state indicators, and to make step-wise parameter adjustments. In some embodiments, the objective function does not depend on UE location information.

As long as MRs (RSRP, RS-SINR or RSRQ) from representative UEs are available for a given parameter change, the objective function can be evaluated accurately. As such, the objective function may not require correct antenna tilt and power information. System objective functions and cell level metrics may be aggregations of UE state information (e.g., MRs, etc.) that don't require individual UE location for evaluation. Even if initial configuration parameters are inaccurate, they can be still adjusted in a meaningful direction using the fact that parameter changes lead to measurable changes in cell/system metrics.

Aspects of this disclosure provide adaptive simulated annealing (SA) techniques that combine online optimization of the real network via closed-loop SA-based guided random search and proactive offline optimization of relevant parameters and/or actions by efficiently exploring the solution space via simulated networks (e.g., Netlab, Unet) iteratively, in order to, learn from experiences, such as mistakes and rewards. This may allow actions to be selected based on the real-time feedback from the system. Embodiments may dynamically select and evolve the best possible actions for online optimization, which may allow the system to adapt to new unforeseen conditions or situations. Embodiments may also update the models and parameters used by SA and/or simulators based on online feedback from the system in real time, to provide fast convergence and to escape the trap of local optimization.

Aspects of this disclosure also provide embodiment SON optimization techniques that utilize an iterative learning approach to adjust wireless network configuration parameters. In particular, a controller iteratively generates and evaluates global solutions over a sequence of iterations. During this process, the controller uses experience obtained from evaluating global solutions during previous iterations when generating global solutions in subsequent iterations. This may be achieved by using the evaluation results to update parameters (e.g., topology model, traffic/usage patterns) of a heuristic/adaptive algorithm used to generate the global solutions. In this way, the controller learns more about the network (e.g., topology, conditions, traffic patterns, etc.) during each successive iteration, which ultimately allows the controller to more closely tailor global solutions to the network. As used herein, the term “global solution” refers to a set of local solutions for two or more wireless network coverage areas in a wireless network. Each “local solution” specifies one or more wireless configuration parameters for a particular wireless network coverage area. For example, in the context of CCO, a local solution may specify an antenna tilt of an access point in a wireless network coverage area and/or a transmit power level (e.g., uplink, downlink, or otherwise) for the wireless network coverage area. In some embodiments, the global solutions are evaluated during online implementation. In other embodiments, the global solutions are evaluated during offline simulation. In yet other embodiments, some global solutions are evaluated offline while others are evaluated online. For example, the best performing global solution obtained from a given number of iterative simulations may be implemented during an online test period. Global solutions may be generated in a manner that seeks to improve performance metrics of the worst performing cells. For example, wireless configuration parameters for a global solution may be selected in order improve performance metrics in wireless coverage areas associated with the highest costs.

Various techniques can be used to evaluate the global solutions. In some embodiments, each global solution is evaluated to determine whether it satisfies one or more global performance criteria, e.g., an overall cost, an average per-cell cost, etc. If the global solution does not satisfy the global performance criteria, then the controller may revert back to a previous global solution, e.g., a lowest cost global solution computed during an earlier iteration. If the global solution does satisfy the global performance criteria, then the controller may evaluate each local solution specified by the global solution to determine which local solutions satisfy corresponding local performance criteria. Different local performance criteria may be used to evaluate local solutions for different coverage areas. Local solutions that fail to satisfy their corresponding local performance criteria may be replaced with previous local solutions, e.g., a default local solution, a local solution defined by a global solution computed in a previous iteration, etc. In some embodiments, the global performance criteria is a relative benchmark established during a previous iteration (e.g., the lowest cost global solution computed prior to the current global solution), while the local performance criteria is an absolute benchmark, e.g., a minimum level of performance for a given cell.

In some embodiments, cost functions are used to evaluate global solution. The cost may be an overall cost for a set of coverage areas or an average per cell cost for a set of coverage areas. In the context of coverage and capacity optimization, a cost function for a global solution may include an RSRP parameter and an interference parameter, e.g., a SINR level, etc. In an embodiment, the RSRP component corresponds to a number of users reporting, or projected to report, an RSRP measurement below an RSRP threshold during a fixed period, and the interference component corresponds to a number of users reporting, or projected to report, an interference measurement above an interference threshold during the fixed period. In such an embodiment, the following cost function may be used: Cost=0.5*Num_UE(RSRP≦Thr_rsrp)+0.5*Num_UE(INT≧thrint), where Num_UE(RSRP≦Thr_rsrp) is the number of UEs reporting, or projected to report, RSRP levels below an RSRP threshold during a fixed period, and Num_UE(INT≧thr_int) is the number of UEs reporting, or projected to report, interference levels below an interference threshold during the fixed period. In such an example, the interference levels may correspond to SINR levels obtained by measuring reference signals.

In some embodiments, some or all of the functions or processes of the one or more of the devices are implemented or supported by a computer program that is formed from computer readable program code and that is embodied in a computer readable medium. The phrase “code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. Upon execution, the computer program may detect core traces, convert the core traces into a hierarchical format, generate the gene function database, and determine preemption costs associated with the gene functions.

Adjusting Cell Configuration Parameters Based on Measurement Reports

Aspects of the present disclosure provide methods and apparatus for adjusting configuration parameters of a plurality of cells in a wireless network based on measurement reports (MRs) received during a data collection period of the wireless network, so that coverage and capacity of the wireless network may be improved. A configuration parameter of a cell may be an antenna tilt or a transmit power.

In some embodiments, labels are assigned to the plurality of cells based on the MRs and configuration parameters of the plurality of cells are adjusted according to the labels. In one embodiment, each of the plurality of cells are assigned two or more labels based on one or more MRs collected in the wireless network. The two or more status labels are associated with different cell status categories. In one embodiment, a cell status may be categorized as a coverage status, a quality status, an overshooter status, or an interference status. Each of the cell status categories may be further classified into different cell status types. For example, a quality status is classified into types of {good, bad}, or an interference status is classified into types of {strong, medium, weak}. A cell may be mapped to one of the cell status types corresponding to a cell status category based on MRs and is labeled by that type and category. A combination of the labels assigned to each of the cells in the wireless network reflects the current status of each corresponding cell with respect to different cell status categories, and is used to determine adjustment of one or more configuration parameters of each corresponding cell, for improving cell performance. In one embodiment, domain expertise, knowledge and experience are used to determine what actions to take to adjust the cells' configuration parameters based on the combinations of labels.

In some embodiments, blames are assigned to the plurality of cells based on the MRs, and configuration parameters of the plurality of cells are adjusted according to the blames. Blames are associated with MRs that do not satisfy a pre-defined set of performance criteria, which are referred to as bad or unsatisfactory MRs, and indicate responsibilities that one or more cells should take for the bad MRs. In one embodiment, bad MRs are identified from the collected MRs, and each bad MR is associated with one unit of blame. For each bad MR identified in the wireless network, fractional units of blame are assigned to responsible cells. If one cell is fully responsible for a bad MR, the cell is assigned a unit of blame. Thus the joint impacts of cell performance issues, such as problems related to coverage, quality or interference, resulted from cell's configuration is captured into the blames assigned to the cell corresponding to bad MRs in the wireless network. Blames assigned to each of the plurality of cells are used to determine adjustment of one or more configuration parameters of each corresponding cell, in order to improve status of each corresponding cell. In one embodiment, domain expertise, knowledge and experience are used to determine what actions to take to adjust the cells' configuration parameters based on the blames assigned to the cells.

In some embodiments, blames are classified into different blame categories for determining configuration parameter adjustment of the cells. The different blame categories indicate different manners to adjust one or more configuration parameters of the cells in order to reduce the values of blames. In one embodiment, a blame is classified into an up-blame or a down-blame, indicating an increase or a decrease of a configuration parameter is needed in order to reduce the blame value. In one embodiment, blames assigned to each of the cells are classified into an up-blame or a down-blame, and a sub-total up-blame value and a sub-total down-blame value are calculated by summing all up-blames and all down-blames, respectively, assigned to each corresponding cell. In one embodiment, the sub-total up-blame value and the sub-total down-blame value of a cell are used to calculate an up-action probability and a down-action probability of the cell. A configuration parameter of the cell may be increased when the up-action probability is greater than a first threshold, and may be decreased when the down-action probability is greater than a second threshold.

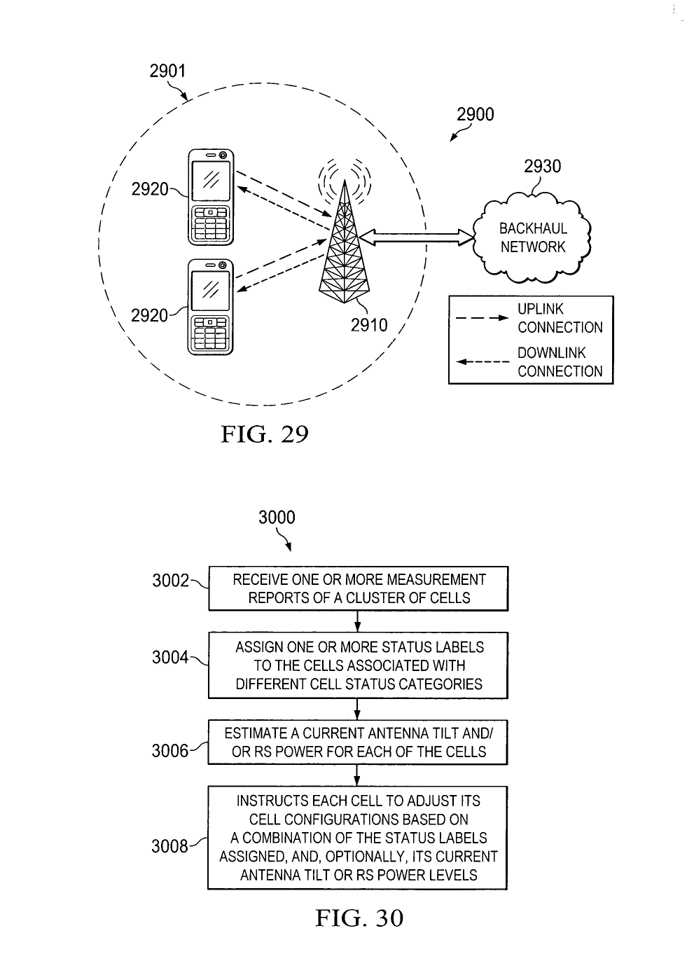

FIG. 29 illustrates a network 2900 for communicating data. The network 2900 comprises a base station 2910 having a coverage area (or a cell) 2901, a plurality of mobile devices 2920, and a backhaul network 2930. As shown, the base station 2910 establishes uplink (dashed line) and/or downlink (dotted line) wireless connections with the mobile devices 2920, which serve to carry data from the mobile devices 2920 to the base station 2910 and vice-versa. Data carried over the uplink/downlink connections may include data communicated between the mobile devices 2920, as well as data communicated to/from a remote-end (not shown) by way of the backhaul network 2930. As used herein, the term “base station” refers to any component (or collection of components) configured to provide wireless access to a network, such as an enhanced base station (eNB), a macro-cell, a femtocell, a Wi-Fi access point (AP), or other wirelessly enabled devices. Base stations may provide wireless access in accordance with one or more wireless communication protocols, e.g., long term evolution (LTE), LTE advanced (LTE-A), High Speed Packet Access (HSPA), Wi-Fi 802.11a/b/g/n/ac, etc. As used herein, the term “mobile device” refers to any component (or collection of components) capable of establishing a wireless connection with a base station, such as a user equipment (UE), a mobile station (STA), and other wirelessly enabled devices. In some embodiments, the network 2900 may comprise various other wireless devices, such as relays, low power nodes, etc.

A wireless communications network may include a cluster of cells associated with base stations, as illustrated in FIG. 29, serving mobile devices. Such a wireless communications network may implement Self-Organizing-Network (SON) strategies to achieve coverage capacity optimization (CCO) through configuration and adjustment of radio frequency (RF) configuration parameters of the cells in the wireless communications network. An example of a RF configuration parameter of a cell includes an antenna tilt, or a power parameter, such as a reference signal power.

Conventional SON methods for CCO, such as the automatic cell planner (ACP), typically require costly drive tests and human verification to configure RF configuration parameters of a cell. For example, drive test (MT) or minimization of drive test (MDT) data, along with user equipment (UE) geo-location (AGPS) and accurate antenna configuration parameters are required to achieve an accurate propagation modeling based on which cell configuration parameters are adjusted. Additionally, these methods also require significant manual effort to be applied for configuring different types of cells, which results in high expenditure and complicated configuration process.

Aspects of the present disclosure provide methods and apparatus to generally optimize a cluster of cells in terms of coverage and capacity, by utilizing measurement reports (MRs) obtained from UEs served by the cells and experts' domain knowledge to determine configuration parameter adjustment of the cells. Embodiments of the present disclosure do not reply on UE AGPS and do not require accurate antenna configuration parameters of the cells.

A measurement report generally includes measurement results that a UE measures and provides for delivery to its serving cell regarding various measurement items the serving cell requests. For example, a measurement report includes measurement results about signal strength or quality of the serving cell. Typically, a measurement report includes a reference signal received power (RSRP) and a reference signal receive quality (RSRQ). A RSRP generally provides information about strength of a received reference signal, and a RSRQ indicates quality of a received reference signal. Measurement and calculation of a RSRQ may be based on a RSRP and a received signal strength indicator (RSSI). A RSSI includes information about a reference signal power from a serving cell of a UE as well as co-channel interference and noise, and can help in determining interference and noise information. As used herein, MRs sent by UEs served by a cell is referred to as MRs of the cell. Embodiments of this disclosure use RSRP and RSRQ reported to indicate reference signal strength and reference signal quality of a cell, respectively. However, the use of RSRP and RSRQ are merely for illustrative purpose, and any other measures for reference signal strength and reference signal quality of a cell may also be used. For example, a signal to interference and noise ratio (SINR) may be used to indicate reference signal quality of a cell. One of ordinary skill in the art would recognize many variations and alternatives of measures for reference signal strength and reference signal quality of a cell. These variations and alternatives are all within the scope of this disclosure without departing from the spirit of this disclosure.

A cell may be characterized by its cell status in different categories. For examples, a cell status may be a coverage status, a quality status, an interference status, or an overshooter status, etc. In some embodiments, cell statuses may be estimated or indicated based on information included in MRs. For example, a RSRP, or any other measure for reference signal strength, may be used to indicate coverage status of a cell at its edge, and a RSRQ, or an SINR, or any other measure for reference signal quality, may be used to indicate quality status within a cell coverage area. In some embodiments, a cell status in a category may be further classified into different status types. Status types corresponding to a cell status category may be, as an example, represented by {type 1, type 2 . . . type n}. For example, a coverage status is classified into types of {good, weak, weak edge only, weak interior/insufficient only, weak edge and interior/insufficient}. In some embodiments, a cell's coverage status is “good” when an average RSRP included in MRs of the cell is greater than a first threshold, and the cell's coverage status is “weak” when the average RSRP is less than a second threshold. A coverage status type of “weak interior only” may indicate that signal strength within a cell is less than a threshold, and “insufficient only” may indicate there is a gap between two cells and UEs in the gap are not sufficiently covered. A coverage status type of “weak edge and interior” may indicate signal strength within and at the edge of the cell is less than a threshold. In an example, a quality status may include types of {good quality, bad quality}.

In another example, an overshooter status is classified into two types: {yes (i.e., with overshooter), no (i.e., without overshooter)}. In another example, an interference status may be categorized into types of {interferer zero, interferer one, interferer more}, or {none, single, multiple} depending on the number of interferee cells (e.g., victim cells of an interference) affected. Alternatively, an interference status of a cell, which is identified as an interferer, may have interference status types of {strong interferer, medium interferer, weak interferer} based on the number of UEs/MRs which are affected by the interferer and/or the number of interferee cells. One of ordinary skill in the art would recognize many variations and alternatives for classifying cell status categories and for classifying a cell status into different types corresponding to a category. The terms of “label” and “status label” are used interchangeably throughout this disclosure.

A cell may be mapped to one of the status types corresponding to a cell status category utilizing information in MRs, and is labeled by that type and category. For example, a cell may be assigned a label of “weak” corresponding to its coverage status, and/or be assigned a label of “yes” corresponding to its overshooter status based on RSRP information included in MRs obtained. In one embodiment, a label assigned to a cell may be referred to as a problematic label for it indicates a performance, e.g., cell capacity or coverage, problem of the cell. For example, a label of “bad” quality status indicates there may be a quality issue in the cell, and a label of “strong” interference status indicates that a cell may cause interference problems to other cells. Thus labels assigned to cells provide information indicating problems of cells and also guides to adjust the cells' configurations. In some embodiments, labels assigned to a cell are used to determine whether and how the cell's configuration parameters are adjusted, in expectation of improving one or more labels of the cell, and consequently improving the cell performance and MRs received in future.

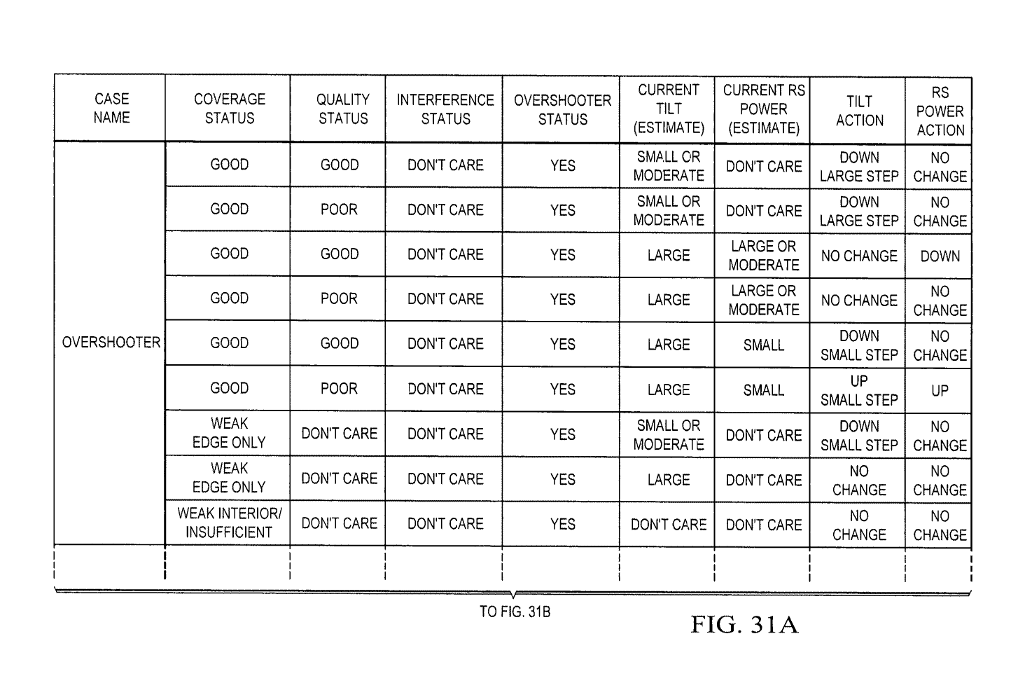

FIG. 30 illustrates a flowchart of an embodiment method 3000 for improving coverage and capacity of a cluster of cells in a wireless network. The method 3000 may be performed by a network component, such as a communications controller or an evolved node B (eNodeB). The method 3000 starts at step 3002, where the network component receives one or more MRs. The MRs may be sent by one or more UEs served in the wireless network by one or more of the cluster of cells. The UEs may send the MRs periodically (e.g., whenever pilots are received), when and as configured for pilot measurement reporting, or whenever requested. In one embodiment, the network component also collects MDT and/or DT data in the wireless network.

At step 3004, each of the cluster of cells is assigned one or more status labels associated with different cell status categories based on the MRs, and optionally, the MDT/DT data. For example, each cell is assigned two labels corresponding to the coverage status and interference status. In another example, each cell is assigned four labels corresponding to the coverage status, the quality status, the interference status, and the overshooter status. What cell status category will be used to label the cells may depend on many factors, such as user experience, system load, number of user equipments, or impacting problems to be solved in the network. Since each cell status category may include different types, there may be various combination of labels assigned to a cell corresponding to the cell status categories used. For example, a cell may be labeled as “good” coverage, “bad” quality, and “no” overshooter. Alternatively, the cell may be labeled as “weak” coverage, “good” quality and “no” overshooter.

At step 3006, the network component estimates the current antenna tilt and/or RS power for each cell in the wireless network. In one embodiment, the current antenna tilt or RS power of a cell may be represented by: (original antenna tilt/RS power+change value). The original antenna tilt/RS power represents the antenna tilt value/RS power value of the cell at a point of time when the cell's configuration is set as original, and the change value represents increase or decrease of the cell's tilt or RS power with respect to its original value. In one example, the original values of each cell's antenna tilt and RS power and their change values over the time may be stored in a database. Thus a current value of a cell's antenna tilt or RS power may be obtained by adding the original value and a previous change value. In one embodiment, the estimation of the current antenna tilt or RS power for a cell may indicate a level of a value compared with the cell's original antenna tilt or RS power. For example, a cell's current antenna tilt may be estimated as “small”, which indicates that the current antenna tilt is small compared with the original antenna tilt. In another example, a cell's current RS power may be estimated as “large” indicating the current RS power is large compared with the original RS power. In one embodiment, the level of a tilt/RS power value may be classified as “large”, “moderate”, “small”, and “zero” which indicates there is no change. A person of ordinary skill in the art would recognize many variations for classifying the levels. In one embodiment, a cell's estimated antenna tilt and RS power may be represented by a vector: [antenna tilt level, RS power level]. For example, a cell's estimated antenna tilt and RS power may be [small, 0], [large, moderate], etc. The antenna tilt and RS power may also be taken into consideration when determining cell configuration parameter adjustment. For example, when a cell is assigned a label of “bad” quality and increase of transmit power of the cell is desired. However, if the current RS power is already “large”, the transmit power of the cell may not be adjusted.

At step 3008, the network component instructs the cluster of cells to adjust their cell configuration parameters, such as their antenna tilts, transmit power, or both, based on status labels assigned to the cell. In one embodiment, a combination of labels assigned to each cell may be used to determine cell configuration parameter adjustment. For example, if a cell is labeled as “good” coverage, and “bad” quality, the transmit power of the cell may be increased. In another example, if a cell is labeled as “good” coverage and “strong” interference, the antenna tilt and/or transmit power of the cell may be decreased. In another embodiment, a combination of labels assigned to each cell and the current antenna tilt and/or RS power level of each corresponding cell are used to determine cell configuration adjustment. In the example where the cell is labeled as “good” coverage and “strong” interference, if the current antenna tilt level of the cell is “small”, then the antennal tilt of the cell may be decreased by a small amount, which is a pre-defined level of antenna tilt amount. Alternatively, the antennal tilt of the cell may not be adjusted, and the transmit power of the cell may be decreased according to its current RS power level. In one embodiment, the network component may map a combination of the status labels assigned to a cell and the current antenna tilt and/or RS power levels of the cell to an action and assign the action to the cell. An action represents a change of one or more of a cell's configuration parameter, such as increase or decrease of the antenna tilt and/or RS power of the cell. An action may be assigned based on domain knowledge, experience or expertise in consideration of status labels assigned to a cell, current configuration of the cell, and other factors that may affect its cell status. Steps of 3002-208 of the method 3000 may be performed iteratively, with each cell's configuration parameter(s) adjusted in multiple “small steps”, for improving labels assigned to the cells.

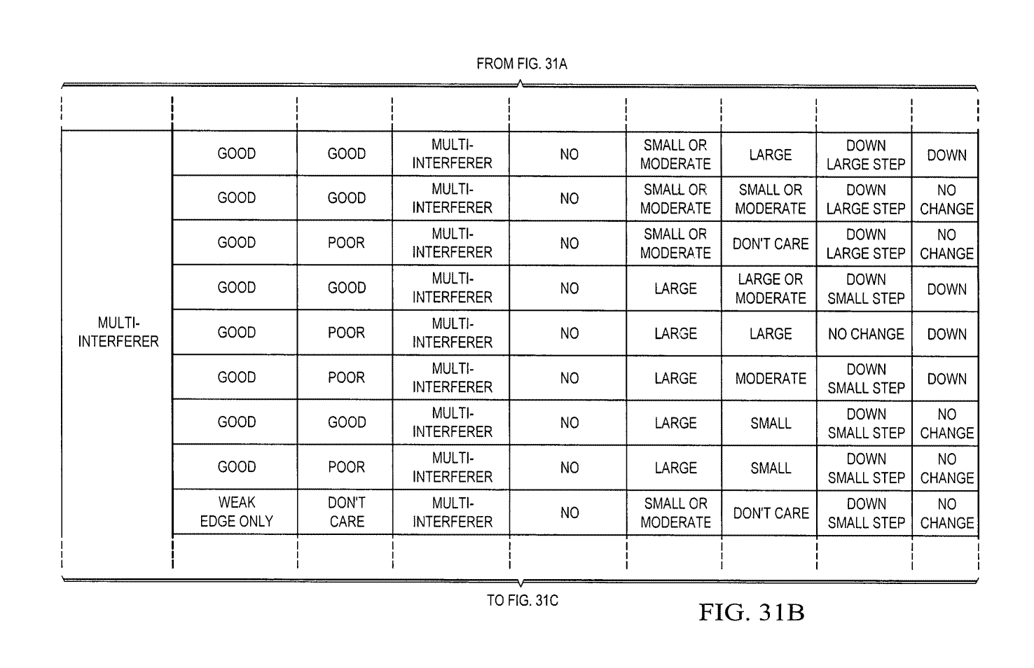

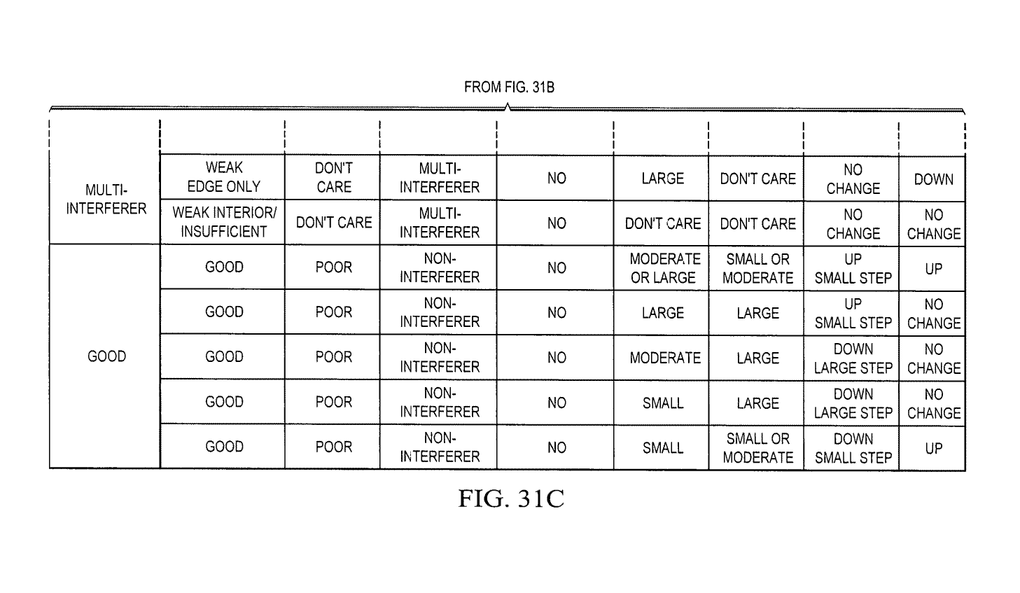

In some embodiments, tables are used to indicate status labels and actions assigned to cells. FIGS. 31A-31C and FIGS. 32A-32C illustrate examples of tables for mapping status labels to actions for cells in a wireless network. Tables in FIGS. 31A-31C and FIGS. 32A-32C show status labels assigned to the cells, current antenna tilt and current RS power levels of the cells, and actions assigned to the cells for adjusting antenna tilt, RS power, or both. Actions for a cell are determined based on a combination of labels assigned to the cell and the cell's current antenna tilt and RS power levels. Each row represents labels and actions assigned to a cell. As shown, the cells are listed according to a particular problem, shown in the first column of “Case Name”, observed based on MRs. That is, the “Case Name” column indicates a problematic label assigned to the cells corresponding to a cell status category. For example, the “Case Name” column of overshooter indicates these cells have an overshooter problem and their labels corresponding to the overshooter status are “Yes”. In another example, the “Case Name” column of multi-interferer indicates that these cells have been identified as interferers of multiple interferees and have been assigned a label “multi-interferer” according to the interference status. The second to the fifth columns show labels assigned to each of the cells corresponding to the cover status, quality status, interference status and overshooter status, and the sixth and seventh columns are current antenna tilt and RS power levels estimated of the cells. Each of the cells is assigned an action to adjust its antenna tilt and/or RS power, as shown in the eighth and ninth columns.

The embodiment methods illustrated in FIGS. 30-32 map UE level MR data to various disparate cell level labels, and further to actions for adjusting cell configuration parameters, resulting in non-linear mappings, since actions are determined based on various combinations of labels. The methods may also be error prone, because labels could be incorrectly assigned due to mapping quantization errors, e.g., a “weak” coverage cell may be assigned a “weak edge only” label. Actions determined based on the labels may also be wrong due to, e.g., poor mapping decisions and/or overall quantization errors. Further, a so called “tricky or ambiguous” combination of labels may be assigned to a cell, which makes it hard to determine an action. For example, when a cell is assigned labels of “multi-interferer” and “poor quality”, it is hard to determine whether the cell's antenna tilt or RS power should be increased or decreased, and consequently hard to map an action to the combination of labels. Moreover, the methods may not quantitatively inform about how many UEs in the system are affected due to a cell's “multi-interferer” status, as well as how many “poor quality” statuses can be weighed against each other for choosing a specific action. Additionally, the methods do not provide ability to weigh a cell's “own” quality/coverage label against interference/overshoot labels of “other cells”, and to estimate impact on stability of a wireless communications network when multiple cells interact with each other due to actions taken which are determined based on labels.

In some embodiments, a concept of “blame” is provided to indicate a responsibility a cell may take for each MR that does not satisfy a performance criterion of a wireless communications network. Such a MR may be referred to as a “bad” or “unsatisfactory” MR. In some embodiments, the system may pre-define a set of performance criteria. If a MR does not satisfy one of the set of criteria, the MR is marked as a bad or unsatisfactory MR; otherwise, it is a good MR. For example, the set of performance criteria includes a coverage criterion, e.g., having a RSRP, or any other measure for reference signal strength, greater than a first threshold, and a quality criterion, e.g., having a RSRQ, or any other measure for reference signal quality, greater than a second threshold.

When a RSRP included in a MR is not greater than the first threshold, the MR does not satisfy the coverage criterion and is bad, or when a RSRQ in the MR is not greater than the second threshold, the MR is bad. A person of ordinary skill in the art would recognize many variations and alternatives for defining the performance criteria by which MRs may be identified as good or bad. For each bad MR, there should be one or more cells responsible for such an MR and thus taking the blame for it, and a blame is assigned to a cell if the cell takes at least a partial responsibility for a bad MR. Each assigned blame may be associated with a blame value. In one embodiment, each bad MR is associated with one unit of blame. If one cell is fully responsible for the bad MR, this one cell takes one unit of blame. If multiple cells are responsible for the bad MR, these multiple cells share the one unit of blame. The cells may include a serving cell of the UE reporting the bad MR, a non-co-site neighbor cell of the serving cell, or other cells in the system.

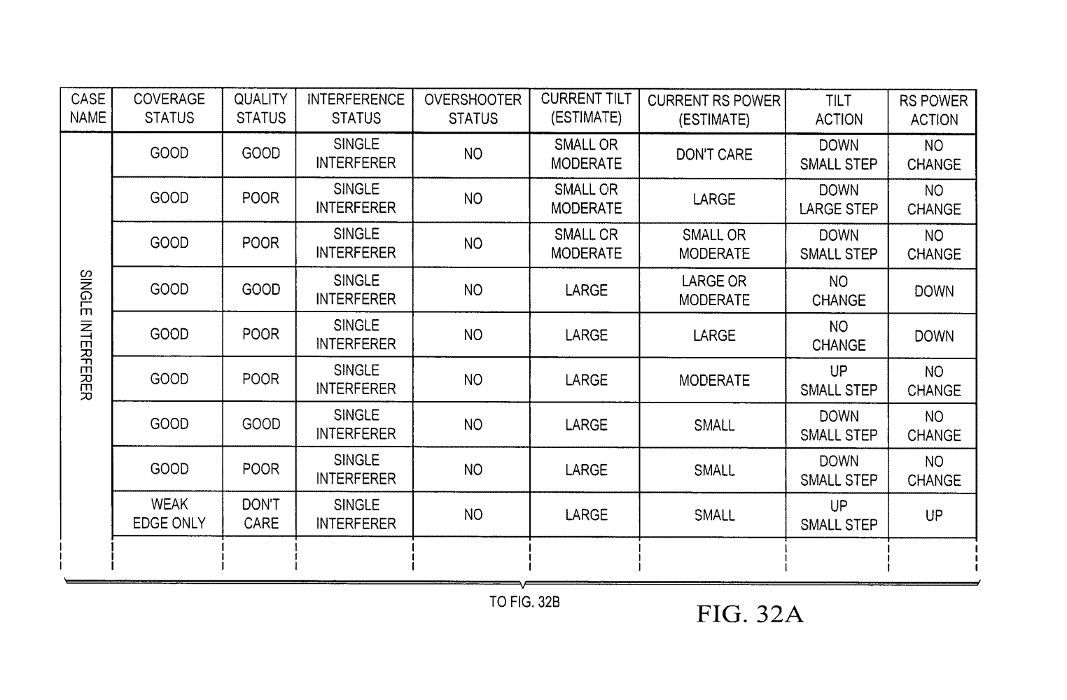

FIG. 33 illustrates a diagram of an embodiment wireless communications network 3300 where blames are assigned to cells. As shown, the network 3300 includes cells 3310, 3320 and 3330 serving UEs in their respective coverage areas. Mobile devices 3312, 3314 and 3316 are within the coverage area of the cell 3310 and transmit MRs to the cell 3310. In this example, each of the mobile devices 3312 and 3314 reports a bad MR 3322 and a bad MR 3324, respectively, and the mobile device 3316 reports a good MR 3326. Each bad MR is associated with a unit of blame. By analysis of the MRs 3322-3326, the cell 3310 is fully responsible for the bad MR 3322, and one unit of blame (e.g., a blame value of “1”) is assigned to the cell 3310. The cells 3320 and 3330 are not assigned any blame for the bad MR 3322 since they do not take any responsibility for it.

In one embodiment, the cells 3320 and 3330 may also be assigned blames for the bad MR 3322, with each having a blame value of “0”. Cells 3310, 3320 and 3330 are responsible for the bad MR 3324 reported by the mobile device 3314, and share the responsibility equally, so each of the cells 3310, 3320 and 3330 are assigned ⅓ unit of blame. In another word, each of the cells 3310, 3320 and 3330 is assigned a blame with a value of “⅓”. This may be the case when cells 3320 and 3330 cause interference on the mobile device 3314, while the cell 3310 has a low transmit power. The mobile device 3316's good MR 3326 is good and thus does not impose blames on any of the cells. In this example, the total blame value assigned to all the cells in the wireless communications system equals the number of bad MRs received, that is, (1+⅓+⅓+⅓)=2 (i.e., two bad MRs 3322 and 3324).

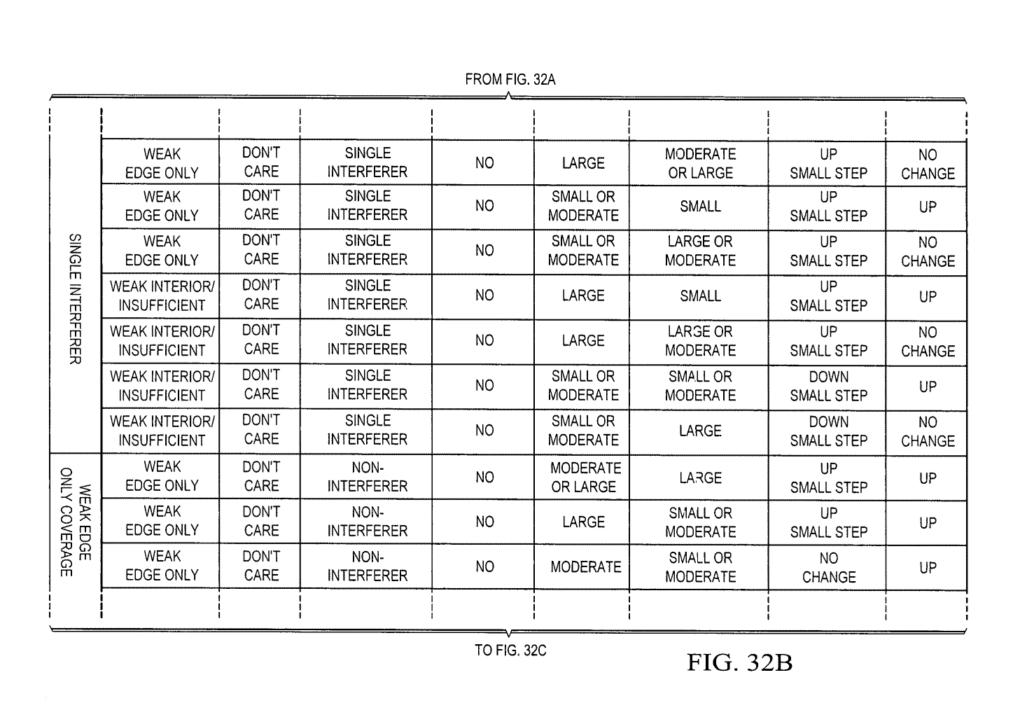

By using the concept of blame, responsibilities of a cell for causing bad MRs in the wireless communications network are captured and identified, based on which corresponding adjustment to the cell's configuration parameters may be determined in order to reduce the blame values of the cell and consequently the number of bad MRs, thus the entire network performance is improved. FIG. 34 illustrates a flowchart of an embodiment method 3400 for adjusting cell configuration parameters in a wireless network based on blames. The method 3400 may be performed by a network component in the wireless network, such as a communications controller, or an eNodeB. At step 3402, the method 3400 identifies bad MRs, i.e., MRs failing to satisfy one of a set of performance criteria, from a plurality of MRs received in the wireless network, e.g., during a data collection time period. The plurality of MRs are measured and reported by UEs served by multiple cells in the wireless network, and may be transmitted by the UEs periodically or upon request. Each of the bad MR is associated with one unit of blame.

At step 3404, for each of the identified bad MRs, the method 3400 assigns fractional units of blame to responsible cells. Thus for each of the bad MRs, a cell is assigned a blame associated with a blame value. The blame value may be “1” when the cell is fully responsible for the corresponding bad MR, may be “0” when the cell is not responsible for the corresponding bad MR, and may be between 0 and 1 when the cell is partially responsible for the corresponding bad MR. A blame corresponding to a bad MR may be assigned to a cell based on information included in the bad MR, such as a RSRP list, RSRQ and timing advance, topology information of the cell, and other information collected, such as MDT data. At step 3406, the method 3400 instructs one or more of the cells to adjust one or more of their configuration parameters based on their assigned blame values. Example configuration parameters include an antenna tilt, and a power parameter, such as a transmit power, etc. In one embodiment, blames assigned to a cell may be used to label the cell corresponding to different cell status categories, such as a coverage status or a quality status, taking into consideration of information, e.g., included in MRs received in the cell. The cell's configuration parameter may then be adjusted based on labels assigned to the cell, as illustrated in FIG. 30.

In some embodiments, a blame assigned to a cell according to a bad MR may be classified into different blame categories. The blame categories are associated with different manners for adjusting one or more cell configuration parameters in expectation of reducing the value of the blame and thus the number of bad MRs. In some embodiment, a blame may be classified into an up-blame or a down-blame. An up-blame or a down-blame indicates increase or decrease of one or more cell configuration parameters is desired for reducing the value of the up-blame. So the up-blame and down-blame corresponds to an increase-action (or up-action) and a decrease-action (or down-action), respectively, for adjusting one or more cell configuration parameters. In one example, a blame assigned to a cell is classified as an up-blame if increasing the antenna tilt, transmit power, or both of the cell is expected to reduce the associated blame value, and the blame is classified as a down-blame if decreasing the antenna tilt, transmit power, or both of the cell is expected to reduce the cell's blame values. For example, a cell may be assigned a down-blame with a value “⅕” or an up-blame with a value “1”. In another example, a blame may be classified into three categories, where the first category indicates increase of both antenna tilt and transmit power are desired, the second category indicates decrease of both antenna tilt and transmit power are desired, and the third category indicates increase/decrease of an antenna tilt and decrease/increase of a transmit power. A person of ordinary skill in the art would recognize many variations and alternatives for defining the blame categories and adjusting a cell's configuration parameters.

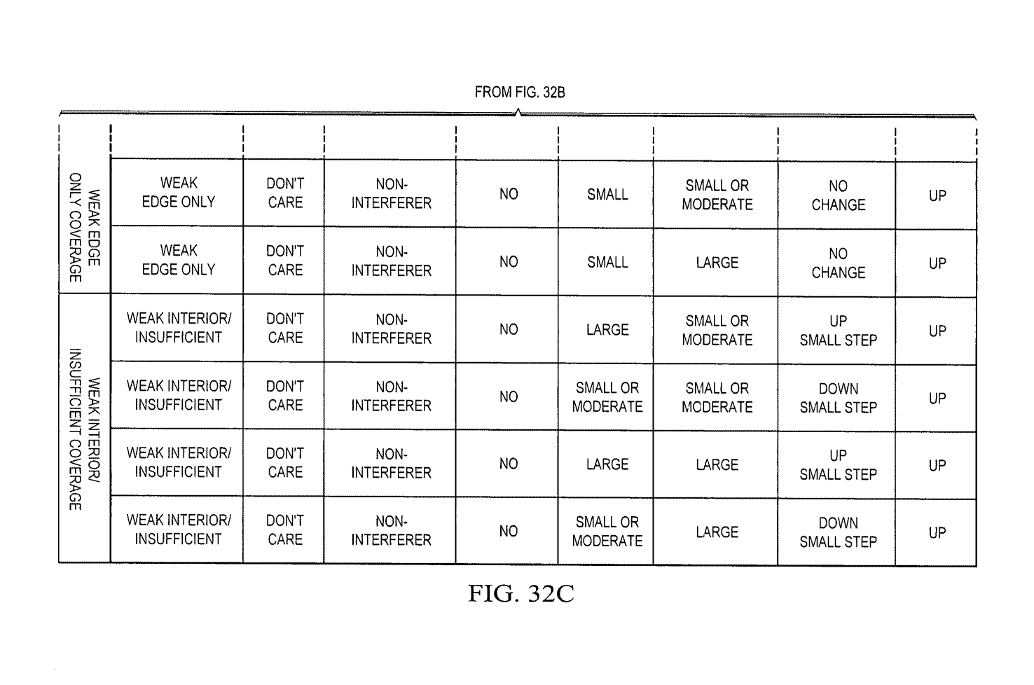

Classifying blames assigned to cells into different categories is helpful in determining how configuration parameters of the cells may be adjusted based on blames. FIG. 35 illustrates a flowchart of an embodiment method 3500 for adjusting cell configuration parameters in a wireless network having multiple cells based on blames. At step 3502, the method 3500 assigns blames to responsible cells for each bad MR identified in the wireless network. Each bad MR is associated with one unit of blame, and responsible cells are assigned fractional units of blame for each bad MR. At step 3504, each of the assigned blames is classified into a blame category of multiple blame categories. For example, a blame is classified into either an up-blame or a down-blamed, as described above. Steps 3502 and 3504 are repeated for all bad MRs received during a data collection period of the wireless network. Thus responsibilities, i.e., blames for all bad MRs are assigned.

At step 3506, the method 3500 calculates, for each cell, a sub-total blame corresponding to each of the blame categories. In some embodiments, the method 3500 sums the fractional units of blame that are assigned to each cell and that fall into a corresponding blame category, by which a sub-total blame value of the corresponding blame category is obtained. Taking the up-blame and down-blame categories as an example, a sub-total up-blame value for a cell is calculated by summing all up-blame values assigned to the cell, and a sub-total down-blame value for the cell is also calculated by summing all down-blame values assigned to the cell. Thus for each of the cells, two sub-total blame values are calculated, which include a sub-total down-blame value and a sub-total up-blame value.

At step 3508, the method instructs one or more of the cells to adjust their configuration parameters based on the sub-total blame values in different blame categories. In some embodiments, action probabilities may be calculated and used to determine how a cell's configuration parameters are adjusted. For example, when a sub-total down-blame value and a sub-total up-blame value are obtained for each of the cells, an up-action probability P_{up-action} and a down-action probability P_{down-action} may be calculated for each cell as follows:

P_{up-action}=(sub-total up-blame value)/(total blame value)

P_{down-action}=1−P_{up-action}

where the total blame value equals (sub-total down-blame value+sub-total up-blame value), the up-action probability indicates a probability of a need for a cell to increase one or more of its configuration parameters for reducing its blames (responsibilities) for bad MRs, and the down-action probability indicates a probability of a need for the cell to decrease its configuration parameters in order to reduce its responsibilities for bad MRs. In one embodiment, the up-action probability and the down-action probability are compared with a pre-defined up-action threshold TPᵤₚ and a pre-defined down-action threshold TP_{down}, respectively, to determine actions to be taken to adjust a cell's configuration parameters. For example, if the up-action probability of a cell is greater than the TPᵤₚ, a configuration parameter of the cell, such as the antenna tilt or transmit power of the cell, may be increased. If the down-action probability of a cell is greater than the TP_{down}, a configuration parameter of the cell, may be decreased. Generally, the pre-defined up-action threshold TPᵤₚ and the pre-defined down-action threshold TP_{down} should be greater than or equal to 0.5. As such a cell is only eligible for adjusting its configuration parameters by either increasing or decreasing the configuration parameters. If neither of the up-action probability and the down-action probability of a cell is greater than the corresponding threshold TPᵤₚ or TP_{down}, then no action will be taken to adjust the cell's configuration parameters.

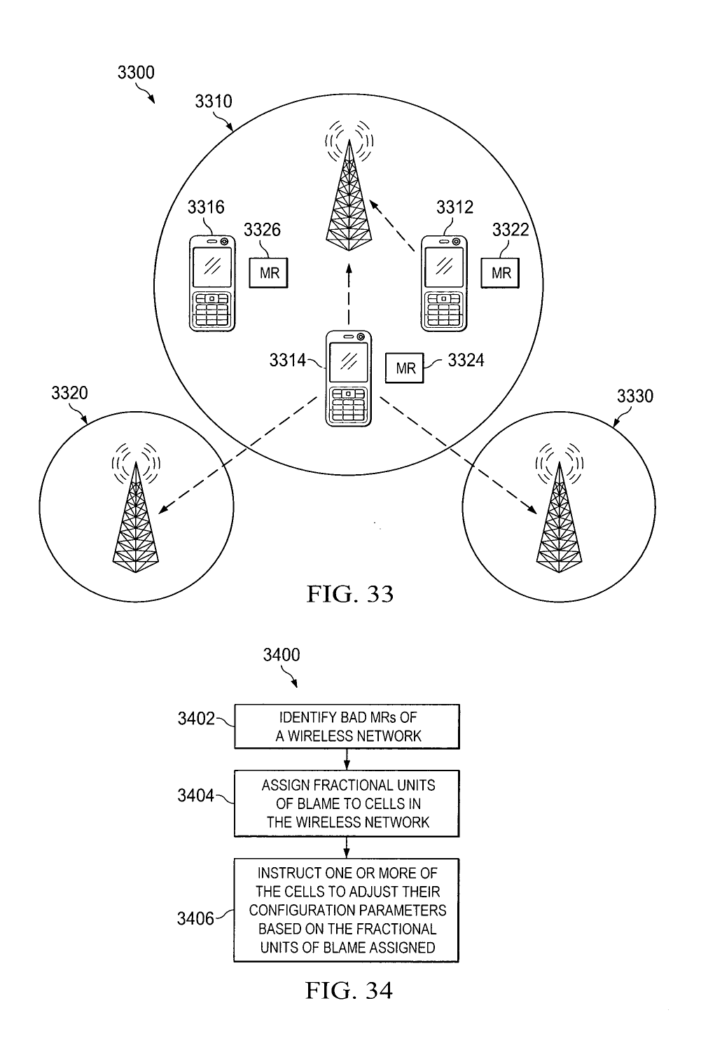

FIG. 36 illustrates a graph 3600 showing an embodiment up-blame and down-blame space, where analysis may be performed to determine actions for adjusting a cell's configuration parameters. The horizontal axis of the graph 3600 represents a normalized up-blame and the vertical axis represents a normalized down-blame. Each point in the graph represents a cell. As shown, the up-blame and down-blame space is divided into zones 3610, 3620, 3630 and 3640. Zone 3610 is a down-action zone, indicating cells in this zone have a down-action probability greater than a pre-defined down-action threshold TP_{down}. These cells generally have a high confidence to perform a down-action, i.e., decreasing a configuration parameter of the cells, with expectation of reducing their blame values. Zone 3620 is an up-action zone, indicating cells in this zone have an up-action probability greater than a pre-defined up-action threshold TPᵤₚ. Similarly, these cells also have a generally high confidence to perform an up-action to increase their configuration parameters. Zone 3630 is a no-action zone, where cells in this zone do not adjust their configuration parameters, since neither their down-action probabilities nor up-action probabilities are greater than the pre-defined thresholds. Cells in zone 3630 may have low confidence to determine an action for adjusting their parameters. Zone 3640 is a good zone, which indicates cells in this zone do not need to adjust their configuration parameters. This may be the case when cells in the zone 3640 are not responsible for any bad MRs, or when the cells have very small up-blame and down-blame values, even if their down-action probabilities or up-action probabilities exceed the corresponding pre-defined threshold. Cells on line 3612 are those having a down-action probability equal to the pre-defined down-action threshold TP_{down}. Cells on the line 3616 have an up-action probability equal to the pre-defined up-action threshold TPᵤₚ. Cells on line 3612 and line 3616 may or may not adjust their configuration parameters. Cells on line 3614 are those that have equal total blame values, which is the sum of the up-blame values and the down-blame values assigned to each of the cells in this example.

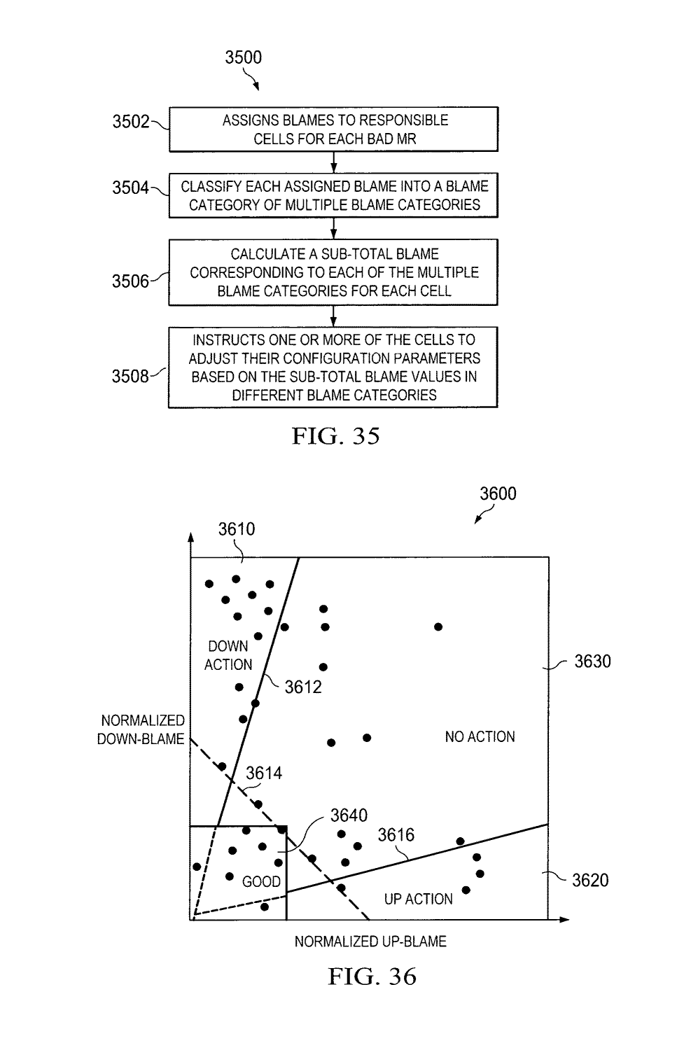

FIG. 37 illustrates a flowchart of another embodiment method 3700 for adjusting cell configuration parameters in a wireless network having multiple cells based on blames. Generally, the method 3700 receives a plurality of MRs for the cells, identifies bad MRs for each of the cells using a set of pre-defined performance criteria of the wireless network, and assigns blames to responsible cells for each of the bad MRs based on analysis of the corresponding bad MRs and other information, such as cell topology, antenna parameters, etc. In this example, two blame categories, namely, down-blame and up-blame are used for assigning blames. The two blame categories are used only for illustrative purpose and should not be interpreted as limiting the scope of the claims. The method 3700 starts with step 3702, where the method 3700 receives MRs of the wireless network during a data collection period given a fixed configuration of the cells. A UE may transmits a MR to its serving cell periodically (e.g., whenever pilots are received), when and as configured for pilot measurement reporting, or whenever requested. In one embodiment, the method 3700 also collects other information, such as MDT data and topology information of each cell, which may be useful for assigning blames to the cells.

At step 3704, for each MR of a cell, the method 3700 determines whether the MR satisfies a cell coverage criteria, e.g., whether a RSRP, or any other measure for reference signal strength, included in the MR is greater than or equals a first threshold T1. If the RSRP is greater than or equals the first threshold T1, then the method 3700 continues to determine whether the MR satisfies a cell quality criteria at step 3706, e.g., whether a RSRQ, or any other measure for reference signal quality, included in the MR is greater than or equals a second threshold T2. If the MR also satisfies the quality criteria, i.e., the RSRQ is greater than or equals the second threshold T2, the MR is marked as a good MR at step 3708 and no blame will be assigned to any cell for this good MR. The method then goes back to step 3704 to determine whether a next MR of the cell is good or bad. The method may record the number of good MRs for each cell, which may be used to estimate performance of the wireless network.

If the MR does not satisfy the cell coverage criteria at step 3704, or if the MR satisfies the cell coverage criteria at step 3704 but fails to satisfy the cell quality criteria at the step 3706, the MR is marked bad at step 3710. At step 3712, the method 3700 classifies the bad MR into one of multiple MR categories, and assigns blames for the bad MR to responsible cells. Bad MRs are classified into different categories so that responsible cells may be identified and appropriate blame values may be assigned. In one embodiment, a bad MR is classified into four categories: weak coverage with non-co-site neighbor, weak coverage without non-co-site neighbor, poor quality with non-co-site neighbor, and poor quality without non-co-site neighbor. The weak coverage indicates that the MR fails the cell coverage criteria, and the poor quality indicates that the MR fails the cell quality criteria.

A non-co-site neighbor of a cell is a neighbor of the cell which does not share the same base station with the cell. When a bad MR of a cell includes RSRP information of its neighbors, i.e., the cell has non-co-site neighbors, interference or overshooting of its neighbors may be considered when assigning blames for this bad MR. Each MR category may be further classified into different sub-categories, so that blames may be assigned appropriately to responsible cells. For example, the weak coverage without non-co-site neighbor is classified into sub-categories of weak interior and insufficient coverage. Domain expertise, knowledge and experience may be used to define different MR categories and sub-categories. A person of ordinary skill in the art would recognize many variations, alternatives and modifications for categorizing bad MRs for blame assignment.

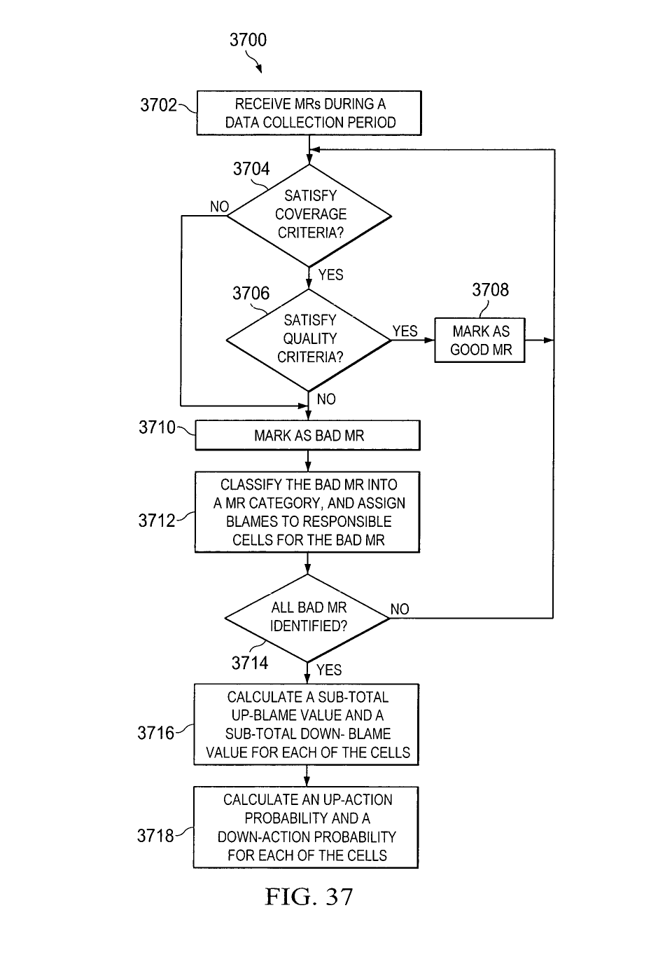

Blames for a bad MR may be assigned to responsible cells based on information included in the MR, such as the RSRP list, RSRQ, timing advance which may indicate distance of the UE reporting a bad MR to the cell (referred to as distance of the bad MR), topology information of the cell, information about the cell antenna, such as the main lobe radius and planned radius, and other information. FIG. 38 illustrates a diagram of an embodiment antenna radiation coverage zone 3800 of a cell. As shown, an antenna 3810 of the cell has a main lobe or main beam 3820 for communications.

In an example when a bad MR is in a category of weak coverage with non-co-site neighbor, if the timing advance of the bad MR indicates that the distance of the bad MR falls in the downblame zone 3830, e.g., when the distance is less than a pre-defined down-blame distance threshold, a down-blame with a blame value “1” may be assigned to the cell. This is because the cell needs to decrease its antenna tilt in order to provide sufficient coverage to the bad MR (i.e., the UE reporting the bad MR) which is closer to the antenna 3810 of the cell. If the timing advance of the bad MR indicates that the distance of the bad MR falls in the upblame zone 3850, an up-blame with a blame value “1” may be assigned to the cell, indicating an increased antenna tilt of the cell is desired for providing coverage to a MR far away from the antenna 3810. If the distance of the bad MR falls in the non-action zone 3840, the blame is not assigned. In this case, the blame for the bad MR is unknown, since it is not clear what causes the bad MR.

In some embodiments, for various reasons, a blame corresponding to a bad MR of a cell is left un-assigned due to uncertainty or unknown root causes. In one embodiment, this un-assigned blame is accounted for in the total blame of the cell (so that the total blame value of the cell is conserved, and the total blame value of the wireless network is conserved). In another embodiment, the un-assigned blames of a cell are divided as additional up-blames and down-blames according to a ratio of the up-blames and down-blames to the total assigned blame value of the cell, and are allocated to the final sub-total up-blame value and the final sub-total down-blame value of the cell. For example, a cell has n1 un-assigned blames (i.e., the un-assigned blame values are n1), a sub-total up-blame value x1 and a sub-total down-blame value y1. The total blame value of the cell is (n1+x1+y1), and the total assigned blame value of the cell is (x1+y1). The final sub-total up-blame value may be calculated by: x1+[x1/(x1+y1)]*n1, and the final sub-total down-blame value is equal to (total blame value of the cell−final sub-total up-blame value), which is: (n1+x1+y1)−{x1+[x1/(x1+y1)]*n1}. This ensures that the up-action probability and the down-action probability of each cell remains the same regardless of whether the un-assigned blames are re-assigned or not.

Referring back to FIG. 37, after blames of a bad MR in the cell are assigned to responsible cells, the method 3700 will check whether all bad MRs of the cells in the wireless network are identified at step 3714. If not, the method 3700 goes back to step 3704 to identify the next bad MR of the cell, or a next bad MR of a next cell if all bad MRs of the cell are identified and have blames assigned. The steps of 3704-3714 are repeated for each MR received in each of the cells in the wireless network. When all bad MRs received in the wireless network during the data collection period are identified and corresponding blames are assigned, the method 3700 proceeds to step 3716, where the method 3700 calculates a sub-total up-blame value and a sub-total down-blame value for each of the cells. Calculation of the sub-total up-blame value and the sub-total down-blame value may take into account of the un-assigned blames of each corresponding cell. At step 3718, the method 3700 calculates an up-action probability and a down-action probability for each of the cells, based on which an action may be assigned to the cells for adjusting configuration parameters of the cells.

Aspects of this disclosure may provide advantages over conventional automatic cell planner (ACP) solutions, which typically require minimization of drive test (MDT) data with UE geo-location (AGPS) and accurate antenna configuration parameters to achieve accurate propagation modeling. Notably, systems for providing UE geo-location information and accurate antenna configuration parameters may be costly and require human verification. Accordingly, embodiment techniques provide cost savings by reconfiguring RF parameters without relying on UE geo-location and/or antenna configuration feedback information.

Aspects of this disclosure may maximize CCO objective functions under constrained inputs. In some embodiments, techniques may utilize continuous closed loop measurement report (MR) feedback from a network. Drive tests (DT) and MDT data may also be used. Embodiment techniques may adjust RF configuration parameters without access to UE geo-location (AGPS), and without access to accurate antenna configuration parameters. Hence, embodiment techniques may offer similar accuracy to ACP CCO, but at a much lower cost.

Aspects of this disclosure provide a SON CCO algorithm. Embodiment algorithms may calculate cell level features or blame metrics from MRs. Embodiment Algorithms may label coverage/quality/interference/overshoot statuses that provide mappings for “intuitively correct” adjustment decisions based on domain knowledge applied simultaneously on multiple cells. This may allow the algorithm to substantially increase performance in a relatively short time frame. Embodiment algorithms may characterize a cell's coverage status as good, weak, weak edge only, weak interior/insufficient only, weak edge and interior/insufficient. Embodiment algorithms may characterize a cell's interference status as multiple interferer, single interferer, or non-interferer.

Aspects of this disclosure may provide a first phase of analytics assisted SON algorithms for CCO to achieve machine learned cell labels in addition to engineering knowledge guidelines for iterative action steps. This phase may be based at least partially on cell level features abstracted from MR data, labels or metrics of blame (e.g., multi-interferer, single/medium interferer, over-shooter, etc.), which may be gleaned using unsupervised or semi-supervised learning methods. Aspects of this disclosure may provide a feedback loop for UE MRs that sample the network state.

A clustering, machine learning algorithm that processes real-time local data and historical global data that represents key cell features as points in a multi-dimensional space, and which groups similar points together. Aspects of this disclosure may provide cell bottleneck labeling or blame metric assignment. A Cell (a point) is given a label based on cluster membership, e.g., non-interferer vs. multiple interferer, non-over-shooter vs. over-shooter. Alternatively, numerical blame metric and related blame action metric may be assigned.

Aspects of this disclosure may provide action rules that govern small step changes to cell parameters (power/tilt) in the “correct” direction. In white-box phase, engineering knowledge guides small step action based on machine learned cell labels or blame action metrics. Actions are designed to increase the score with high probability initially.

Aspects of this disclosure may provide an AA SON Approach that uses automatic software programming: to learn (online) the environment via real-time feedback (of UE MRs and cell KPIs) and analytics; to abstract the UE MR level information to cell level labels and metrics mapping to domain expertise guided incremental actions for optimizing configuration. Aspects of this disclosure provide a generalizable framework that is extendable to a variety of use cases, e.g., load balancing. Embodiment algorithms may provide significant improvement in 10-20 iterations. Labeling and blame metrics show good correlation with actual interferers, over-shooters, coverage/quality challenged cells etc.

Embodiment algorithms may calculates cell level features or blame metrics from MRs, as well as label cells based on their coverage/quality/interference/overshoot status.

Aspects of this disclosure provide an embodiment algorithm (version 2). The embodiment algorithm may be configured to record all positive NormBAM(j) metrics gathered from multiple scenarios in a global database and cluster them (1-D) into different levels, e.g., three levels. The embodiment algorithm may also be configured to map positive clusters to actions: The lowest magnitude clusters may be mapped to no action; the middle clusters may be mapped to a single parameter action (e.g., antenna down-tilt) by one step, and the highest clusters may be mapped to multiple or joint parameters (e.g., down-tilt and transmit power reduction) by one step each. The embodiment algorithm may also cluster negatives in a global database. Specifically, the embodiment algorithm may record all negative NormBAM(j) metrics in the global database and cluster them into multiple levels, e.g., three levels.

The embodiment algorithm may also map negative clusters to actions. For example, lowest magnitude clusters may be mapped to no action; middle clusters may be mapped to a single parameter (e.g., antenna up-tilt); and high clusters may be mapped to joint parameters (e.g., antenna up, power-up). The embodiment algorithm may also filter actions based on a current state. For example, the final action may be an adjustment of the action based on the above cluster mapping, and may depend on the coarse current estimated state (configuration). If a single parameter action is suggested (down-tilt or power-down), and current total tilt is estimated to be already high then the action may adjust the power. If current power is also already low, then no actions may be taken.

The embodiment algorithm may divide problems UEs/MRs into the following mutually exclusive categories:

Category 0 UEs/MRs have a weak coverage problem (best serving RSRP<−105 dBm). Category 0 UEs/MRs may be further divided into category 0.1 UEs/MRs that have weak edge coverage; and Category 0.2 UEs/MRs are those that are not in Category 0.1. Category 0.1 UEs may be defined as the second best RSRP>=best serving RSRP−6 dB. One unit of blame for UE u in category 0.1 is assigned to its own best serving cell i (self blame). The sign is positive because weak edge coverage is mitigated by up-tilt and thus have weak interior/insufficient coverage. One unit of blame may be assigned for each UE in category 0.2 based on its own best serving cell (e.g., self-blame). Typically weak interior versus insufficient coverage results in opposite actions (down-tilt vs. up-tilt). If COD triggers COC on a cell, then weak insufficient coverage can result with a positive sign for blame with action of up-tilt/up-power for mitigation.

Category 1 UEs/MRs are those not in Category 0 that have the problem of poor quality (e.g., SINR<3 dB) due to a combination of serving cell weakness and other cell interference and is further divided into sub-categories: Initially, self blame S(RSRP(i)) is assigned to serving cell i depending on its strength using a sigmoidal function to compute the blame: S(x) is S(x)→1 as x→−105 dBm from above and S(x)=1 for x<=−105 dBm and similarly, S(x)→0 as x→−95 dBm from below and S(x)=0 for x>=−95 dBm; also at the mid-point: S(−100)=½. The remaining (other) blame 1-S(RSRP(i)) is divided among interfering cells, if any, based on the following categories: Category 1.1 UEs/MRs are those not in category 0 reporting the second best RSRP>=best serving RSRP−3 dB. For a UE u best served by cell i, let C_{1.1}(u) be the set of all other cells such that their RSRP>=RSRP(i)−3 dB. Then the remaining (other) blame for u's poor quality=(1−S(RSRP(i))/|C_{1.1}(u)| is equally divided between these other cells. Thus if there is only one such cell, it is assigned the remaining blame regarding u. The rationale here is that even a single cell at more than half the power of the best server will likely cause the SINR to drop below 3 dB.

Category 1.2 UEs/MRs are those not in categories 0 or 1.1 reporting the second best RSRP>=best serving RSRP−6 dB. For a UE u best served by cell i, let C_{1.2}(u) be the set of all other cells such that their RSRP>=RSRP(i)−6 dB. Then the remaining (other) blame for UE's poor quality=min(½,1/|C_{1.2}(u)|)*(1−S(RSRP(0) is equally divided between these other cells. Thus if there are two or more such other cells, they are assigned to share the remaining (other) blame regarding u equally. The rationale here is that just two cells at more than quarter the power each of the best server will cause the SINR to drop below 3 dB. Note that if there is only one such other cell then its assignment is capped at half the remaining blame—the unaccounted blame is left unassigned as an approximation.

Category 1.3 UEs/MRs are those not in categories 0 or 1.1 or 1.2 reporting the second best RSRP>=best serving RSRP−9 dB. For a UE u best served by cell i, let C_{1.3}(u) be the set of all other cells such that their RSRP>=RSRP(i)−9 dB. Then the remaining (other) blame for UE's poor quality=min(¼,1/|C_{1.3}(u)|))*(1−S(RSRP(i)) is equally divided between these other cells. Thus if there are four or more such other cells, they are assigned to share the remaining (other) blame regarding u equally. The rationale here is that four cells at more than an eighth power each of the best server will cause the SINR to drop below 3 dB. Note that if there is only one, two or three such other cells then their assignment is capped at a quarter of the remaining blame—the unaccounted blame is left unassigned as an approximation. Category 2 UEs/MRs are those not in Category 0 or 1 that have the problem of poor quality (SINR<3 dB).

Category 2 UEs/MRs are those not in categories 0 or 1. Self blame S (RSRP(i)) is assigned to a serving cell in a similar manner to category 1 UEs. Such UEs do not have a clearly responsible interferer to assign remaining (other) blame and so the unaccounted blame is left unassigned as an approximation. Such instances are hopefully low—yet our algorithm will monitor the numbers of such UEs and their accumulated unassigned blame at cell and system level.

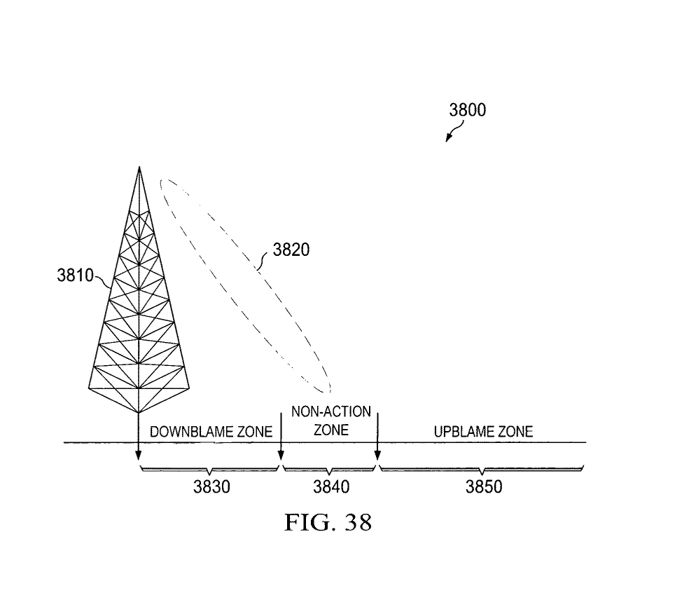

Embodiment algorithms may assign a blame counter matrix to cells. FIG. 39 illustrates an embodiment blame counter matrix. The rules for assigning blame metrics to cells are as follows:

Every best serving cell i has a set of served UEs/MRs Sᵢ. ;Sᵢ=S_{i,good} U S_{i,problem} (disjoint union); S_{i,problem}=S_{i,0.1} U S_{i,0.2} U S_{i,1.1} U S_{i,1.2} U S_{i,1.3} U S_{i,2}(disjoint union);
Each of the UEs/MRs u belonging to a problem sub-category is associated with a group of cells in the system that are assigned blame;
For category 0 UEs, the serving cell takes all the blame and for category 1 UEs, some other cells also share part of the blame;
For a fixed serving cell i and every cell j in the system, every served UE/MR of i with a problem distributes the blame (one unit maximum) for its problem across several or all js (including i);
For a given pair of cells i and j, accumulate the individual blame accorded to j over all UEs/MRs served by i and record in the B(i,j) entry of the blame matrix; B(i,i) along the diagonal is the self blame.
Category 0 and 2.1 UEs contribute to only self blame whereas Category 1 UEs contribute to other blame as well;
For any given i (fixing a row), summation over j of B(i,j) is the row-sum that is roughly equal to the number of problem UEs served by i (could be less because some blame may be unassigned) related to cell level O.F; and
The sum of all row-sums is roughly equal to the total number of problem UEs in the system’ For any given j (fixing a column), summation over i of B(i,j) is the column-sum that is roughly equal to the number of problem UEs caused by j. This is the Blame Metric of cell j, BM(j).

Instead of using the blame metric directly for action, some embodiment algorithms may use the blame action metric to exploit the fact that for self-blame, the action is typically opposite (up-tilt/power-up) to that of the action to mitigate other-blame (down-tilt/power-down). Reflecting this opposite action, the Blame Action Metric of cell j is (for example) defined as: BAM(j)=Σ_{i< >j} B(i,j)−B(j,j) (same cell blame is negative weighted); BAM(j)=_{i< >j, eNB(i)< >eNB(j)}B(i,j)−B(j,j) (other cells of the same eNB are zero weighted); Normalize BAM(j) by the total number of UEs in the cluster formed by j and all its neighbors (can use neighbor list or infer it based on significant BM(i,j) values: NormBAM(j)=BAM(j)/Number of UEs in j and all of its RF neighbors. If NormBAM(j) is small in magnitude, there may be no action on cell j. It is possible to normalize BM(j) to yield NormBM(j). NormBM(j) provides some information about the cell. For instance, if a cell j has high NormBM(j) but low NormBAM(j) then that cell is in a very “tricky” or “ambiguous” action situation where its numerous problem UEs are requiring conflicting actions that essentially cancel out. If a cell has both of them high, then that cell is a problem cell but with a clear action for resolution. If a cell has both of them low, then that cell is not a problem cell.

Aspects of this disclosure may use an action rule for mapping a NormBAM metric to actions. Clustering of Positives in Global Database: All positive NormBAM(j) metrics gathered from multiple scenarios may be recorded in a global database and clustered into multiple levels, e.g., three levels. Mapping Positive Clusters to Actions: The lowest magnitude clusters map to no action; the middle cluster maps to single parameter action (e.g., antenna down-tilt) by one step and the highest cluster maps to joint parameter (e.g., down-tilt and power-down) action by one step each. Clustering of Negatives in Global Database: Negative NormBAM(j) metrics may be clustered in the global database and cluster them into multiple levels, e.g., three levels. Mapping Negative Clusters to Actions: Lowest magnitude cluster implies no action; middle one to single parameter action (Antenna up-tilt preferred) by one step and highest cluster maps to joint parameter (up) action by a step each. Filtering Actions Based on Current State: The final action is an adjustment of the action based on the above cluster mapping that depends on the coarse current estimated state (configuration) For example, if single parameter action is suggested (down-tilt or power-down), and current total tilt is estimated to be already high then power-down is done. If current power is also already low, then no action is taken.

Aspects of this disclosure may use semi-supervised learning (EM) to augment clustering for improved thresholding of the NormBAM metric, e.g., NormBAMs of good performing cells (low interferer, high quality, good coverage) taken from optimized configurations can provide labeled training examples in the “no action” range of points. The “dead zone” range of “no action” configuration states can be narrowed to be next to nothing (to essentially allow tilt and power actions to be unconstrained except for max and min allowed e-tilts and powers). In other words, if e-tilt range allowed by the vendor is [0, 12] degrees, then we may prescribe the small range of tilt as (−inf, 0], the moderate range as (0, 12) and the high range as [12, inf).

Embodiment algorithms may provide ways to deal with overshooting cells. They may be discovered by a similar learning procedure of the algorithm (version 1). The first way is to incorporate overshooting into the blame metric. More specifically, after assigning blame in category 0.x, we consider a new category 0.3 in which falls those UEs/MRs that are served by cell i but should not be (since i is an overshooter or overloaded). Thus when the serving cell (of a UE/MR at “large” distance) is itself the overshooter, we decrement B(i,i) by 1 keeping in mind that B(i,i) positively influences up-tilt/power-up (or increment B(j,i) by 1 where j is the strongest local cell). If an overshoot UE/MR (overlap at “large” distance) falls in category 1.x, we can continue the blame sharing as before or punitively assign all “remaining” or full blame to the overshooting cell (i.e., increment B(i,j) by 1−S(RSRP(i)) or 1 for each UE/MR served by cell i that is overlapped by overshooting cell j). We also optionally add a category 3.1 of blame assignment for overshoot UEs/MRs not falling under categories 0 or 1 (by adding/subtracting a new unit of blame to other/self over-shooters), i.e., even if that UE/MR reports no coverage/quality issues. The second way is to provide a separate Label for overshooter: If cell j is deemed overshooter and Action prescribed for cell j based on BAM(j) is down-tilt/power-down, then do nothing further. If Action prescribed for cell j based on BAM(j) is do nothing, then modify to single parameter down-tilt/power-down. If Action prescribed for cell j based on BAM(j) is up-tilt/power-up then cancel it to no action.

Embodiment algorithms may provide actions for configuring cells having excessive up-tilt and power-up parameters. The up-tilt/power-up action arises from a need to improve a cell's own coverage or quality. A consequence of this is the interference increase in UE/MRs served by neighboring cells and/or overshoot problems. Such action is selected to correct any imbalance between selfishness (for improving current served UEs' problems) and cooperation (for improving current interfered UEs of other cells). However, such action does not account for the consequent increase in number of interfered UEs in other cells. Several cells in the same area (neighbors of each other or have common neighbors) being up-tilted/powered-up at the same time may lend a multiplier effect to such increase in interfered UEs and worsen quality. This can create instability in system performance when successive similar actions run away (due to competition between neighbors) or successive opposite actions on a cell engender oscillations with no meaningful improvement.

Embodiment algorithms may address this issue by implementing the following steps. Construct an interaction graph GU of up-tilt/power-up candidate cell nodes with edges between them if they are neighbors or have significantly interacting common neighbors. Use the B(i,j) matrix (e.g., blame metric) as a guideline for figuring out “significant” interacting neighbors. In other words, the adjacency matrix AU(i,j) for graph GU is a function of B(i,j), B(i, neighbor of j) and B(neighbor of i, j). Note that GU is not the original network graph NG. GU has a subset of nodes of NG but with a superset of edges given a node. The complementary graph GU′ replaces edges with non-edges and non-edges with edges. The problem is then to find the Maximum Clique of GU′ (largest complete sub-graph or largest set of mutually inter-connected nodes). Maximum Clique is known to be an NP Hard Problem. Use a suitable heuristic for maximal clique (with high degree vertices for a sub-optimal solution: R implementations for max clique; GU″=approximate Max Clique of GU′ is a limited set of cells that can be used for Up-tilt/power-up Actions with reduced worry of unstable interaction that could increase interference

Embodiment algorithms may mitigate instability by picking separated cells for Down-tilt/Power-Down. Specifically, a problem may exist for those cells in the system identified for down-tilt/power-down, as identifying the largest subset of them such that they are not direct neighbors may cause down-tilting to open up edge holes.

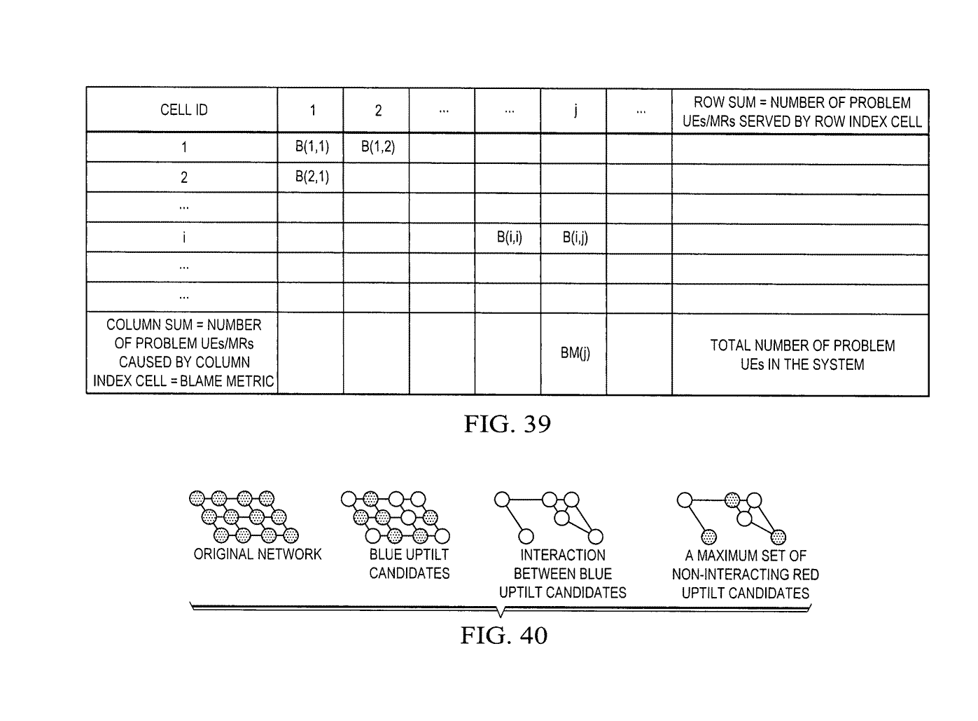

Embodiment algorithms may address this issue by implementing the following steps. Construct an interaction graph GD of down-tilt/power-down candidate cell nodes with edges between them if they are neighbors. Use the B(i,j) matrix, i.e., blame metric as a guideline for figuring out neighbors. In other words, the adjacency matrix AD(i,j) for graph GD is a function of B(i,j). Note that GD is not the original network graph NG. GD has a subset of nodes of NG with same edges given a node. The complementary graph GD′ replaces edges with non-edges and non-edges with edges The problem is then to find the Maximum Clique of GD′ (largest complete sub-graph or largest set of mutually inter-connected nodes). Maximum Clique is known to be an NP Hard Problem. Use a good heuristic for maximal clique (with high degree vertices) for sub-optimal solution: R implementations for max clique: GD″=approximate Max Clique of GD′ is a limited set of cells that can be used for down-tilt/power-down Actions with reduced worry of unstable interaction that could cause coverage/quality holes. FIG. 40 illustrates a diagram of a Graph Problem & Solution Visualization.

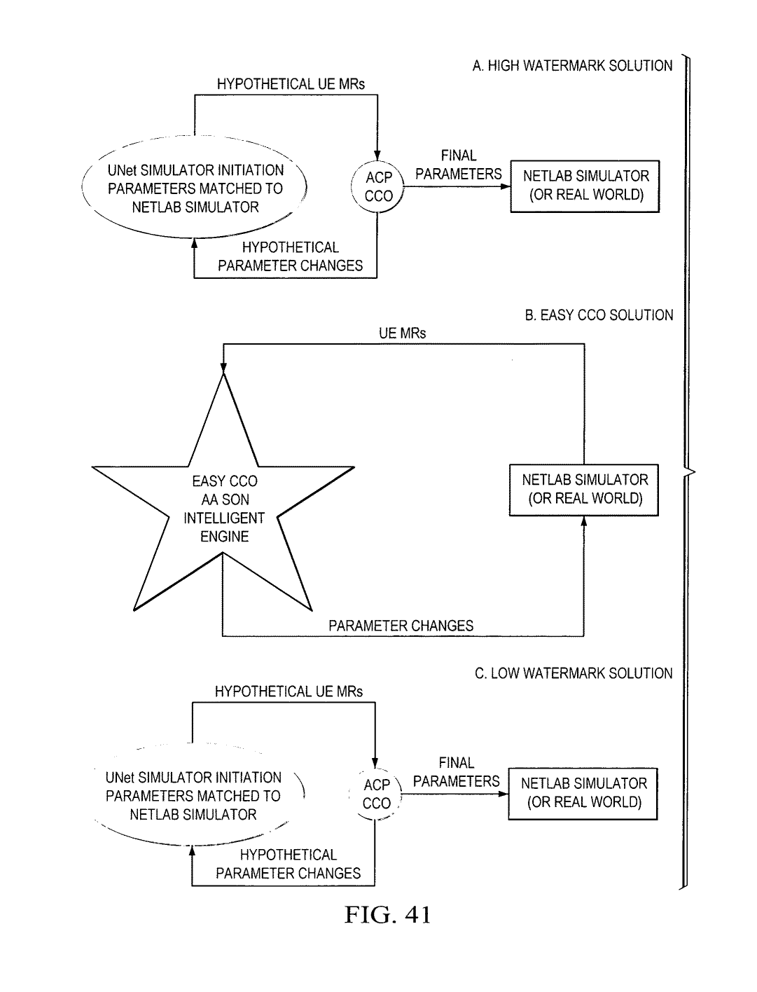

Embodiment algorithms may learn from mistakes through maximizing gain in NormBM(j) and resultant M-out-of-N cell tuning. Usually NormBM(j) is a good indicator of cells that are root causes of problem UEs. Action Cells may have High NormBM(j). Actions on Cells are chosen with the expectation that their NormBM(j) is reduced (step-by-step). NormBM(j) reduction is tied to System Objective Function Improvement. However, actions taken on chosen cells are not guaranteed to reduce their NormBM(j) due to unknown hidden variables. In practice, NormBM(j) may not drop consistently or may even grow (due to interactions and hidden variable impacts). The algorithm may learn which cells j under which configurations under which current NormBM(j) and NormBAM(j) (action) values produce the largest reduction (Gain) in NormBM(j) on average. Initially target precisely such cells for WB action (M-out-of-N for Whitebox). Cells that produce extreme/sustained negative gain may be removed from Whitebox list first for no action and then passed on to Blackbox for Oppositional, Exploitative and Explorative Action. FIG. 41 illustrates a flowchart of a method for operating a CCO interface. Additional details regarding aspects of this disclosure are provided in the Appendix filed herewith.

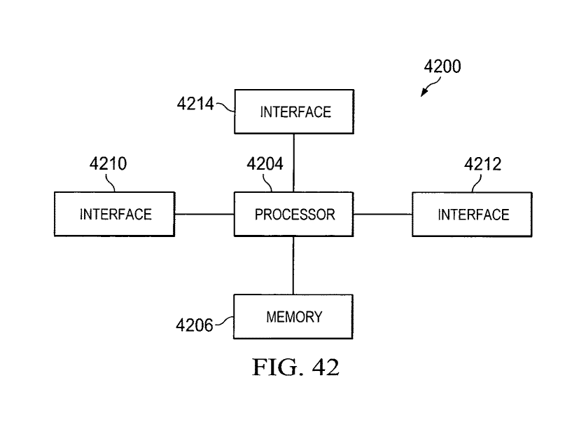

FIG. 42 illustrates a block diagram of an embodiment processing system 4200 for performing methods described herein, which may be installed in a host device. As shown, the processing system 4200 includes a processor 4204, a memory 4206, and interfaces 4210-4214, which may (or may not) be arranged as shown in FIG. 42. The processor 4204 may be any component or collection of components adapted to perform computations and/or other processing related tasks, and the memory 4206 may be any component or collection of components adapted to store programming and/or instructions for execution by the processor 1204. In an embodiment, the memory 4206 includes a non-transitory computer readable medium. The interfaces 4210, 4212, 4214 may be any component or collection of components that allow the processing system 4200 to communicate with other devices/components and/or a user. For example, one or more of the interfaces 4210, 4212, 4214 may be adapted to communicate data, control, or management messages from the processor 4204 to applications installed on the host device and/or a remote device. As another example, one or more of the interfaces 4210, 4212, 4214 may be adapted to allow a user or user device (e.g., personal computer (PC), etc.) to interact/communicate with the processing system 4200. The processing system 4200 may include additional components not depicted in FIG. 42, such as long term storage (e.g., non-volatile memory, etc.).

In some embodiments, the processing system 4200 is included in a network device that is accessing, or part otherwise of, a telecommunications network. In one example, the processing system 4200 is in a network-side device in a wireless or wireline telecommunications network, such as a base station, a relay station, a scheduler, a controller, a gateway, a router, an applications server, or any other device in the telecommunications network. In other embodiments, the processing system 4200 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network. In some embodiments, one or more of the interfaces 4210, 4212, 4214 connects the processing system 4200 to a transceiver adapted to transmit and receive signaling over the telecommunications network, such as the transceiver illustrated in FIG. 22.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method for improving coverage and capacity of a wireless network having multiple cells, comprising:
receiving one or more measurement reports associated with communications in the wireless network for at least one of the multiple cells during a first period;
assigning two or more status labels to a cell in the wireless network based on the one or more measurement reports, the two or more status labels associated with different cell status categories; and
instructing the cell to adjust an antenna tilt, a transmit power level, or both based on at least a combination of the two or more status labels, wherein the antenna tilt or transmit power level is used to communicate wireless signals in the cell during a second period.

2. The method of claim 1, wherein the different cell status categories comprise at least one of a coverage status, an interference status, a quality status, and an overshooter status.

3. The method of claim 1, wherein instructing the cell to adjust an antenna tilt, a transmit power level, or both based on at least the combination of the two or more status labels comprises instructing the cell to adjust an antenna tilt, a transmit power level, or both based on the combination of the two or more status labels, and at least one of a current antenna tilt of the cell and a current reference signal power of the cell.

4. An apparatus, comprising:
a processor; and
a non-transitory computer readable storage medium storing programming for execution by the processor, the programming includes instructions to:
receive one or more measurement reports associated with communications in a wireless network having multiple cells during a first period;
assign two or more status labels to a cell in the wireless network based on the one or more measurement reports, the two or more status labels associated with different cell status categories; and
instruct the cell to adjust an antenna tilt, a transmit power level, or both, based on at least a combination of the two or more status labels, wherein the adjusted antennal tilt or transmit power level is used to communicate wireless signals in the cell during a second period.

5. The apparatus of claim 4, wherein the different cell status categories comprise at least one of a coverage status, an interference status, a quality status, and an overshooter status.

6. The apparatus of claim 4, wherein the antenna tilt or the transmit power level is adjusted based on the combination of the two or more status labels, and at least one of a current antenna tilt of the cell and a current reference signal power of the cell.

7. A method, comprising:
identifying measurement reports each of which fails to satisfy a performance criteria for a wireless network, the measurement reports being generated in the wireless network during a first period, each of the measurement reports being associated with a unit of blame;
assigning, for each of the measurement reports, fractional units of blame to cells in the wireless network; and
instructing at least one of the cells to adjust at least one parameter based on the fractional units of blame assigned to the at least one of the cells, the at least one parameter being used to communicate wireless signals in the at least one of the cells.

8. The method of claim 7, wherein the performance criteria is satisfied when a measure of reference signal strength included in a corresponding measurement report is greater than a threshold.

9. The method of claim 7, wherein the performance criteria is satisfied when a measure of reference signal quality included in a corresponding measurement report is greater than a threshold.

10. The method of claim 7, wherein the fractional units of blame are assigned to the cells based on information included in a corresponding measurement report.

11. The method of claim 7, wherein the at least one parameter comprises an antenna tilt.

12. The method of claim 7, wherein the at least one parameter comprises a transmit power.

13. The method of claim 7, wherein the fractional units of blame are classified into different blame categories, the different blame categories indicating different manners to adjust the at least one parameter in order to reduce the fractional units of blame.

14. The method of claim 13, further comprising:
calculating, for each of the cells, a sub-total blame corresponding to each of the different blame categories, by summing the fractional units of blame that are assigned to a corresponding cell and fall into a corresponding blame category, thereby obtaining sub-total blame values corresponding to the different blame categories for each of the cells.

15. The method of claim 14, wherein instructing the at least one of the cells to adjust the at least one parameter comprises instructing the at least one of the cells to adjust the at least one parameter based on the sub-total blame values of the at least one of the cells.

16. The method of claim 7, wherein the fractional units of blame are classified into an up-blame or a down-blame, the up-blame or the down-blame indicating that an increase or a decrease of the at least one parameter is desired in order to reduce the fractional units of blame.

17. The method of claim 16, further comprising:
calculating a sub-total up-blame value and a sub-total down-blame value for each of the cells, using the up-blame fractional units of blame and the down-blame fractional units of blame assigned to a corresponding cell, respectively;
calculating a total blame value for each of the cells, using the fractional units of blame assigned to a corresponding cell;
calculating an up-action probability for each of the cells, by dividing the total blame value of a corresponding cell by the sub-total up-blame value of the corresponding cell; and
calculating a down-action probability for each of the cells, using the up-action probability of a corresponding cell; and
wherein the up-action probability or the down-action probability of each of the cells indicates a probability of a need to increase or decrease the at least one parameter of a corresponding cell.

18. The method of claim 17, wherein instructing the at least one of the cells to adjust the at least one parameter comprises instructing the at least one of the cells to:
increase the at least one parameter when the up-action probability of the at least one of the cells is greater than a first threshold; and
decrease the at least one parameter when the down-action probability of the at least one of the cells is greater than a second threshold.

19. An apparatus, comprising:
a processor; and
a non-transitory computer readable storage medium storing programming for execution by the processor, the programming includes instructions to:
identify measurement reports each of which fails to satisfy a performance criteria for a wireless network, the measurement reports being generated in the wireless network during a first period, each of the measurement reports being associated with a unit of blame;
assign, for each of the measurement reports, fractional units of blame to cells in the wireless network; and
instruct at least one of the cells to adjust one or more parameters based on the fractional units of blame assigned to the at least one of the cells, the one or more parameters being used to communicate wireless signals in the at least one of the cells.

20. The apparatus of claim 19, wherein the performance criteria is satisfied when a measure of reference signal strength included in a corresponding measurement report is greater than a threshold.

21. The apparatus of claim 19, wherein the performance criteria is satisfied when a measure of reference signal quality included in a corresponding measurement report is greater than a threshold.

22. The apparatus of claim 19, wherein the fractional units of blame are assigned to the cells based on information included in a corresponding measurement report.

23. The apparatus of claim 19, wherein the one or more parameters comprise an antenna tilt.

24. The apparatus of claim 19, wherein the one or more parameters comprise a transmit power level.

25. The apparatus of claim 19, wherein the fractional units of blame are classified into different blame categories associated with different manners to adjust the one or more parameters.

26. The apparatus of claim 25, wherein the programming comprises further instructions to:
calculate, for each of the cells, a sub-total blame corresponding to each of the different blame categories by summing the fractional units of blame that are assigned to a corresponding cell and fall into a corresponding blame category, thereby obtaining sub-total blame values corresponding to the different blame categories for each of the cells.

27. The apparatus of claim 26, wherein the one or more parameters are adjusted based on the sub-total blame values of the at least one of the cells.
